(19) United States
(12) Patent Application Publication
(10) Pub. No.: US 2026/0357112 A1
(43) Pub. Date: Nov. 12, 2026

(54) ADHESION-PROMOTING LAYER-COATED POLYESTER FILM, FILM ARTICLE, OPTICAL LAMINATE, LAMINATED ARTICLE, POLARIZING PLATE, PANEL, SURFACE PLATE, IMAGE DISPLAY PANEL, AND IMAGE DISPLAY DEVICE

(71) Applicant: DAI NIPPON PRINTING CO., LTD., Tokyo (JP)

(72) Inventors: Takashi KURODA, Tokyo (JP); Shosei KUBOTA, Tokyo (JP); Minoru KATO, Tokyo (JP); Hikaru HOTTA, Tokyo (JP); Yoshiko TANAKA, Tokyo (JP); Akinobu USHIYAMA, Tokyo (JP)

(21) Appl. No.: 19/515,120

(22) PCT Filed: Aug. 30, 2024
(86) PCT No.: PCT/JP2024/031409

§ 371 Date: Feb. 27, 2026

(30) Foreign Application Priority Data
Sep. 1, 2023 (JP) 2023-142557

(51) Int. Cl. C09J 7/25; G02B 1/14

(52) U.S. Cl. CPC C09J 7/255; G02B 1/14; C09J 2467/006

(57) ABSTRACT

An adhesion-promoting layer-coated polyester film includes a polyester film and an adhesion-promoting layer on the polyester film. A plane orientation degree is higher than or equal to 0.150 and lower than or equal to 0.195. An average value of δq/δa on a surface of the adhesion-promoting layer is lower than or equal to 1.80. δa is an arithmetic mean value of a phase signal on the surface of the adhesion-promoting layer. δq is a root mean square of the phase signal on the surface of the adhesion-promoting layer.

### TECHNICAL FIELD

The present disclosure relates to an adhesion-promoting layer-coated polyester film, a film article, an optical laminate, a laminated article, a polarizing plate, a panel, a surface plate, and an image display device.

### BACKGROUND ART

In image display devices, such as liquid crystal display devices, organic EL display devices, micro-LED display devices, mini-LED display devices, quantum dot display devices, and laser holographic display devices, various optical laminates are disposed for the purpose of improving the visibility of images, suppressing scratches on the device surfaces, and the like. Optical laminates can also be disposed in show windows, covers for paintings, and the like, for the purpose of improving the visibility of articles, protecting articles, and the like.

An optical laminate includes a plastic film and a functional layer laminated on the plastic film. Many optical laminates include an adhesion-promoting layer located on the plastic film. The adhesion-promoting layer improves the adhesion between the plastic film and the functional layer in the optical laminate. The plastic film is treated as an adhesion-promoting layer-coated film, in which the adhesion-promoting layer is laminated.

A triacetyl cellulose film with low optical anisotropy has been preferably used as the plastic film of the optical laminate. However, a TAC film has a problem in mechanical strength. The problem becomes more remarkable in a TAC film applied to a large-screen image display device. In this specification, the term “triacetyl cellulose film” is also referred to as a “TAC film”.

Accordingly, polyester films such as polyethylene terephthalate films have been suggested as an alternative to TAC films (for example, PTL 1). In this specification, the term “polyethylene terephthalate film” is also referred to as a “PET film”.

Image display devices, such as liquid crystal display devices and organic EL display devices, output polarized light. When a PET film is applied to such an image display device, a rainbow-like interference pattern referred to as rainbow unevenness can occur. The rainbow-like interference pattern is caused by the in-plane retardation of the PET film. The rainbow-like interference pattern reduces visibility. As a countermeasure against rainbow unevenness, it has been suggested to significantly increase the in-plane retardation of the PET film (for example, PTL 1).

The PET film with a significantly large in-plane retardation as described in PTL 1 is obtained by uniaxially stretching the PET film. However, uniaxially stretched films have problems such as being prone to tearing in the stretching direction.

As a countermeasure against rainbow unevenness, a method of reducing the in-plane retardation of a PET film can be considered in contrast to PTL 1.
PTL 1: Japanese Unexamined Patent Application Publication No. 2011-107198
PTL 2: Japanese Unexamined Patent Application Publication No. 2012-032819
PTL 3: Japanese Unexamined Patent Application Publication No. 2016-006530
PTL 4: International Publication No. 2021/200884

A PET film with a small in-plane retardation can be obtained, for example, by lowering the stretching ratio. However, a PET film with a smaller stretching ratio has reduced mechanical strength.

In the PET films described in PTLs 2 and 3, the in-plane retardation is reduced without lowering the stretching ratio, compared to general-purpose biaxially stretched PET films. In the PET films described in PTLs 2 and 3, the in-plane retardation is reduced, for example, by reducing the stretching ratio difference between an MD direction that is a machine direction and a TD direction that is a transverse direction.

In the PET films with a reduced in-plane retardation without lowering the stretching ratio, and in adhesion-promoting layer-coated polyester films including such a PET film, the plane orientation degree ΔP tends to increase. However, it has been confirmed by the inventors of the present application that, when the plane orientation degree of an adhesion-promoting layer-coated polyester film is high, another inconvenience arises. In an adhesion-promoting layer-coated polyester film, having a large plane orientation degree ΔP, the adhesion between the adhesion-promoting layer and the polyester film can decrease.

This problem can be resolved by selecting an appropriate material for the adhesion-promoting layer. However, the above-described solution limits the range of choices of materials for the adhesion-promoting layer, which causes constraints on product design. For this reason, the above solution lacks practicality. In a case where optical design is performed for the optical laminate as a whole, when there is an adhesion-promoting layer of a specific material on the PET film, constraints are also imposed on the selection of materials for the functional layer formed on the adhesion-promoting layer.

### SUMMARY OF INVENTION

The present disclosure aims to improve the adhesion between a polyester film and an adhesion-promoting layer in an adhesion-promoting layer-coated polyester film having a high plane orientation degree.

The invention described in PTL 4 aims to solve challenges similar to the above-described challenges of the present disclosure. The optical laminate described in PTL 4 includes an adhesion-promoting layer-coated polyester film, an uneven layer, and an antifouling layer, in this order. According to paragraphs 0073, 0122, and the like, of PTL 4, the optical laminate of PTL 4 improves the adhesion between the adhesion-promoting layer and the polyester film through the surface shape of the surface of the uneven layer and the slip properties of the antifouling layer. In other words, PTL 4 improves the adhesion between the adhesion-promoting layer and the polyester film in an optical laminate where a functional layer is laminated on an adhesion-promoting layer-coated polyester film. The adhesion-promoting layer-coated polyester film described in PTL 4, as is apparent from the evaluation results of Comparative Example 6 (described later), has not been able to improve the adhesion between the adhesion-promoting layer and the polyester film in the state before the functional layer is laminated. The present disclosure improves the adhesion between an adhesion-promoting layer and a polyester film in an adhesion-promoting layer-coated polyester film before the functional layer is laminated, as demonstrated in the examples (described later).

An adhesion-promoting layer-coated film according to one embodiment of the present disclosure includes:
a polyester film; and an adhesion-promoting layer, wherein
a plane orientation degree is higher than or equal to 0.150 and lower than or equal to 0.195, and
an average value of δq/δa on a surface of the adhesion-promoting layer is higher than or equal to 1.125 and lower than or equal to 1.80.
   <Calculation of the Average Value of δq/δa>

A 10 μm×10 μm region on the surface of the adhesion-promoting layer is measured using an atomic force microscope in a phase mode. A distribution of a phase signal on the surface of the adhesion-promoting layer is obtained through the measurement. A unit of the phase signal is [deg].

δa denotes an arithmetic mean value of the phase signal shown in the following Equation (1). δq denotes a root mean square of the phase signal shown in the following Equation (2).

(In the following Equation (1) and Equation (2), orthogonal coordinate axes X and Y are placed on a reference surface that represents an average value of the phase signal, an axis orthogonal to the reference surface is defined as a Z axis, and a curved surface of the phase signal is defined as f(x,y). In the following Equation (1) and Equation (2), dimensions of a region for calculating da and δq are Lx and Ly. In the following Equation (1) and Equation (2), Ar=Lx×Ly.)

Seven measurement evaluation regions each having a size of 2 μm×2 μm are selected from within the measurement region of 10 μm×10 μm. δa and δq of the seven measurement evaluation regions and δq/δa are calculated. Based on the five δq/δa values, excluding a maximum value and a minimum value from the seven δq/δa values, an average value of δq/δa is calculated.

$$[ Formula 1 ]$$

$$δ a = \frac{1}{Ar} {\int }_{0}^{Lx} {\int }_{0}^{Ly} \vert f ( x , y ) \vert dxdy \qquad Equation ( 1 )$$

$$[ Formula 2 ]$$

$$δ q = \sqrt{\frac{1}{Ar} {\int }_{0}^{Lx} {\int }_{0}^{Ly} \vert {f}^{2} ( x , y ) \vert dxdy} \qquad Equation ( 2 )$$

According to the present disclosure, it is possible to improve the adhesion between a polyester film and an adhesion-promoting layer in an adhesion-promoting layer-coated polyester film having a high plane orientation degree.

### BRIEF DESCRIPTION OF DRAWINGS

FIG. 1 is a diagram for illustrating one embodiment of the present disclosure and is a longitudinal sectional view showing one example of an adhesion-promoting layer-coated polyester film.

FIG. 2 is a perspective view showing one example of a film article including a plurality of the adhesion-promoting layer-coated polyester films, shown in FIG. 1.

FIG. 3 is a diagram for illustrating a present embodiment and is a longitudinal sectional view showing one example of an optical laminate.

FIG. 4 is a perspective view showing one example of a laminated article including a plurality of the optical laminates shown in FIG. 3.

FIG. 5 is a cross-sectional view showing one example of a polarizing plate including the adhesion-promoting layer-coated polyester film and the optical laminate.

FIG. 6 is a cross-sectional view showing one example of a panel including the adhesion-promoting layer-coated polyester film and one example of a surface plate including the adhesion-promoting layer-coated polyester film and the optical laminate.

FIG. 7 is a cross-sectional view showing one example of an image display panel and an image display device, including the adhesion-promoting layer-coated polyester film and the optical laminate.

FIG. 8A is a diagram for illustrating a bending test.

FIG. 8B is a diagram for illustrating a bending test.

FIG. 8C is a diagram for illustrating a bending test.

FIG. 9 is a diagram schematically showing a manufacturing apparatus for the optical laminate used for transportability evaluation.

### DESCRIPTION OF EMBODIMENTS

One embodiment of the present disclosure relates to the following <1> to <19>.

<1>

An adhesion-promoting layer-coated polyester film includes:
a polyester film; and an adhesion-promoting layer, wherein
a plane orientation degree is higher than or equal to 0.150 and lower than or equal to 0.195, and
an average value of δq/δa on a surface of the adhesion-promoting layer is higher than or equal to 1.125 and lower than or equal to 1.80.
   <Calculation of the Average Value of δq/δa>

A 10 μm×10 μm region on the surface of the adhesion-promoting layer is measured using an atomic force microscope in a phase mode. A distribution of a phase signal on the surface of the adhesion-promoting layer is obtained through the measurement. A unit of the phase signal is [deg].

δa denotes an arithmetic mean value of the phase signal shown in the following Equation (1). δq denotes a root mean square of the phase signal shown in the following Equation (2). In the following Equation (1) and Equation (2), orthogonal coordinate axes X and Y are placed on a reference surface that represents an average value of the phase signal, an axis orthogonal to the reference surface is defined as a Z axis, and a curved surface of the phase signal is defined as f(x,y). In the following Equation (1) and Equation (2), dimensions of a region for calculating δa and δq are Lx and Ly. In the following Equation (1) and Equation (2), Ar=Lx×Ly.

Seven measurement evaluation regions each having a size of 2 μm×2 μm are selected from within the measurement region of 10 μm×10 μm. δa and δq of the seven measurement evaluation regions and δq/δa are calculated. Based on the five δq/δa values, excluding a maximum value and a minimum value from the seven δq/δa values, an average value of δq/δa is calculated.

$$[ Formula 3 ]$$

$$δ a = \frac{1}{Ar} {\int }_{0}^{Lx} {\int }_{0}^{Ly} \vert f ( x , y ) \vert dxdy \qquad Equation ( 1 )$$

$$[ Formula 4 ]$$

$$δ q = \sqrt{\frac{1}{Ar} {\int }_{0}^{Lx} {\int }_{0}^{Ly} \vert {f}^{2} ( x , y ) \vert dxdy} \qquad Equation ( 2 )$$

<2>

In the adhesion-promoting layer-coated polyester film according to <1>, a coefficient of variation of δq/δa, calculated based on the five δq/δa values, is lower than or equal to 0.150.

<3>

In the adhesion-promoting layer-coated polyester film according to <1> or <2>, when a refractive index in a slow axis direction within a plane is defined as nx, and a refractive index in a direction orthogonal to the slow axis within the same plane is defined as ny, nx and ny satisfy the following relationship.

nx−ny≤0.0300

<4>

In the adhesion-promoting layer-coated polyester film according to any one of <1> to <3>, a thickness is greater than or equal to 10 μm and less than or equal to 75 μm.

<5>

In the adhesion-promoting layer-coated polyester film according to any one of <1> to <4>, an in-plane retardation is less than or equal to 2000 nm.

<6>

In the adhesion-promoting layer-coated polyester film according to any one of <1> to <4>, an in-plane retardation is greater than or equal to 1800 nm and less than or equal to 2800 nm.

<7>

In the adhesion-promoting layer-coated polyester film according to any one of <1> to <6>, an Nz coefficient is higher than 2.0.

<8>

A film article includes a plurality of the adhesion-promoting layer-coated polyester films according to any one of <1> to <7>.

<9>

In the film article according to <8>, the film article is taken up around a take-up axis.

<10>

An optical laminate includes the polyester film according to any one of <1> to <7>; and one or more functional layers on the adhesion-promoting layer of the polyester film.

<11>

In the optical laminate according to <10>, among the one or more functional layers, the functional layer that is in contact with the adhesion-promoting layer contains a cured material of an ionizing radiation curable resin composition.

<12>

In the optical laminate according to <10> or <11>, a contact angle, at which a surface of the optical laminate on a side having the functional layer contacts pure water, is larger than or equal to 80 degrees.

<13>

A laminated article includes a plurality of the optical laminates according to any one of <10> to <12>.

<14>

In the laminated article according to <13>, the laminated article is taken up around a take-up axis.

<15>

A polarizing plate include:
a first transparent protective plate; a polarizer; and a second transparent protective plate in this order, wherein
at least one of the first transparent protective plate and the second transparent protective plate is the optical laminate according to any one of <10> to <12>, and the adhesion-promoting layer-coated polyester film is located between the functional layer and the polarizer.
   <16>

A panel includes: a support plate; and the adhesion-promoting layer-coated polyester film according to any one of <1> to <7>.

<17>

A surface plate includes:
a support plate; and the optical laminate according to any one of <10> to <12>, wherein
the adhesion-promoting layer-coated polyester film is located between the functional layer and the support plate.
   <18>

An image display panel includes: a display element; and the optical laminate according to any one of <10> to <12>.

<19>

An image display device includes the image display panel according to <18>.

Hereinafter, an adhesion-promoting layer-coated polyester film, a film article, an optical laminate, a laminated article, a polarizing plate, a surface plate, an image display panel, and an image display device according to the present embodiment will be described.

A numeric range expressed as “AA to BB” in this specification means “greater than or equal to AA and less than or equal to BB”.

In this specification, a plurality of upper limit candidates and a plurality of lower limit candidates regarding a numeric range may be described in separate sentences. In this description, the numeric range may be a combination of a selected one upper limit candidate and a selected one lower limit candidate. In an example, the sentence “Parameter B may be larger than or equal to A1, may be larger than or equal to A2, or may be larger than or equal to A3. Parameter B may be smaller than or equal to A4, may be smaller than or equal to A5, or may be smaller than or equal to A6.” will be discussed. In this example, the numeric range of parameter B may be larger than or equal to A1 and smaller than or equal to A4, may be larger than or equal to A1 and smaller than or equal to A5, may be larger than or equal to A1 and smaller than or equal to A6, may be larger than or equal to A2 and smaller than or equal to A4, may be larger than or equal to A2 and smaller than or equal to A5, may be larger than or equal to A2 and smaller than or equal to A6, may be larger than or equal to A3 and smaller than or equal to A4, may be larger than or equal to A3 and smaller than or equal to A5, or may be larger than or equal to A3 and smaller than or equal to A6.

### <<<Adhesion-Promoting Layer-Coated Polyester Film>>>

An adhesion-promoting layer-coated polyester film according to the present embodiment includes a polyester film and an adhesion-promoting layer located on the polyester film.

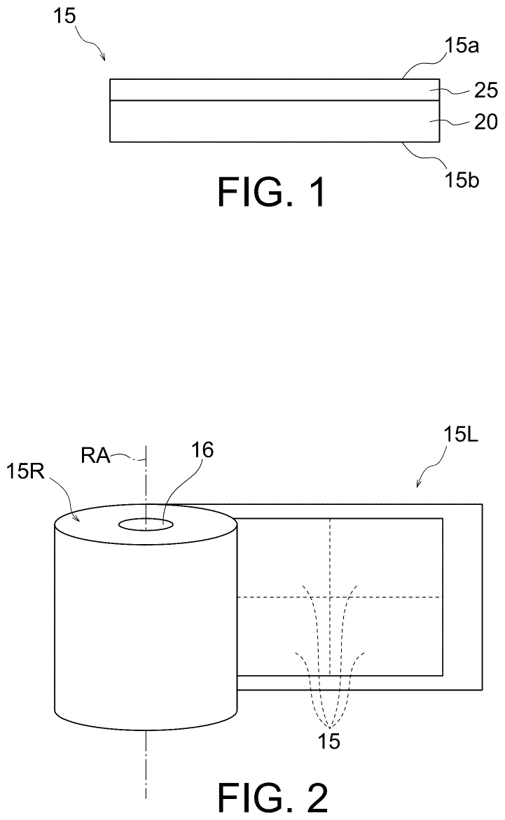

FIG. 1 is a longitudinal sectional view showing one example of the adhesion-promoting layer-coated polyester film. As shown in FIG. 1, the adhesion-promoting layer-coated polyester film 15 has a first surface 15a and a second surface 15b. The first surface 15a and the second surface 15b may be a pair of main surfaces of the adhesion-promoting layer-coated polyester film 15. The adhesion-promoting layer-coated polyester film 15 includes an adhesion-promoting layer 25 and a polyester film 20 in order from the first surface 15a toward the second surface 15b. In the illustrated example, the first surface 15a is constituted by the adhesion-promoting layer 25. In the illustrated example, the second surface 15b is constituted by the polyester film 20. The adhesion-promoting layer-coated polyester film 15 is used in an optical laminate 10.

The adhesion-promoting layer-coated polyester film according to the present embodiment includes the following feature (A) and feature (B). As described later, with the combination of the feature (A) and the feature (B), it is possible to improve the adhesion between the polyester film and the adhesion-promoting layer in the adhesion-promoting layer-coated polyester film having a high mechanical strength.

Feature (A): The plane orientation degree ΔP is higher than or equal to 0.150 and lower than or equal to 0.195.

Feature (B): The average value of δq/δa on the surface of the adhesion-promoting layer is higher than or equal to 1.125 and lower than or equal to 1.80.

<Calculation of Average Value of δq/δa in Feature B>

A 10 μm×10 μm region on the surface of the adhesion-promoting layer is measured using an atomic force microscope in a phase mode. A distribution of a phase signal on the surface of the adhesion-promoting layer is obtained through the measurement. A unit of the phase signal is [deg].

Sa denotes an arithmetic mean value of the phase signal shown in the following Equation (1). δq denotes a root mean square of the phase signal shown in the following Equation (2). In the following Equation (1) and Equation (2), orthogonal coordinate axes X and Y are placed on a reference surface that represents an average value of the phase signal, an axis orthogonal to the reference surface is defined as a Z axis, and a curved surface of the phase signal is defined as f(x,y). In the following Equation (1) and Equation (2), dimensions of a region for calculating δa and δq are Lx and Ly. In the following Equation (1) and Equation (2), Ar=Lx×Ly.

Seven measurement evaluation regions each having a size of 2 μm×2 μm are selected from within the measurement region of 10 μm×10 μm. δa and δq of the seven measurement evaluation regions and δq/δa are calculated. Based on the five δq/δa values, excluding a maximum value and a minimum value from the seven δq/δa values, an average value of δq/δa is calculated.

$$[ Formula 5 ]$$

$$δ a = \frac{1}{Ar} {\int }_{0}^{Lx} {\int }_{0}^{Ly} \vert f ( x , y ) \vert dxdy \qquad Equation ( 1 )$$

$$[ Formula 6 ]$$

$$\begin{matrix}δ q = \sqrt{\frac{1}{Ar} {\int }_{0}^{Lx} {\int }_{0}^{Ly} \vert {f}^{2} ( x , y ) \vert dxdy} & Equation ( 2 )\end{matrix}$$

### <<Features of Adhesion-Promoting Layer-Coated Polyester Film>>

### <Feature (A): Plane Orientation Degree ΔP>

The adhesion-promoting layer-coated polyester film has such a feature that the plane orientation degree ΔP is higher than or equal to 0.150 and lower than or equal to 0.195, as the above-described feature <A>.

The plane orientation degree ΔP is expressed by “ΔP=((nx+ny)/2)−nz”. “nx” is a refractive index in the slow axis direction in the plane of the adhesion-promoting layer-coated polyester film. “ny” is a refractive index in the fast axis direction in the plane of the adhesion-promoting layer-coated polyester film. “nz” is a refractive index in the thickness direction of the adhesion-promoting layer-coated polyester film. The slow axis is a direction in which the refractive index is highest in the plane of the adhesion-promoting layer-coated polyester film. The fast axis is a direction orthogonal to the slow axis in the plane of the adhesion-promoting layer-coated polyester film.

In this specification, the refractive indices such as nx, ny, and nz, the plane orientation degree ΔP, the in-plane retardation, and the thickness direction retardation are values for light with a wavelength of 589 nm, unless otherwise specified. In this specification, the in-plane retardation is also referred to as “Re”. In this specification, the thickness direction retardation is also referred to as “Rth”.

In the feature (A), it is specified that the plane orientation degree ΔP expressed by “((nx+ny)/2)−nz” is higher than or equal to 0.150 and lower than or equal to 0.195. The plane orientation degree ΔP is a parameter that indicates the strength of the orientation over the entire surface of a target film-shaped member.

As specified in the feature (A), a lower limit is set on the plane orientation degree ΔP. By setting a lower limit on the plane orientation degree ΔP, it is possible to impart excellent mechanical strength to the adhesion-promoting layer-coated polyester film. From this viewpoint, the plane orientation degree ΔP may be higher than or equal to 0.150, may be higher than or equal to 0.151, may be higher than or equal to 0.154, may be higher than or equal to 0.156, may be higher than or equal to 1.58, may be higher than or equal to 0.161, or may be higher than or equal to 0.176.

According to the study of the inventors of the present application, the following findings were obtained. When the plane orientation degree ΔP of the adhesion-promoting layer-coated polyester film was set to 0.150 or higher, the mechanical strength was improved. Furthermore, it has been found that, when the feature (B) is satisfied in addition to the feature (A), puncture resistance and bending resistance of the mechanical strength can be effectively improved. Puncture resistance and bending resistance are indicators indicating local mechanical properties, and puncture resistance serves as an indicator indicating more local mechanical properties than bending resistance. It has been confirmed that, when the feature (B) is satisfied in addition to the feature (A), puncture resistance, which is an evaluation indicator for local mechanical strength, can be improved very effectively, compared to the overall mechanical strength. By improving puncture resistance, it is possible to impart impact resistance to adhesion-promoting layer-coated polyester films and optical laminates, so it is possible to suppress occurrence of local damage, such as formation of through-holes, to adhesion-promoting layer-coated polyester films and optical laminates.

For example, during handling, such as during production of an optical laminate, the adhesion-promoting layer-coated polyester film may be curved, which can lead to local damage to the adhesion-promoting layer-coated polyester film. For example, holes can be formed in the adhesion-promoting layer-coated polyester film. In recent years, with the increase in size of display devices, optical laminates and adhesion-promoting layer-coated polyester films have also been increasing in size. Since a large-sized adhesion-promoting layer-coated polyester film can be curved with a large curvature, so local damage tends to occur in the adhesion-promoting layer-coated polyester film. Optical laminates including adhesion-promoting layer-coated polyester films are used for applications that are folded during use, that is, foldable applications. Local damage is also likely to occur in the adhesion-promoting layer-coated polyester film when the adhesion-promoting layer-coated polyester film is used in foldable applications.

Puncture resistance is a mechanical property that has been increasing in importance in recent years. The inventors of the present application have confirmed that, by setting a lower limit on the plane orientation degree ΔP, the mechanical strength of the adhesion-promoting layer-coated polyester film can be improved. When a lower limit is set on the plane orientation degree ΔP together with the feature (B), puncture resistance can be improved. Puncture resistance shows a stronger correlation with the plane orientation degree ΔP when the feature (B) is satisfied, compared to when the feature (B) is not satisfied.

Generally, in terms of mechanical properties, scratch resistance has been more focused on than pure mechanical strength. Examples of scratch resistance evaluation tests include pencil hardness and steel wool resistance. Scratch resistance does not necessarily correlate with puncture resistance. The inventors of the present application have actually confirmed that, in some cases, the puncture resistance of an adhesion-promoting layer-coated polyester film having a high pencil hardness was insufficient. In light of the background, the advantageous effect that the combination of the feature (A) and the feature (B) can stably improve puncture resistance is an unexpected advantageous effect that exceeds a range predictable from the current state of the art.

The details of the mechanism by which the combination of the feature (A) and the feature (B) improves puncture resistance are not clear. It is presumed that by improving the overall orientation through the feature (A) and by making the mechanical properties uniform from a more local viewpoint than puncture resistance through the feature (B), not only the overall mechanical strength but also the more local bending resistance and the puncture resistance, which serves as an evaluation indicator for the more local mechanical strength than bending resistance, can be stably improved. However, the present disclosure is not bound by this presumption.

In the feature (A), an upper limit is set on the plane orientation degree ΔP. By setting an upper limit on the plane orientation degree ΔP, damage such as tearing and breakage of the adhesion-promoting layer-coated polyester film can be suppressed. When the plane orientation degree ΔP exceeds 0.195, bending resistance and puncture resistance can decrease. From this viewpoint, the plane orientation degree ΔP may be lower than or equal to 0.195, may be lower than or equal to 0.193, may be lower than or equal to 0.191, may be lower than or equal to 0.189, or may be 0.187.

The plane orientation degree ΔP may be higher than or equal to 0.150 and lower than or equal to 0.195, may be higher than or equal to 0.150 and lower than or equal to 0.193, may be higher than or equal to 0.150 and lower than or equal to 0.191, may be higher than or equal to 0.150 and lower than or equal to 0.189, or may be higher than or equal to 0.150 and lower than or equal to 0.187. The plane orientation degree ΔP may be higher than or equal to 0.151 and lower than or equal to 0.195, may be higher than or equal to 0.151 and lower than or equal to 0.193, may be higher than or equal to 0.151 and lower than or equal to 0.191, may be higher than or equal to 0.151 and lower than or equal to 0.189, or may be higher than or equal to 0.151 and lower than or equal to 0.187. The plane orientation degree ΔP may be higher than or equal to 0.154 and lower than or equal to 0.195, may be higher than or equal to 0.154 and lower than or equal to 0.193, may be higher than or equal to 0.154 and lower than or equal to 0.191, may be higher than or equal to 0.154 and lower than or equal to 0.189, or may be higher than or equal to 0.154 and lower than or equal to 0.187. The plane orientation degree ΔP may be higher than or equal to 0.156 and lower than or equal to 0.195, may be higher than or equal to 0.156 and lower than or equal to 0.193, may be higher than or equal to 0.156 and lower than or equal to 0.191, may be higher than or equal to 0.156 and lower than or equal to 0.189, or may be higher than or equal to 0.156 and lower than or equal to 0.187. The plane orientation degree ΔP may be higher than or equal to 0.158 and lower than or equal to 0.195, may be higher than or equal to 0.158 and lower than or equal to 0.193, may be higher than or equal to 0.158 and lower than or equal to 0.191, may be higher than or equal to 0.158 and lower than or equal to 0.189, or may be higher than or equal to 0.158 and lower than or equal to 0.187. The plane orientation degree ΔP may be higher than or equal to 0.161 and lower than or equal to 0.195, may be higher than or equal to 0.161 and lower than or equal to 0.193, may be higher than or equal to 0.161 and lower than or equal to 0.191, may be higher than or equal to 0.161 and lower than or equal to 0.189, or may be higher than or equal to 0.161 and lower than or equal to 0.187. The plane orientation degree ΔP may be higher than or equal to 0.176 and lower than or equal to 0.195, may be higher than or equal to 0.158 and lower than or equal to 0.193, may be higher than or equal to 0.158 and lower than or equal to 0.191, may be higher than or equal to 0.158 and lower than or equal to 0.189, or may be higher than or equal to 0.158 and lower than or equal to 0.187.

The nx, ny, nz, plane orientation degree ΔP, in-plane retardation Re (described later), and thickness direction retardation Rth of the adhesion-promoting layer-coated polyester film were values determined using a retardation measuring device “RETS-100” manufactured by Otsuka Electronics Co., Ltd. The measurement is conducted on the adhesion-promoting layer-coated polyester film, rather than on the adhesion-promoting layer or polyester film, peeled from the adhesion-promoting layer-coated polyester film. Determination of values using “RETS-100” is performed in accordance with the following procedure of steps (P1) to (P6).

(P1) Initially, before the measurement is started, a light source is turned on for 60 minutes or longer. By turning on the light source for 60 minutes, the output of the light source is stabilized. After that, a rotating analyzer method is selected, and a θ mode (the mode for measuring angular retardation and calculating Rth) is selected. When the θ mode is selected, a stage becomes a tilt and rotation stage.

(P2) Subsequently, the following measurement conditions are input to the measuring device.
Retardation measurement range: rotating analyzer method
Measurement spot diameter: φ5 mm
Inclination angle range: −40° to 40°
Measurement wavelength range: 400 nm to 800 nm
   The “average refractive index N of the film” and the “film thickness” are input. For the “average refractive index N of the film”, the average refractive index of the polyester film included in the adhesion-promoting layer-coated polyester film to be measured is input. When the polyester film used is a PET film, “1.617” is input as the “average refractive index N of the film”. For the “film thickness”, the thickness of the adhesion-promoting layer-coated polyester film, which is measured by a method (described later), is input.

(P3) After that, background data is acquired in a state where no sample is placed in the measuring device. The measuring device is a closed system. Each time the light source is turned on, background data is acquired.

(P4) Subsequently, the sample is placed in the measuring device. When a plurality of samples is extracted from the adhesion-promoting layer-coated polyester film to be measured, the orientations of the plurality of samples are aligned. Specifically, the orientations are aligned in the following procedure. Each of the plurality of samples extracted from the adhesion-promoting layer-coated polyester film is marked with an arrow indicating a first reference direction and a first side in the first reference direction of the adhesion-promoting layer-coated polyester film to be measured. A sample stage where the samples are sequentially placed is marked in advance with an arrow indicating a second reference direction and a first side in the second reference direction is attached. When each sample is placed on the sample stage, the first reference direction and the second reference direction are aligned in parallel, and the first side in the first reference direction and the first side in the second reference direction are aligned with each other.

(P5) Measurement is started. Initially, the measuring device identifies a slow axis while rotating the sample through 360°. Subsequently, the measuring device presents choices for the slow axis and the fast axis, so the slow axis is selected. By selecting the slow axis, the measuring device measures the retardation (Re) while rotating the sample stage around the slow axis. The measuring device measures the retardation (Re) at each angle every 10° within the set inclination angle range (−40° to) 40° for several wavelengths within the set measurement wavelength range (longer than or equal to 400 nm and shorter than or equal to 800 nm). Among the obtained measured values, the measured value at an inclination angle of 0° for a wavelength of 589 nm is set for the value of the retardation (Re) of the sample to be measured.

(P6) Subsequently, the command “Display three-dimensional refractive index” is selected. At this time, a data table is displayed; however, this data table is not set for the measurement results. The command “Settings button” is selected. Then, input the “average refractive index N of the film” and the “film thickness” are input.

For the “average refractive index N of the film”, the average refractive index of the polyester film included in the adhesion-promoting layer-coated polyester film to be measured is input. When the polyester film used is a PET film, “1.617” is input as the “average refractive index N of the film”. For the “film thickness”, the thickness of the adhesion-promoting layer-coated polyester film, which is measured by a method (described later), is input. As a result, the measured values for the adhesion-promoting layer-coated polyester film to be measured are output.

Here, the measured values of the refractive index nx, the refractive index ny, the refractive index nz, the thickness direction retardation Rth, and the plane orientation degree ΔP are obtained. The measured values for the parameters at several wavelengths are output as the measurement results. Among the obtained measured values, the measured values at the wavelength of 589 nm are set for the refractive index nx, the refractive index ny, the refractive index nz, the thickness direction retardation Rth, and the plane orientation degree ΔP for the sample to be measured.

Each of nx, ny, nz, ΔP, Re, and Rth is measured at seven positions. The maximum value and the minimum value are excluded from seven measured values, and the average value of the remaining five measured values is calculated. The average value is set for the value of a corresponding one of nx, ny, nz, ΔP, Re, and Rth.

Before the measurements of measurements of nx, ny, nz, plane orientation degree ΔP, in-plane retardation Re, and thickness direction retardation Rth are started, the measurement sample is placed in a measurement environment for 16 hours. The measurement environment is a temperature of 23 °C±2 °C and a relative humidity of 50%±5%.

<Feature B: Average Value of δq/δa>

The adhesion-promoting layer-coated polyester film has such a feature that the average value of δq/δa on the surface of the adhesion-promoting layer is higher than or equal to 1.125 and lower than or equal to 1.80, as the above-described feature (B). The “average value of δq/δa” is determined as follows.

A 10 μm×10 μm region on the surface of the adhesion-promoting layer is measured using an atomic force microscope in a phase mode. In the example shown in FIG. 1, the 10 μm×10 μm region on the surface of the first surface 15a is an object to be measured. Through this measurement, the distribution of a phase signal on the surface of the adhesion-promoting layer is obtained. The unit of the phase signal is [deg]. “8a” is the arithmetic mean value of the phase signal shown in the following Equation (1). “δq” is the root mean square of the phase signal shown in the following Equation (2).

In the following Equation (1) and Equation (2), orthogonal coordinate axes X and Y are placed on a reference surface that represents an average value of the phase signal, an axis orthogonal to the reference surface is defined as a Z axis, and a curved surface of the phase signal is defined as f(x,y). In the following Equation (1) and Equation (2), dimensions of a region for calculating δa and δq are Lx and Ly. In the following Equation (1) and Equation (2), Ar=Lx×Ly.

Seven measurement evaluation regions each having a size of 2 μm×2 μm are selected from within the measurement region of 10 μm×10 μm. δa and δq of the seven measurement evaluation regions and δq/δa are calculated. Based on the five δq/δa values, excluding a maximum value and a minimum value from the seven δq/δa values, an average value of δq/δa is calculated. The calculated average value is set for the average value of δq/δa.

The seven measurement evaluation regions may partially overlap each other. However, an overlap ratio between any one measurement evaluation region and each of the other six measurement evaluation regions is lower than or equal to 25% based on an area of the measurement evaluation region.

The other measurement conditions for measuring the average value of δq/δa will be described later.

$$[ Formula 7 ]$$

$$δ a = \frac{1}{Ar} {\int }_{0}^{Lx} {\int }_{0}^{Ly} \vert f ( x , y ) \vert dxdy \qquad Equation ( 1 )$$

$$[ Formula 8 ]$$

$$\begin{matrix}δ q = \sqrt{\frac{1}{Ar} {\int }_{0}^{Lx} {\int }_{0}^{Ly} \vert {f}^{2} ( x , y ) \vert dxdy} & Equation ( 2 )\end{matrix}$$

In a case where no adhesion-promoting layer is provided, even when a functional layer is formed on a polyester film, it is not possible to provide good adhesion of the optical laminate including both the polyester film and the functional layer. When the average value of δq/δa on the surface of an adhesion-promoting layer exceeds 1.80 even when the adhesion-promoting layer is formed on a polyester film, it is not possible to provide good adhesion of the optical laminate including the polyester film, the adhesion-promoting layer, and the functional layer in this order.

Hereinafter, the technical significance of the average value of δq/δa on the surface of the adhesion-promoting layer will be described.

δa and δq are parameters related to a phase signal when a predetermined region on the surface of the adhesion-promoting layer is measured using an atomic force microscope in a phase mode. The unit of the phase signal is [deg]. The phase signal indicates the viscoelasticity of the surface of the adhesion-promoting layer. The atomic force microscope measures the physical properties of the surface by scanning the surface of the sample with a minute probe attached to a flat spring. In the phase mode, a variation in vibration phase within the plane can be mapped by measuring while vibrating the probe. For this reason, in the phase mode, it is possible to map the contrast caused by differences in the viscoelasticity of the surface components.

δa is the arithmetic mean value of a phase signal in a predetermined region. δq is the root mean square of a phase signal in a predetermined region. The root mean square emphasizes values that are distant from the arithmetic mean value. Even when the value of δa, which is an arithmetic mean value, is the same, when variation of the phase signal within a predetermined region is large, the average value of δq, which is a root mean square, becomes large. Even when the value of δa, which is an arithmetic mean value, is the same, when variation of the phase signal in a predetermined region is large, the average value of δq/δa becomes large. Conversely, even when the value of δa, which is an arithmetic mean value, is the same, when variation of the phase signal in a predetermined region is small, the average value of δq/δa becomes small. In other words, the adhesion-promoting layer with a small arithmetic mean value of δq/δa indicates that the phase signal is concentrated near the arithmetic mean value of the phase signal in a predetermined region, and shows that variation of the phase signal is small in the predetermined region. Since the phase signal indicates the viscoelasticity of the surface of the adhesion-promoting layer, the adhesion-promoting layer with a small average value of δq/δa indicates that a change in viscoelasticity is small in the predetermined region.

A phase signal indicates a relative variation amount within the same image. Therefore, in general, it is not possible to compare the δa and δq among different samples. In the present disclosure, attention is focused on δq/δa that is the ratio between δq and δa. As described above, δq/δa is a parameter that indicates phase variation within a sample and is a dimensionless parameter. Therefore, δq/δa can be considered an appropriate parameter for comparing the degree of phase variation between different samples.

As described above, the adhesion-promoting layer with a small average value of δq/δa indicates that a change in viscoelasticity is small in the predetermined region. Then, a polyester film including the adhesion-promoting layer with a small average value of δq/δa can enhance the adhesion between the adhesion-promoting layer and the polyester film. The adhesion of the optical laminate is believed to be good for the following reasons.

When other members contact the functional layer of the optical laminate, a predetermined stress occurs. The stress is transmitted to the interface between the polyester film and the adhesion-promoting layer through the functional layer and the adhesion-promoting layer. The way in which stress is transmitted varies depending on the value of the viscoelasticity of the adhesion-promoting layer. Therefore, when there is a significant change in the viscoelasticity within the plane of the adhesion-promoting layer, the magnitude of the stress transmitted to the interface between the polyester film and the adhesion-promoting layer vary depending on the position within the plane. Therefore, when the average value of δq/δa of the adhesion-promoting layer is large, the optical laminate is likely to cause interfacial delamination due to application of significant stress at a predetermined position in the plane. On the other hand, when the average value of δq/δa of the adhesion-promoting layer is small, stress is dispersed within the plane, so it is believed to be able to suppress interfacial delamination of the optical laminate and achieve high adhesion. When the average value of δq/δa of the adhesion-promoting layer is small, it is understood that the starting point of delamination is less likely to be formed. However, the present disclosure is not bound by this presumption.

One reason why the viscoelasticity of the adhesion-promoting layer varies among positions is believed to be, for example, the compatibility of the components that make up the adhesion-promoting layer. For example, by improving the compatibility of the components contained in the coating liquid used to form the adhesion-promoting layer, the viscoelasticity of the adhesion-promoting layer can be made uniform.

The average value of δq/δa is influenced by the compatibility of the coating liquid used to form the adhesion-promoting layer and the phase separation state of the components contained in the coating liquid. For example, even when the composition of the resin that makes up the adhesion-promoting layer is the same, the average value of δq/δa can be adjusted depending on the compatibility of the coating liquid and the phase separation state of the components. Depending on the drying conditions and curing conditions when a cured film is formed from a coating liquid as well, the average value of δq/δa can be adjusted by changing the phase separation state of the adhesion-promoting layer.

Another reason why the viscoelasticity of the adhesion-promoting layer varies among positions is believed to be variation of the molecular orientation of the polyester film. By increasing the Nz coefficient to higher than 2.0 as described later, the viscoelasticity of the adhesion-promoting layer can be made uniform.

The average value of δq/δa may be lower than or equal to 1.80, may be lower than or equal to 1.79, may be lower than or equal to 1.74, may be lower than or equal to 1.71, may be lower than or equal to 1.68, may be lower than or equal to 1.65, may be lower than or equal to 1.61, may be lower than or equal to 1.59, may be lower than or equal to 1.56, or may be lower than or equal to 1.38. As the average value of δq/δa decreases, the viscoelasticity of the surface of the adhesion-promoting layer approaches a uniform state. By setting an upper limit on the average value of δq/δa, it is possible to ensure the uniformity of mechanical properties to improve the adhesion of the polyester film and the adhesion-promoting layer.

When the viscoelasticity of the surface of the adhesion-promoting layer is excessively uniform, the components of the functional layer are difficult to penetrate into the adhesion-promoting layer. Therefore, when the viscoelasticity of the surface of the adhesion-promoting layer is excessively uniform, the adhesion between the adhesion-promoting layer and the functional layer can decrease. From this viewpoint, the average value of δq/δa may be higher than or equal to 1.125, may be higher than or equal to 1.13, may be higher than or equal to 1.20, may be higher than or equal to 1.25, may be higher than or equal to 1.31, or may be higher than or equal to 1.33.

The average value of δq/δa may be higher than or equal to 1.125 and lower than or equal to 1.80, may be higher than or equal too 1.125 and lower than or equal to 1.77, may be higher than or equal to 1.125 and lower than or equal to 1.74, may be higher than or equal to 1.125 and lower than or equal to 1.71, may be higher than or equal to 1.125 and lower than or equal to 1.68, may be higher than or equal to 1.125 and lower than or equal to 1.65, may be higher than or equal to 1.125 and lower than or equal to 1.61, may be higher than or equal to 1.125 and lower than or equal to 1.59, may be higher than or equal to 1.125 and lower than or equal to 1.56, or may be higher than or equal to 1.125 and lower than or equal to 1.38. The average value of δq/δa may be higher than or equal to 1.13 and lower than or equal to 1.80, may be higher than or equal too 1.13 and lower than or equal to 1.77, may be higher than or equal to 1.13 and lower than or equal to 1.74, may be higher than or equal to 1.13 and lower than or equal to 1.71, may be higher than or equal to 1.13 and lower than or equal to 1.68, may be higher than or equal to 1.13 and lower than or equal to 1.65, may be higher than or equal to 1.13 and lower than or equal to 1.61, may be higher than or equal to 1.13 and lower than or equal to 1.59, may be higher than or equal to 1.13 and lower than or equal to 1.56, or may be higher than or equal to 1.13 and lower than or equal to 1.38. The average value of δq/δa may be higher than or equal to 1.20 and lower than or equal to 1.80, may be higher than or equal too 1.20 and lower than or equal to 1.77, may be higher than or equal to 1.20 and lower than or equal to 1.74, may be higher than or equal to 1.20 and lower than or equal to 1.71, may be higher than or equal to 1.20 and lower than or equal to 1.68, may be higher than or equal to 1.20 and lower than or equal to 1.65, may be higher than or equal to 1.20 and lower than or equal to 1.61, may be higher than or equal to 1.20 and lower than or equal to 1.59, may be higher than or equal to 1.20 and lower than or equal to 1.56, or may be higher than or equal to 1.20 and lower than or equal to 1.38. The average value of δq/δa may be higher than or equal to 1.25 and lower than or equal to 1.80, may be higher than or equal too 1.25 and lower than or equal to 1.77, may be higher than or equal to 1.25 and lower than or equal to 1.74, may be higher than or equal to 1.25 and lower than or equal to 1.71, may be higher than or equal to 1.25 and lower than or equal to 1.68, may be higher than or equal to 1.25 and lower than or equal to 1.65, may be higher than or equal to 1.25 and lower than or equal to 1.61, may be higher than or equal to 1.25 and lower than or equal to 1.59, may be higher than or equal to 1.25 and lower than or equal to 1.56, or may be higher than or equal to 1.25 and lower than or equal to 1.38. The average value of δq/δa may be higher than or equal to 1.31 and lower than or equal to 1.80, may be higher than or equal too 1.31 and lower than or equal to 1.77, may be higher than or equal to 1.31 and lower than or equal to 1.74, may be higher than or equal to 1.31 and lower than or equal to 1.71, may be higher than or equal to 1.31 and lower than or equal to 1.68, may be higher than or equal to 1.31 and lower than or equal to 1.65, may be higher than or equal to 1.31 and lower than or equal to 1.61, may be higher than or equal to 1.31 and lower than or equal to 1.59, may be higher than or equal to 1.31 and lower than or equal to 1.56, or may be higher than or equal to 1.31 and lower than or equal to 1.38. The average value of δq/δa may be higher than or equal to 1.33 and lower than or equal to 1.80, may be higher than or equal too 1.33 and lower than or equal to 1.77, may be higher than or equal to 1.33 and lower than or equal to 1.74, may be higher than or equal to 1.33 and lower than or equal to 1.71, may be higher than or equal to 1.33 and lower than or equal to 1.68, may be higher than or equal to 1.33 and lower than or equal to 1.65, may be higher than or equal to 1.33 and lower than or equal to 1.61, may be higher than or equal to 1.33 and lower than or equal to 1.59, may be higher than or equal to 1.33 and lower than or equal to 1.56, or may be higher than or equal to 1.33 and lower than or equal to 1.38.

The average value of δq/δa on the surface of the above-described adhesion-promoting layer is a value within the predetermined 10 μm×10 μm region. The proportion of the area where the value of δq/δa is lower than or equal to 1.80 in the total area of the surface of the adhesion-promoting layer is preferably higher than or equal to 80%, more preferably higher than or equal to 90%, further preferably higher than or equal to 95%, even more preferably higher than or equal to 98%, or most preferably 100%.

In the present disclosure, δa can be calculated using the above-described Equation (1). Equation (1) is based on the arithmetic mean height equation defined in ISO 25178-2:2012. In the arithmetic mean height equation defined in ISO 25178-2:2012, elevation is used as the Z-axis data. In Equation (1), a phase signal [deg], rather than elevation, is used as the Z-axis data. In other words, da and the arithmetic mean height defined in ISO 25178-2:2012 differ in that the former uses a phase signal [deg] as the Z-axis data, whereas the latter uses elevation [μm] as the Z-axis data.

In the present disclosure, δq can be calculated using the above-described Equation (2). Equation (2) is based on the root mean square height equation defined in ISO 25178-2:2012. In the root mean square height equation defined in ISO 25178-2:2012, elevation is used as the Z-axis data. In Equation (2), a phase signal [deg], rather than elevation, is used as the Z-axis data. In other words, δq and the root mean square height defined in ISO 25178-2:2012 differ in that the former uses a phase signal [deg] as the Z-axis data, whereas the latter uses elevation [μm] as the Z-axis data.

The average value of δq/δa can be calculated using the procedure of steps Q1 to Q4 described below.
(Q1) A 10 μm×10 μm region on the surface of the adhesion-promoting layer is measured using an atomic force microscope in a phase mode. In an example, when measurement is performed using “SPM-9600” manufactured by Shimadzu Corporation, it is preferable to adjust the P gain, the I gain, and the offset.
(Q2) Seven measurement evaluation regions each having a size of 2 μm×2 μm are selected from within a measurement region of 10 μm×10 μm.
(Q3) δa, δq, and δq/δa are calculated within each of the selected seven measurement evaluation regions.
(Q4) Based on the five δq/δa values, excluding a maximum value and a minimum value from the seven δq/δa values, the average value of δq/δa is calculated.

In A1 described above, “SPM-9600” manufactured by Shimadzu Corporation is an example of the atomic force microscope. The measurement using the atomic force microscope is conducted on the surface (first surface 15a) of the adhesion-promoting layer-coated polyester film, rather than on the adhesion-promoting layer peeled from the adhesion-promoting layer-coated polyester film.

In A2 described above, 2 μm×2 μm regions to be selected are selected from regions in which the maximum height of the amplitude measured with the atomic force microscope is less than or equal to 90 nm. The maximum height is the maximum height Sz defined in ISO 25178-2:2012. By selecting 2 μm×2 μm regions from the regions of which Sz is less than or equal to 90 nm, the influence of foreign matter and defects can be suppressed. The seven measurement evaluation regions are preferably selected so as not to overlap each other; however, the seven measurement evaluation regions may overlap each other. When the measurement evaluation regions overlap each other, the overlap ratio between any one measurement evaluation region and each of the other six measurement evaluation regions is lower than or equal to 25% based on an area of the measurement evaluation region. The overlap ratio between any one measurement evaluation region and each of the other six measurement evaluation regions is more preferably lower than or equal to 12% or is further preferably lower than or equal to 5%.

In A2 described above, to suppress the influence of foreign matter and defects, 2 μm×2 μm measurement evaluation regions to be selected are selected from regions in which the arithmetic mean height of the amplitude measured with the atomic force microscope is less than or equal to 10 nm. The arithmetic mean height is the arithmetic mean height Sa defined in ISO 25178-2:2012.

As described above, the adhesion-promoting layer-coated polyester film according to the present embodiment has the above-described feature (A) and feature (B). With the feature (A), the mechanical strength of the adhesion-promoting layer-coated polyester film can be improved. With the feature (B), the adhesion between the adhesion-promoting layer and the polyester film in the adhesion-promoting layer-coated polyester film can be improved. Therefore, with the combination of the feature (A) and the feature (B), it is possible to solve the challenge to improve the adhesion between the polyester film and the adhesion-promoting layer in the adhesion-promoting layer-coated polyester film with a high plane orientation degree, and furthermore, it is also possible to solve the challenge to improve the adhesion between the polyester film and the adhesion-promoting layer while imparting high mechanical strength to the adhesion-promoting layer-coated polyester film.

As already described, by combining the feature (A) and the feature (B), the mechanical strength of the adhesion-promoting layer-coated polyester film can be stably improved, and, particularly, the puncture resistance of the adhesion-promoting layer-coated polyester film can be stably improved. More specifically, as a synergistic effect of the combination of the feature (A) and the feature (B), it is possible to stably improve local mechanical strength such as puncture resistance and bending resistance.

By setting a lower limit on the plane orientation degree ΔP, it is believed that the mechanical strength can be improved. Additionally, according to the study of the inventors of the present application, it was considered that by setting an upper limit on the plane orientation degree ΔP, damage such as tearing and breakage was able to be suppressed and, as a result, bending resistance and puncture resistance were also able to be improved. However, even with the adhesion-promoting layer-coated polyester film of which the plane orientation degree ΔP was adjusted according to the feature (A), bending resistance and puncture resistance were sometimes unexpectedly insufficient. The test samples that exhibited insufficient bending resistance and puncture resistance were some of all the test samples. The inventors of the present application confirmed that the average value of δq/δa for the adhesion-promoting layer-coated polyester film that exhibited insufficient bending resistance and puncture resistance did not satisfy the feature (B).

For an adhesion-promoting layer-coated polyester film that satisfies the feature (A), when the average value of δq/δa increased, about 10% to 20% of samples obtained from the same adhesion-promoting layer-coated polyester film exhibited insufficient bending resistance or puncture resistance. Although the detailed mechanism by which this phenomenon occurs is not clear, the following matters were presumed.

When the average value of δq/δa is large, for example, when the average value of δq/δa exceeds 1.80, it is expected that phase separation of the adhesion-promoting layer has progressed. It is presumed that aggregation has occurred in the adhesion-promoting layer where phase separation has taken place. Aggregation within the adhesion-promoting layer can become a source of defects such as cracking and breakage.

When the average value of δq/δa is large, for example, when the average value of δq/δa exceeds 1.80, there is in-plane variation in the viscoelasticity of the adhesion-promoting layer, so the penetration state of a coating liquid into the adhesion-promoting layer for forming the functional layer is also not uniform in the plane. When other members contact the functional layer of the optical laminate, a predetermined stress occurs. The stress is transmitted to the interface between the polyester film and the adhesion-promoting layer through the functional layer and the adhesion-promoting layer. Due to the unevenness of the penetration state, the way in which stress is transmitted is not uniform, which can lead to local cohesive failure within the adhesion-promoting layer. Local cohesive failure within the adhesion-promoting layer can serve as a starting point for defects such as cracking and breakage.

When bending resistance and puncture resistance are evaluated, external force is locally applied to the adhesion-promoting layer-coated polyester film and the optical laminate. It is presumed that unexpected damage can occur due to concentration of an external force on a more local defective site located within a local region to which the external force is applied. However, the present disclosure is not bound by this presumption.

By setting an upper limit on the average value of δq/δa, the molecular orientation can be made sufficiently uniform, and occurrence of local defects can be sufficiently suppressed. By setting an upper limit on the average value of δq/δa of the adhesion-promoting layer-coated polyester film to which appropriate mechanical strength is imparted by the feature (A), excellent bending resistance and excellent puncture resistance can be stably imparted. In other words, it is possible to effectively suppress insufficient bending resistance and puncture resistance in some of a plurality of test samples obtained from a target to be evaluated.

As described above, from the viewpoint of more stably ensuring excellent bending resistance and excellent puncture resistance, an upper limit is set on the average value of δq/δa. The average value of δq/δa may be lower than or equal to 1.80, may be lower than or equal to 1.79, may be lower than or equal to 1.74, may be lower than or equal to 1.71, may be lower than or equal to 1.68, may be lower than or equal to 1.65, may be lower than or equal to 1.61, may be lower than or equal to 1.59, may be lower than or equal to 1.56, or may be lower than or equal to 1.38.

For an adhesion-promoting layer-coated polyester film that satisfies the feature (A), when the average value of δq/δa decreases, although the samples do not break, test marks remain on the samples, about 10% to 20% of the samples obtained from the same adhesion-promoting layer-coated polyester film are determined to have insufficient puncture resistance and bending resistance. Although the detailed mechanism by which this phenomenon occurs is not clear, the following matters are presumed.

When the average value of δq/δa is extremely small, for example, when the average value of δq/δa is lower than 1.125, the film quality of the adhesion-promoting layer is considered to be very uniform, and phase separation is considered to be not occurring in the adhesion-promoting layer. When a constant external force is repeatedly applied to such a uniform adhesion-promoting layer, the external force does not disperse within the adhesion-promoting layer-coated polyester film that is the combination of the uniform adhesion-promoting layer and the polyester film having the feature (A), with the result that the external force is repeatedly received at a certain position of the adhesion-promoting layer-coated polyester film. As a result, by repeatedly bending the adhesion-promoting layer-coated polyester film and the optical laminate at the certain position, it is expected that, although the adhesion-promoting layer-coated polyester film does not break, small cracking occurs in the adhesion-promoting layer to form test marks as whitish regions.

When the average value of δq/δa is extremely small, for example, when the average value of δq/δa is lower than 1.125, the puncture resistance can be insufficient even when the feature (A) is satisfied. When the average value of δq/δa is extremely small, the film quality of the adhesion-promoting layer is very uniform. Due to this uniformity, the impact external forces to be evaluated in terms of puncture resistance can be applied to an extremely small area of the adhesion-promoting layer-coated polyester film without being propagated and dispersed in a plane direction within the adhesion-promoting layer-coated polyester film that is a combination of the uniform adhesion-promoting layer and the polyester film having the feature (A). As a result, even when the feature (A) is satisfied, it is expected that puncture resistance can be insufficient although with a low probability.

By setting a lower limit on the average value of δq/δa, excessive uniformity of the adhesion-promoting layer can be suppressed. By setting a lower limit on the average value of δq/δa of the adhesion-promoting layer-coated polyester film to which appropriate mechanical strength is imparted by the feature (A), excellent bending resistance and excellent puncture resistance can be stably imparted. In other words, it is possible to effectively suppress insufficient bending resistance in some of a plurality of test samples obtained from a target to be evaluated.

As described above, from the viewpoint of more stably ensuring excellent bending resistance and excellent puncture resistance, a lower limit is set on the average value of δq/δa. The average value of δq/δa may be higher than or equal to 1.125, may be higher than or equal to 1.13, may be higher than or equal to 1.20, may be higher than or equal to 1.25, may be higher than or equal to 1.31, or may be higher than or equal to 1.33.

<Feature B1: Coefficient of Variation of δq/δa>

The adhesion-promoting layer-coated polyester film may further have the following feature (B1) in addition to the feature (A) and the feature (B).

Feature (B1): The coefficient of variation of δq/δa, calculated based on five δq/δa values, is lower than or equal to 0.150.

The “five δq/δa values” in the feature (B1) refer to the “five δq/δa values” used to calculate the average value of δq/δa specified in the feature (B). The coefficient of variation is obtained by dividing the standard deviation of targets by the average value of the targets. The coefficient of variation is a dimensionless value obtained by normalizing the standard deviation. The coefficient of variation specified in the feature (B1) is a value obtained by dividing the standard deviation of the five δq/δa values by the average value of the five δq/δa values.

By setting an upper limit on the coefficient of variation of δq/δa, the viscoelasticity between the five 2 μm×2 μm measurement evaluation regions can be made uniform. By setting the coefficient of variation of δq/δa to 0.150 or lower, the viscoelasticity of the adhesion-promoting layer can be made further uniform. As a result, the stress applied to the adhesion-promoting layer-coated polyester film is more evenly distributed in the plane. Thus, a starting point of interlayer delamination is less likely to occur, so the adhesion between the adhesion-promoting layer and the polyester film can be further improved. The adhesion between the adhesion-promoting layer and the functional layer in the optical laminate using this adhesion-promoting layer-coated polyester film can also be further improved. From the viewpoint of improvement in adhesion, the coefficient of variation of δq/δa may be lower than or equal to 0.150, may be lower than or equal to 0.143, may be lower than or equal to 0.130, may be lower than or equal to 0.110, or may be lower than or equal to 0.093.

When the coefficient of variation of δq/δa is excessively low, the components of the functional layer are difficult to penetrate into the adhesion-promoting layer, so it can also be assumed that the adhesion between the adhesion-promoting layer and the functional layer cannot be sufficiently improved. From this viewpoint, the coefficient of variation of δq/δa may be higher than or equal to 0.010, may be higher than or equal to 0.025, may be higher than or equal to 0.040, or may be higher than or equal to 0.049.

The coefficient of variation of δq/δa may be higher than or equal to 0.010 and lower than or equal to 0.150, may be higher than or equal to 0.010 and lower than or equal to 0.143, may be higher than or equal to 0.010 and lower than or equal to 0.130, may be higher than or equal to 0.010 and lower than or equal to 0.110, or may be higher than or equal to 0.010 and lower than or equal to 0.090. The coefficient of variation of δq/δa may be higher than or equal to 0.025 and lower than or equal to 0.150, may be higher than or equal to 0.025 and lower than or equal to 0.143, may be higher than or equal to 0.025 and lower than or equal to 0.130, may be higher than or equal to 0.025 and lower than or equal to 0.110, or may be higher than or equal to 0.025 and lower than or equal to 0.090. The coefficient of variation of δq/δa may be higher than or equal to 0.040 and lower than or equal to 0.150, may be higher than or equal to 0.040 and lower than or equal to 0.143, may be higher than or equal to 0.040 and lower than or equal to 0.130, may be higher than or equal to 0.040 and lower than or equal to 0.110, or may be higher than or equal to 0.040 and lower than or equal to 0.090. The coefficient of variation of δq/δa may be higher than or equal to 0.049 and lower than or equal to 0.150, may be higher than or equal to 0.049 and lower than or equal to 0.143, may be higher than or equal to 0.049 and lower than or equal to 0.130, may be higher than or equal to 0.049 and lower than or equal to 0.110, or may be higher than or equal to 0.049 and lower than or equal to 0.090.

<Feature A1: nx−ny>

The adhesion-promoting layer-coated polyester film may further have the following feature (A1) in addition to the feature (A) and the feature (B).

Feature (A1): In the adhesion-promoting layer-coated polyester film, when the refractive index in the slow axis direction within the plane of the adhesion-promoting layer-coated polyester film is defined as nx and the refractive index in the direction orthogonal to the slow axis within the same plane is defined as ny, nx and ny satisfy the following relationship.

nx−ny≤0.0300

By setting nx−ny to 0.0300 or smaller, it is possible to suppress rainbow unevenness caused by in-plane retardation. nx−ny may be smaller than or equal to 0.0300, may be smaller than or equal to 0.0250, may be smaller than or equal to 0.0240, or may be smaller than or equal to 0.0230.

In this specification, rainbow unevenness means rainbow unevenness when viewed with the naked eye, unless otherwise specified.

When the nx−ny of the adhesion-promoting layer-coated polyester film is excessively small, it is difficult to suppress blackout. From this viewpoint, nx−ny may be larger than or equal to 0.0050, may be larger than or equal to 0.0080, may be larger than or equal to 0.0100, may be larger than or equal to 0.0120, or may be larger than or equal to 0.0130. Blackout is a phenomenon where the entire surface appears dark when light that has passed through a polarizer and a polyester film in this order is viewed through a polarizer such as polarized sunglasses.

The value of nx−ny for the adhesion-promoting layer-coated polyester film may be larger than or equal to 0.0050 and smaller than or equal to 0.0300, may be larger than or equal to 0.0050 and smaller than or equal to 0.0250, may be larger than or equal to 0.0050 and smaller than or equal to 0.0240, or may be larger than or equal to 0.0050 and smaller than or equal to 0.0230. The value of nx-ny for the adhesion-promoting layer-coated polyester film may be larger than or equal to 0.0080 and smaller than or equal to 0.0300, may be larger than or equal to 0.0080 and smaller than or equal to 0.0250, may be larger than or equal to 0.0080 and smaller than or equal to 0.0240, or may be larger than or equal to 0.0080 and smaller than or equal to 0.0230. The value of nx-ny for the adhesion-promoting layer-coated polyester film may be larger than or equal to 0.0100 and smaller than or equal to 0.0300, may be larger than or equal to 0.0100 and smaller than or equal to 0.0250, may be larger than or equal to 0.0100 and smaller than or equal to 0.0240, or may be larger than or equal to 0.0100 and smaller than or equal to 0.0230. The value of nx-ny for the adhesion-promoting layer-coated polyester film may be larger than or equal to 0.0120 and smaller than or equal to 0.0300, may be larger than or equal to 0.0120 and smaller than or equal to 0.0250, may be larger than or equal to 0.0120 and smaller than or equal to 0.0240, or may be larger than or equal to 0.0120 and smaller than or equal to 0.0230. The value of nx-ny for the adhesion-promoting layer-coated polyester film may be larger than or equal to 0.0130 and smaller than or equal to 0.0300, may be larger than or equal to 0.0130 and smaller than or equal to 0.0250, may be larger than or equal to 0.0130 and smaller than or equal to 0.0240, or may be larger than or equal to 0.0130 and smaller than or equal to 0.0230.

### <Feature A2: In-Plane Retardation Re>

The adhesion-promoting layer-coated polyester film may further have the following feature (A2) in addition to the feature (A) and the feature (B).

Feature (A2): The in-plane retardation Re of the adhesion-promoting layer-coated polyester film is less than or equal to 2000 nm.

The in-plane retardation Re is a value obtained by “(nx−ny)×T [nm]”. T is the thickness [nm] of the adhesion-promoting layer-coated polyester film. By setting an upper limit on the in-plane retardation, rainbow unevenness can be suppressed. From this viewpoint, the in-plane retardation of the adhesion-promoting layer-coated polyester film may be less than or equal to 2000 nm, may be less than or equal to 1600 nm, may be less than or equal to 1400 nm, may be less than or equal to 1200 nm, may be less than or equal to 1148 nm, may be less than or equal to 1100 nm, may be less than or equal to 1000 nm, or may be less than or equal to 950 nm.

Rainbow unevenness can also be suppressed by adjusting the functional layer and the light source. There are applications in which rainbow unevenness is not regarded as important. Therefore, the in-plane retardation of the polyester film is not limited to 2000 nm or less and may be greater than 2000 nm.

By setting a lower limit on the in-plane retardation of the adhesion-promoting layer-coated polyester film, blackout can be suppressed. The reason for this is that polyester films with an in-plane retardation average of less than 50 nm can hardly disturb linearly polarized light and allow the linearly polarized light to pass through as it is, while polyester films with an in-plane retardation average of 50 nm or greater can disturb linearly polarized light. From this viewpoint, the in-plane retardation of the adhesion-promoting layer-coated polyester film may be greater than or equal to 50 nm, may be greater than or equal to 100 nm, may be greater than or equal to 150 nm, may be greater than or equal to 200 nm, may be greater than or equal to 250 nm, may be greater than or equal to 300 nm, may be greater than or equal to 400 nm, may be greater than or equal to 450 nm, or may be greater than or equal to 497 nm.

The in-plane retardation of the adhesion-promoting layer-coated polyester film may be greater than or equal to 50 nm and less than or equal to 2000 nm, may be greater than or equal to 50 nm and less than or equal to 1600 nm, may be greater than or equal to 50 nm and less than or equal to 1400 nm, may be greater than or equal to 50 nm and less than or equal to 1200 nm, may be greater than or equal to 50 nm and less than or equal to 1148 nm, may be greater than or equal to 50 nm and less than or equal to 1100 nm, may be greater than or equal to 50 nm and less than or equal to 1000 nm, or may be greater than or equal to 50 nm and less than or equal to 950 nm. The in-plane retardation of the adhesion-promoting layer-coated polyester film may be greater than or equal to 100 nm and less than or equal to 2000 nm, may be greater than or equal to 100 nm and less than or equal to 1600 nm, may be greater than or equal to 100 nm and less than or equal to 1400 nm, may be greater than or equal to 100 nm and less than or equal to 1200 nm, may be greater than or equal to 100 nm and less than or equal to 1148 nm, may be greater than or equal to 100 nm and less than or equal to 1100 nm, may be greater than or equal to 100 nm and less than or equal to 1000 nm, or may be greater than or equal to 100 nm and less than or equal to 950 nm. The in-plane retardation of the adhesion-promoting layer-coated polyester film may be greater than or equal to 150 nm and less than or equal to 2000 nm, may be greater than or equal to 150 nm and less than or equal to 1600 nm, may be greater than or equal to 150 nm and less than or equal to 1400 nm, may be greater than or equal to 150 nm and less than or equal to 1200 nm, may be greater than or equal to 150 nm and less than or equal to 1148 nm, may be greater than or equal to 150 nm and less than or equal to 1100 nm, may be greater than or equal to 150 nm and less than or equal to 1000 nm, or may be greater than or equal to 150 nm and less than or equal to 950 nm. The in-plane retardation of the adhesion-promoting layer-coated polyester film may be greater than or equal to 200 nm and less than or equal to 2000 nm, may be greater than or equal to 200 nm and less than or equal to 1600 nm, may be greater than or equal to 200 nm and less than or equal to 1400 nm, may be greater than or equal to 200 nm and less than or equal to 1200 nm, may be greater than or equal to 200 nm and less than or equal to 1148 nm, may be greater than or equal to 200 nm and less than or equal to 1100 nm, may be greater than or equal to 200 nm and less than or equal to 1000 nm, or may be greater than or equal to 200 nm and less than or equal to 950 nm. The in-plane retardation of the adhesion-promoting layer-coated polyester film may be greater than or equal to 250 nm and less than or equal to 2000 nm, may be greater than or equal to 250 nm and less than or equal to 1600 nm, may be greater than or equal to 250 nm and less than or equal to 1400 nm, may be greater than or equal to 250 nm and less than or equal to 1200 nm, may be greater than or equal to 250 nm and less than or equal to 1148 nm, may be greater than or equal to 250 nm and less than or equal to 1100 nm, may be greater than or equal to 250 nm and less than or equal to 1000 nm, or may be greater than or equal to 250 nm and less than or equal to 950 nm. The in-plane retardation of the adhesion-promoting layer-coated polyester film may be greater than or equal to 300 nm and less than or equal to 2000 nm, may be greater than or equal to 300 nm and less than or equal to 1600 nm, may be greater than or equal to 300 nm and less than or equal to 1400 nm, may be greater than or equal to 300 nm and less than or equal to 1200 nm, may be greater than or equal to 300 nm and less than or equal to 1148 nm, may be greater than or equal to 300 nm and less than or equal to 1100 nm, may be greater than or equal to 300 nm and less than or equal to 1000 nm, or may be greater than or equal to 300 nm and less than or equal to 950 nm. The in-plane retardation of the adhesion-promoting layer-coated polyester film may be greater than or equal to 400 nm and less than or equal to 2000 nm, may be greater than or equal to 400 nm and less than or equal to 1600 nm, may be greater than or equal to 400 nm and less than or equal to 1400 nm, may be greater than or equal to 400 nm and less than or equal to 1200 nm, may be greater than or equal to 400 nm and less than or equal to 1148 nm, may be greater than or equal to 400 nm and less than or equal to 1100 nm, may be greater than or equal to 400 nm and less than or equal to 1000 nm, or may be greater than or equal to 400 nm and less than or equal to 950 nm. The in-plane retardation of the adhesion-promoting layer-coated polyester film may be greater than or equal to 450 nm and less than or equal to 2000 nm, may be greater than or equal to 450 nm and less than or equal to 1600 nm, may be greater than or equal to 450 nm and less than or equal to 1400 nm, may be greater than or equal to 450 nm and less than or equal to 1200 nm, may be greater than or equal to 450 nm and less than or equal to 1148 nm, may be greater than or equal to 450 nm and less than or equal to 1100 nm, may be greater than or equal to 450 nm and less than or equal to 1000 nm, or may be greater than or equal to 450 nm and less than or equal to 950 nm. The in-plane retardation of the adhesion-promoting layer-coated polyester film may be greater than or equal to 497 nm and less than or equal to 2000 nm, may be greater than or equal to 497 nm and less than or equal to 1600 nm, may be greater than or equal to 497 nm and less than or equal to 1400 nm, may be greater than or equal to 497 nm and less than or equal to 1200 nm, may be greater than or equal to 497 nm and less than or equal to 1148 nm, may be greater than or equal to 497 nm and less than or equal to 1100 nm, may be greater than or equal to 497 nm and less than or equal to 1000 nm, or may be greater than or equal to 497 nm and less than or equal to 950 nm.

### <Feature A2a: In-Plane Retardation Re>

The adhesion-promoting layer-coated polyester film may further have the following feature (A2a) in addition to the feature (A) and the feature (B).

Feature (A2a): The in-plane retardation Re of the adhesion-promoting layer-coated polyester film is greater than or equal to 1800 nm and less than or equal to 2800 nm.

The adhesion-promoting layer-coated polyester film, of which the in-plane retardation Re is adjusted so as to be greater than or equal to 1800 nm and less than or equal to 2800 nm in accordance with the feature (A2a), has excellent transportability. As demonstrated in transport tests related to Reference Examples A to E (described later), the rate of change in transport speed during transport varies according to the in-plane retardation Re of the adhesion-promoting layer-coated polyester film. By setting the in-plane retardation Re to 1800 nm or greater and 2800 nm or less, variation in the transport speed of the adhesion-promoting layer-coated polyester film can be suppressed, and the adhesion-promoting layer-coated polyester film can be stably transported at a constant speed. As a result, it is possible to suppress occurrence of scratches or the like on the adhesion-promoting layer-coated polyester film due to variation in transport speed.

The detailed reason why transportability changes depending on the in-plane retardation Re is not clear. However, by setting the in-plane retardation Re to 1800 nm or greater and 2800 nm or less, it is presumed that the balance between three-dimensional rigidity and hardness in a long adhesion-promoting layer-coated polyester film is favorable and therefore transport speed is stable. The present disclosure is not bound by this presumption.

### <Feature A3: Thickness Direction Retardation Rth>

The adhesion-promoting layer-coated polyester film may further have the following feature (A3) in addition to the feature (A) and the feature (B).

Feature (A3): The thickness direction retardation Rth of the adhesion-promoting layer-coated polyester film is greater than or equal to 2000 nm.

The thickness direction retardation Rth is a value obtained by “((nx+ny)/2−nz)×T [nm]”. T is the thickness [nm] of the adhesion-promoting layer-coated polyester film. By setting a lower limit on the thickness direction retardation Rth, it is possible to suppress blackout when viewed not only in the front direction but also in an oblique direction. From this viewpoint, the thickness direction retardation Rth of the adhesion-promoting layer-coated polyester film may be greater than or equal to 2000 nm, may be greater than or equal to 3000 nm, may be greater than or equal to 4000 nm, or may be greater than or equal to 5000 nm.

The thickness direction retardation Rth of the adhesion-promoting layer-coated polyester film may be less than or equal to 15000 nm, may be less than or equal to 12000 nm, or may be less than or equal to 9000 nm to set Re/Rth within the range (described later).

The thickness direction retardation Rth of the adhesion-promoting layer-coated polyester film may be greater than or equal to 2000 nm and less than or equal to 15000 nm, may be greater than or equal to 2000 nm and less than or equal to 12000 nm, or may be greater than or equal to 2000 nm and less than or equal to 9000 nm. The thickness direction retardation Rth of the adhesion-promoting layer-coated polyester film may be greater than or equal to 3000 nm and less than or equal to 15000 nm, may be greater than or equal to 3000 nm and less than or equal to 12000 nm, or may be greater than or equal to 3000 nm and less than or equal to 9000 nm. The thickness direction retardation Rth of the adhesion-promoting layer-coated polyester film may be greater than or equal to 4000 nm and less than or equal to 15000 nm, may be greater than or equal to 4000 nm and less than or equal to 12000 nm, or may be greater than or equal to 4000 nm and less than or equal to 9000 nm. The thickness direction retardation Rth of the adhesion-promoting layer-coated polyester film may be greater than or equal to 5000 nm and less than or equal to 15000 nm, may be greater than or equal to 5000 nm and less than or equal to 12000 nm, or may be greater than or equal to 5000 nm and less than or equal to 9000 nm.

### <Feature A4: Re/Rth>

The adhesion-promoting layer-coated polyester film may further have the following feature (A4) in addition to the feature (A) and the feature (B).

Feature (A4): Re/Rth is higher than or equal to 0.01 and lower than or equal to 0.20.

A low Re/Rth means that the degree of stretching of the polyester film approaches balanced biaxiality. By setting an upper limit on Re/Rth, the mechanical strength of the adhesion-promoting layer-coated polyester film can be improved. By setting an upper limit on Re/Rth, it is possible to suppress occurrence of wrinkles in the adhesion-promoting layer-coated polyester film due to environmental changes to adversely affect visibility. From these viewpoints, Re/Rth may be lower than or equal to 0.20, may be lower than or equal to 0.17, or may be lower than or equal to 0.15. To exhibit the advantageous effects caused by setting Re/Rth within a predetermined range, the in-plane retardation of the adhesion-promoting layer-coated polyester film is preferably within the above range.

When Re/Rth is excessively low, the orientation in the XY plane is high, while the orientation in the Z-axis direction is low, which leads to a tendency to become brittle in the film thickness direction. Therefore, when Re/Rth is excessively low, the adhesion-promoting layer-coated polyester film can break when the adhesion-promoting layer-coated polyester film is attached to an adherend or the adhesion-promoting layer-coated polyester film is removed from the adherend. From these viewpoints, the Re/Rth of the polyester film is preferably higher than or equal to 0.01, more preferably higher than or equal to 0.03, more preferably higher than or equal to 0.05, or more preferably higher than or equal to 0.06.

The Re/Rth of the adhesion-promoting layer-coated polyester film may be higher than or equal to 0.01 and lower than or equal to 0.20, may be higher than or equal to 0.01 and lower than or equal to 0.17, or may be higher than or equal to 0.01 and lower than or equal to 0.15. The Re/Rth of the adhesion-promoting layer-coated polyester film may be higher than or equal to 0.03 and lower than or equal to 0.20, may be higher than or equal to 0.03 and lower than or equal to 0.17, or may be higher than or equal to 0.03 and lower than or equal to 0.15. The Re/Rth of the adhesion-promoting layer-coated polyester film may be higher than or equal to 0.05 and lower than or equal to 0.20, may be higher than or equal to 0.05 and lower than or equal to 0.17, or may be higher than or equal to 0.05 and lower than or equal to 0.15. The Re/Rth of the adhesion-promoting layer-coated polyester film may be higher than or equal to 0.06 and lower than or equal to 0.20, may be higher than or equal to 0.06 and lower than or equal to 0.17, or may be higher than or equal to 0.06 and lower than or equal to 0.15.

### <Feature A5: Nz Coefficient>

The adhesion-promoting layer-coated polyester film may further have the following feature (A5) in addition to the feature (A) and the feature (B).

Feature (A5): The Nz coefficient is higher than 2.0.

The Nz coefficient is a value obtained by “(Rth/Re)+0.5”. As already described, “Rth” is the thickness direction retardation of the adhesion-promoting layer-coated polyester film. As already described, “Re” is the in-plane retardation of the adhesion-promoting layer-coated polyester film.

The Nz coefficient decreases when the polyester film is uniaxially stretched or close to uniaxial stretching. A state close to uniaxial stretching includes a case where the stretching ratio in the first axis and the stretching ratio in the second axis significantly differ. In the feature (A5), a lower limit is set on the Nz coefficient. An adhesion-promoting layer-coated polyester film that satisfies the feature (A5) can be obtained by stretching in each of two orthogonal directions at a certain stretching ratio or higher. In other words, an adhesion-promoting layer-coated polyester film having the feature (A5) includes a biaxially stretched polyester film.

The term “biaxial stretching” used in this specification means that the Nz coefficient is higher than 2.0. The term “uniaxial stretching” in this specification means that the Nz coefficient is lower than or equal to 2.0.

In the feature (B), the numeric range of the average value of δq/δa is specified. From the viewpoint of setting the average value of δq/δa to lower than or equal to the upper limit specified in the feature (B), it is effective to make the molecular orientation of the polyester film uniform.

For example, when a uniaxially stretched polyester film or a polyester film close to the uniaxially stretched polyester film is used, there is a direction in which the polyester film is stretched at a high stretching ratio. The molecular orientation of the polyester film is made uniform to some extent along this stretching direction. However, the molecular orientation of the polyester film along a direction that is not parallel to the stretching direction, such as along a direction orthogonal to the stretching direction, tends to be non-uniform. When the molecular orientation of the polyester film is non-uniform, the wettability of the coating liquid on the polyester film for forming the adhesion-promoting layer decreases, and the coating liquid may be repelled from the polyester film. The repellency of the coating liquid can cause variations in the mechanical properties of the adhesion-promoting layer produced from the coating liquid in the plane, and can even cause defects. As a result, the average value of δq/δa increases.

In an adhesion-promoting layer-coated polyester film using a uniaxially stretched polyester film or a polyester film close to the uniaxially stretched polyester film, it is not easy to stably and sufficiently reduce the average value of δq/δa. In an adhesion-promoting layer-coated polyester film that does not have the feature (A5), it is not easy to stably set the average value of δq/δa to lower than or equal to the upper limit specified in the feature (B).

In an adhesion-promoting layer-coated polyester film that satisfies the feature (A5), the birefringent refractive index (nx-ny) in the plane is small. When the birefringent refractive index in the plane is small, the molecular orientation of the polyester film is uniform in the plane. The quality and characteristics of the adhesion-promoting layer formed by directly applying the coating liquid onto the polyester film are easily influenced by the polyester film serving as a base, since the thickness of the adhesion-promoting layer is usually less than 1 μm and quite thin. By applying the coating liquid onto a polyester film of which the molecular orientation is uniform in the plane to form an adhesion-promoting layer, the adhesion-promoting layer can be made uniform. The wettability of the coating liquid for forming an adhesion-promoting layer on a polyester film of which the molecular orientation is uniform in the plane can be good throughout the entire region. From this point as well, a uniform adhesion-promoting layer can be formed. As a result, the average value of δq/δa can be stably set to lower than or equal to the upper limit specified in the feature (B), so changes in mechanical properties and viscoelasticity within the adhesion-promoting layer can be suppressed.

In addition, the feature (A5) not only can contribute to formation of a uniform adhesion-promoting layer as described above but also can make the properties of the adhesion-promoting layer-coated polyester film uniform. In a polyester film of which the birefringence (nx-ny) in the plane is large, the transmittance can change according to the vibration direction of light. With the adhesion-promoting layer-coated polyester film that satisfies the feature (A5), the transmittance can be kept constant regardless of direction. With the adhesion-promoting layer-coated polyester film that satisfies the feature (A5), it is possible to reduce the necessity of systematically positioning in consideration of the slow axis and the transmission axis. By satisfying the feature (A5), the mechanical properties of the adhesion-promoting layer-coated polyester film can be made uniform.

### <Thickness of Adhesion-Promoting Layer-Coated Polyester Film>

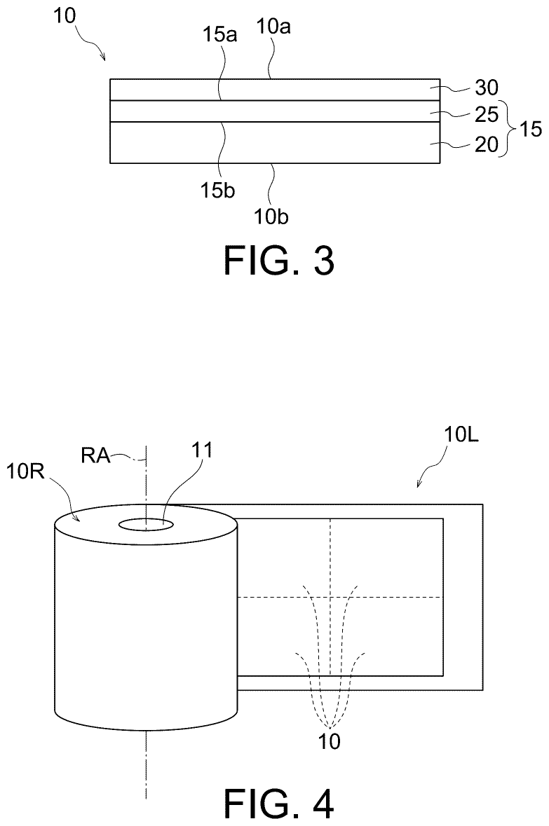

A lower limit may be set on the thickness of the adhesion-promoting layer-coated polyester film. By setting a lower limit on the thickness of the adhesion-promoting layer-coated polyester film, high mechanical strength can be imparted to the adhesion-promoting layer-coated polyester film. High puncture resistance can be imparted to the adhesion-promoting layer-coated polyester film. From this viewpoint, the thickness of the adhesion-promoting layer-coated polyester film may be greater than or equal to 10 μm, may be greater than or equal to 21 μm, may be greater than or equal to 25 μm, or may be greater than or equal to 30 μm. By setting the thickness of the polyester film to 10 μm or greater, stress can be made less likely to be transmitted to the interface between the polyester film and the adhesion-promoting layer when another member contacts the second surface 15b (see FIG. 3) that is on the opposite side from the functional layer of the optical laminate. As a result, the polyester film and the adhesion-promoting layer can be maintained in a stably close contact state.

An upper limit may be set on the thickness of the adhesion-promoting layer-coated polyester film. By setting an upper limit on the thickness of the adhesion-promoting layer-coated polyester film, the in-plane retardation Re can be reduced, so flexibility and bendability can be improved. From these viewpoints, the thickness of the adhesion-promoting layer-coated polyester film may be less than or equal to 75 μm, may be less than or equal to 60 μm, may be less than or equal to 55 μm, or may be less than or equal to 50 μm.

The thickness of the adhesion-promoting layer-coated polyester film may be greater than or equal to 10 μm and less than or equal to 75 μm, may be greater than or equal to 10 μm and less than or equal to 60 μm, may be greater than or equal to 10 μm and less than or equal to 55 μm, or may be greater than or equal to 10 μm and less than or equal to 50 μm. The thickness of the adhesion-promoting layer-coated polyester film may be greater than or equal to 21 μm and less than or equal to 75 μm, may be greater than or equal to 21 μm and less than or equal to 60 μm, may be greater than or equal to 21 μm and less than or equal to 55 μm, or may be greater than or equal to 21 μm and less than or equal to 50 μm. The thickness of the adhesion-promoting layer-coated polyester film may be greater than or equal to 25 μm and less than or equal to 75 μm, may be greater than or equal to 25 μm and less than or equal to 60 μm, may be greater than or equal to 25 μm and less than or equal to 55 μm, or may be greater than or equal to 25 μm and less than or equal to 50 μm. The thickness of the adhesion-promoting layer-coated polyester film may be greater than or equal to 30 μm and less than or equal to 75 μm, may be greater than or equal to 30 μm and less than or equal to 60 μm, may be greater than or equal to 30 μm and less than or equal to 55 μm, or may be greater than or equal to 30 μm and less than or equal to 50 μm.

The thickness of the adhesion-promoting layer-coated polyester film in which no functional layer is laminated is determined using the measured values at 20 measurement positions, measured with a thickness meter. The largest measured value, the second largest measured value, the smallest measured value, and the second smallest measured value are excluded from the measured values at 20 measurement positions, and the average value of the remaining measured values at 16 measurement positions is set for the thickness of the adhesion-promoting layer-coated polyester film. “Digimicro” manufactured by Nikon Corporation may be used as the thickness meter. “Digimicro” manufactured by Nikon Corporation may be used as a combination of a stand and a main unit, that is, “MS-5C” and “MH-15M”, and a counter “TC-101A” may be used.

The thickness of the adhesion-promoting layer-coated polyester film incorporated into the optical laminate is determined using a scanning transmission electron microscopy (STEM). The cross section of the adhesion-promoting layer-coated polyester film or the optical laminate including the adhesion-promoting layer-coated polyester film, to be evaluated, is observed using a scanning transmission electron microscope, and the thickness of the adhesion-promoting layer-coated polyester film is measured from the observation image obtained using the scanning transmission electron microscope. To enable cross-sectional observation, a measurement sample in which the cross section of the adhesion-promoting layer-coated polyester film is exposed is prepared. A microtome is used to prepare the sample. A microtome manufactured by Leica Microsystems is an example of the microtome. The “product number: $4800” manufactured by Hitachi High-Tech Corporation is an example of the scanning electron microscope.

The thickness of the target to be measured is measured at seven measurement positions through cross-sectional observation using a scanning electron microscope. The largest measured value and the smallest measured value are excluded from the measured values at seven measurement positions, and the average value of the remaining measured values at five measurement positions is set for the thickness of the adhesion-promoting layer-coated polyester film. The seven measurement positions are seven positions along a straight line at a pitch of 10 μm.

Before measurement of the thickness is started, the measurement sample is placed in the measurement environment for 16 hours. The measurement environment is a temperature of 23 °C±2 °C and a relative humidity of 50%+5%.

To obtain the values of the above-described in-plane retardation Re and thickness direction retardation Rth, the thickness of the adhesion-promoting layer-coated polyester film is needed. The thickness of the adhesion-promoting layer-coated polyester film, determined by the above method, is used to determine the values of the in-plane retardation Re and thickness direction retardation Rth.

### <Transmission Haze of Adhesion-Promoting Layer-Coated Polyester Film>

The transmission haze of the adhesion-promoting layer-coated polyester film may be lower than or equal to 3.0%, may be lower than or equal to 2.0%, or may be lower than or equal to 1.0%. The transmission haze of the adhesion-promoting layer-coated polyester film does not have a lower limit. The transmission haze of the adhesion-promoting layer-coated polyester film may be 0%, or may be higher than 0%.

A D65 light source is used for measurement of transmission haze. Before the transmission haze is measured, the D65 light source is turned on for 15 minutes to stabilize the output of the D65 light source. The angle of incidence on the measurement sample for measuring transmission haze is set to 0°. The measurement environment for measuring transmission haze is a temperature of 23 °C±2 °C and a relative humidity of 50%±5%. A measurement sample is placed in the measurement environment for 16 hours before measurement is started. The other measurement conditions for measuring transmission haze conform with JIS K 7136:2000. A haze meter (product number: HM-150) manufactured by Murakami Color Research Laboratory may be used for measurement of transmission haze.

The incident surface for measuring the transmission haze of the adhesion-promoting layer-coated polyester film is set to the main surface closer to the polyester film than to the adhesion-promoting layer. In the example shown in FIG. 1 as an example, the incident surface for measuring transmission haze is set to the second surface 15b.

The transmission haze is the arithmetic mean value of five measured values. The five measured values are measured values measured at five measurement positions of a target to be measured. The five measurement positions are located at a distance longer than or equal to 10 mm from each other.

### <Total Light Transmittance of Adhesion-Promoting Layer-Coated Polyester Film>

The total light transmittance of the adhesion-promoting layer-coated polyester film may be higher than or equal to 80%, may be higher than or equal to 85%, or may be higher than or equal to 90%. The total light transmittance of the adhesion-promoting layer-coated polyester film does not have an upper limit. The total light transmittance of the adhesion-promoting layer-coated polyester film may be lower than or equal to 100%, or may be lower than 100%.

A D65 light source is used for measurement of total light transmittance. Before the total light transmittance of the adhesion-promoting layer-coated polyester film is measured, the D65 light source is turned on for 15 minutes to stabilize the output of the D65 light source. The angle of incidence on the measurement sample for measuring the total light transmittance is set to 0°. The measurement environment for measuring total light transmittance is a temperature of 23 °C.±2 °C and a relative humidity of 50%±5%. A sample is placed in the measurement environment for 16 hours before measurement is started. The other measurement conditions for measuring total light transmittance conform with JIS K 7361-1:1997. A haze meter (product number: HM-150) manufactured by Murakami Color Research Laboratory may be used for measurement of total light transmittance.

The incident surface for measuring the total light transmittance of the adhesion-promoting layer-coated polyester film is set to the main surface closer to the polyester film than to the adhesion-promoting layer. In the example shown in FIG. 1 as an example, the incident surface for measuring total light transmittance is set to the second surface 15b.

The total light transmittance is the arithmetic mean value of five measured values. The five measured values are measured values measured at five measurement positions of a target to be evaluated. The five measurement positions are located at a distance longer than or equal to 10 mm from each other.

### <Ultraviolet Transmittance>

The spectral transmittance of the adhesion-promoting layer-coated polyester film at a wavelength of 380 nm may be lower than or equal to 20%, or may be lower than or equal to 10%. The spectral transmittance of the adhesion-promoting layer-coated polyester film at a wavelength of 380 nm does not have a lower limit. The spectral transmittance of the adhesion-promoting layer-coated polyester film at a wavelength of 380 nm may be 0%, or may be higher than 0%.

The spectral transmittance of the adhesion-promoting layer-coated polyester film at a wavelength of 380 nm is a value measured in accordance with JIS Z 8722:2009. The angle of incidence on the measurement sample for measuring spectral transmittance is set to 0°. The geometric conditions for irradiation and light reception in measuring spectral transmittance are geometric conditions f including a normal transmission direction (0°:di), specified in JIS Z 8722:2009. Before the spectral transmittance is measured, the light source is turned on for 15 minutes to stabilize the output of the light source. The measurement environment for measuring spectral transmittance is a temperature of 23 °C±2±C and a relative humidity of 50%+5%. A measurement sample is placed in the measurement environment for 16 hours before measurement is started. The other measurement conditions for measuring spectral transmittance conform with JIS Z 8722:2009.

The incident surface for measuring the spectral transmittance of the adhesion-promoting layer-coated polyester film is set to the main surface closer to the polyester film than to the adhesion-promoting layer. In the example shown in FIG. 1 as an example, the incident surface for measuring spectral transmittance is set to the second surface 15b.

The spectral transmittance is the arithmetic mean value of five measured values. The five measured values are measured values measured at five measurement positions of a target to be evaluated. The five measurement positions are located at a distance longer than or equal to 10 mm from each other.

### <<Layer Structure of Adhesion-Promoting Layer-Coated Polyester Film>>

The adhesion-promoting layer-coated polyester film includes a polyester film and an adhesion-promoting layer.

The adhesion-promoting layer-coated polyester film may include a single polyester film. The polyester film included in the adhesion-promoting layer-coated polyester film may be a single layer. In other words, the polyester film included in the adhesion-promoting layer-coated polyester film may include a single layer.

The adhesion-promoting layer-coated polyester film may include a plurality of polyester films. The polyester film included in the adhesion-promoting layer-coated polyester film may be a multilayer. The polyester film included in the adhesion-promoting layer-coated polyester film may include a plurality of layers.

The adhesion-promoting layer-coated polyester film may include a single adhesion-promoting layer. The adhesion-promoting layer-coated polyester film may include a plurality of adhesion-promoting layers. The plurality of adhesion-promoting layers may be laminated on one side of the adhesion-promoting layer-coated polyester film. The plurality of adhesion-promoting layers may be laminated on one side and the other side of the adhesion-promoting layer-coated polyester film.

As described above, regardless of the layer structure of the adhesion-promoting layer-coated polyester film, the plane orientation degree ΔP is measured for the adhesion-promoting layer-coated polyester film. Regardless of the layer structure of the adhesion-promoting layer-coated polyester film, measurement of δq/δa using an atomic force microscope is conducted on the surface of the adhesion-promoting layer in the adhesion-promoting layer-coated polyester film, rather than on the adhesion-promoting layer peeled from the adhesion-promoting layer-coated polyester film. For example, when a plurality of adhesion-promoting layers is laminated on one side of a polyester film, measurement of δq/δa using an atomic force microscope is conducted on the surface of the adhesion-promoting layer that constitutes one-side surface of the adhesion-promoting layer-coated polyester film.

### <Polyester Film>

The polyester film is a layer that supports an adhesion-promoting layer. The polyester film is a layer that supports a functional layer on the adhesion-promoting layer. The polyester film has physical properties and configurations that can impart the above-described physical properties and configurations to the adhesion-promoting layer-coated polyester film. The polyester film may have the feature (A), the feature (A1), the feature (A2), the feature (A3), and the feature (A4), similarly to the adhesion-promoting layer-coated polyester film. The polyester film may have the same specifications as the above-described adhesion-promoting layer-coated polyester film in terms of transmission haze, total light transmittance, and ultraviolet transmittance.

### <Thickness of Polyester Film>

The thickness of the polyester film may be greater than or equal to 10 μm, may be greater than or equal to 21 μm, may be greater than or equal to 25 μm, or may be greater than or equal to 30 μm, to ensure good mechanical strength. By setting the thickness of the polyester film to 10 μm or greater, stress can be made less likely to be transmitted to the interface between the polyester film and the adhesion-promoting layer when another member contacts the surface of the side closer to the adhesion-promoting layer-coated polyester film than to the functional layer of the optical laminate to generate the stress.

To reduce the in-plane retardation of the adhesion-promoting layer-coated polyester film and to improve the bending resistance of the adhesion-promoting layer-coated polyester film, an upper limit may be set on the thickness of the polyester film. The thickness of the polyester film may be less than or equal to 75 μm, may be less than or equal to 60 μm, may be less than or equal to 55 μm, or may be less than or equal to 50 μm.

The thickness of the polyester film may be greater than or equal to 10 μm and less than or equal to 75 μm, may be greater than or equal to 10 μm and less than or equal to 60 μm, may be greater than or equal to 10 μm and less than or equal to 55 μm, or may be greater than or equal to 10 μm and less than or equal to 50 μm. The thickness of the polyester film may be greater than or equal to 21 μm and less than or equal to 75 μm, may be greater than or equal to 21 μm and less than or equal to 60 μm, may be greater than or equal to 21 μm and less than or equal to 55 μm, or may be greater than or equal to 21 μm and less than or equal to 50 μm. The thickness of the polyester film may be greater than or equal to 25 μm and less than or equal to 75 μm, may be greater than or equal to 25 μm and less than or equal to 60 μm, may be greater than or equal to 25 μm and less than or equal to 55 μm, or may be greater than or equal to 25 μm and less than or equal to 50 μm. The thickness of the polyester film may be greater than or equal to 30 μm and less than or equal to 75 μm, may be greater than or equal to 30 μm and less than or equal to 60 μm, may be greater than or equal to 30 μm and less than or equal to 55 μm, or may be greater than or equal to 30 μm and less than or equal to 50 μm.

### <Raw Materials for Polyester Film>

Examples of the polyester constituting the polyester film include a homopolymer obtained by polycondensation of a dicarboxylic acid and a diol, a copolymer obtained by polycondensation of one or more dicarboxylic acids and two or more diols, a copolymer obtained by polycondensation of two or more dicarboxylic acids and one or more diols; and a blend resin obtained by mixing one or more homopolymers and one or more copolymers.

The polyester film may contain additives. Examples of the additives include ultraviolet absorbers, slip particles such as inorganic particles, heat-resistant polymer particles, alkali metal compounds, alkaline earth metal compounds, phosphorus compounds, antistatic agents, light stabilizers, flame retardants, thermal stabilizers, antioxidants, anti-gelling agents, and surfactants.

The raw materials for the polyester film may be newly synthesized materials, naturally derived materials, recycled materials, or a mixture of two or more of these materials.

Examples of the dicarboxylic acids include terephthalic acid, isophthalic acid, ortho-phthalic acid, 2,5-naphthalenedicarboxylic acid, 2,6-naphthalenedicarboxylic acid, 1,4-naphthalenedicarboxylic acid, 1,5-naphthalenedilcarboxylic acid, diphenylcarboxylic acid, diphenoxyethanedicarboxylic acid, diphenylsulfone carboxylic acid, anthracenedicarboxylic acid, 1,3-cyclopentanedicarboxylic acid, 1,3-cyclohexanedicarboxylic acid, 1,4-cyclohexanedicarboxylic acid, hexahydroterephthalic acid, hexahydroisophthalic acid, malonic acid, dimethylmalonic acid, succinic acid, 3,3-diethylsuccinic acid, glutaric acid, 2,2-dimethylglutaric acid, adipic acid, 2-methyladipic acid, trimethyladipic acid, pimelic acid, azelaic acid, dimer acid, sebacic acid, suberic acid, and dodecanedicarboxylic acid.

Examples of the diols include ethylene glycol, propylene glycol, hexamethylene glycol, neopentyl glycol, 1,2-cyclohexanedimethanol, 1,4-cyclohexanedimethanol, decamethylene glycol, 1,3-propanediol, 1,4-butanediol, 1,5-pentanediol, 1,6-hexanediol, 2,2-bis(4-hydroxyphenyl) propane, and bis(4-hydroxyphenyl) sulfone.

The polyester film may also include polyethylene terephthalate. With polyethylene terephthalate, high mechanical strength can be imparted to the polyester film.

Examples of polymerization methods for polyethylene terephthalate include a direct polymerization method in which terephthalic acid and ethylene glycol, and optionally other dicarboxylic acid components and diol components, are directly reacted; and a transesterification method in which a dimethyl ester of terephthalic acid and ethylene glycol undergo transesterification. In the transesterification method, a dimethyl ester of terephthalic acid may optionally include methyl esters of other dicarboxylic acids. In the transesterification method, ethylene glycol may optionally contain other diol components.

The intrinsic viscosity of polyethylene terephthalate may be higher than or equal to 0.45 and lower than or equal to 0.70. By setting the intrinsic viscosity to 0.45 or higher, the tear resistance of the adhesion-promoting layer-coated polyester film can be improved. By setting the intrinsic viscosity to 0.70 or lower, the increase in filtration pressure can be suppressed to improve the accuracy of filtration.

### <Layer Structure of Polyester Film>

The polyester film may have a single-layer structure. The polyester film may have a multilayer structure. In other words, the polyester film may include a single layer. The polyester film may include a plurality of layers.

A single-layer structure is excellent in that its stretching is easily controllable. For this reason, the adhesion-promoting layer having a single-layer structure can increase the plane orientation degree

ΔP of the adhesion-promoting layer-coated polyester film by bringing the stretching ratios in the machine direction and transverse direction closer to each other without lowering the stretching ratios in both directions. Therefore, a single-layer structure of which the stretching is easily controllable is preferable in that the single-layer structure can increase the plane orientation degree ΔP of the adhesion-promoting layer-coated polyester film.

On the other hand, the polyester film having a multilayer structure is preferable in that it is easy to impart advantageous effects by changing the composition of each layer. For example, a laminated polyester film including at least three layers formed by co-extrusion may be used as the adhesion-promoting layer-coated polyester film. In this example, by using polyester with a low oligomer content for the surface layers on both sides of the laminated polyester film, the amount of oligomer deposited after heat treatment can be suppressed.

### (Stretching of Polyester Film)

To achieve the plane orientation degree ΔP specified in the above-described feature (A), the stretching ratios in the machine direction and transverse direction may be brought closer to each other without lowering the stretching ratios. The polyester film may also be a stretched film or a biaxially-stretched film.

### —Sequential Biaxial Stretching—

In sequential biaxial stretching, a casting film is stretched in the machine direction, and then the polyester film is stretched in the transverse direction.

Stretching in the machine direction is usually performed by the difference in peripheral speed between a pair of stretching rolls. Stretching in the machine direction may be performed in a single stage, or may also be performed in multiple stages using a plurality of pairs of stretching rolls. To suppress excessive variation in optical properties such as plane orientation degree ΔP and in-plane retardation, a plurality of nip rolls may be placed in proximity to the stretching rolls. The stretching ratio in the machine direction may be higher than or equal to twice and lower than or equal to 15 times, and may be higher than or equal to twice and lower than or equal to seven times, may be higher than or equal to three times and lower than or equal to five times, or may be higher than or equal to three times and lower than or equal to four times, to suppress excessive variation in optical properties such as plane orientation degree ΔP and in-plane retardation.

To suppress excessive variations in physical properties such as plane orientation degree ΔP and in-plane retardation, the stretching temperature may be set so as to be higher than or equal to the glass transition temperature of the resin and lower than or equal to the glass transition temperature+100 °C. The stretching temperature for stretching a PET film may be higher than or equal to 70 °C and lower than or equal to 120 °C, may be higher than or equal to 80 °C and lower than or equal to 110 °C, or may be higher than or equal to 95 °C and lower than or equal to 110 °C.

Regarding the stretching temperature, when the stretching zone at low temperatures is shortened, for example, by quickly heating the polyester film, the average value of the in-plane retardation tends to decrease. On the other hand, when the stretching zone at low temperatures is extended, for example, by slowly heating the polyester film, the orientation increases, and the average value of the in-plane retardation tends to increase.

A layer having functions such as slip properties and antistatic properties may be formed on the polyester film stretched in the machine direction, by inline coating or offline coating. In this specification, the layers formed by inline coating or offline coating are not counted as layers constituting the polyester film.

Stretching in the transverse direction is usually performed using a tenter method. In this stretching method, the polyester film is stretched in the transverse direction by transporting the polyester film while holding both ends of the polyester film with clips. The stretching ratio in the transverse direction may be higher than or equal to twice and lower than or equal to 15 times. From the viewpoint of suppressing excessive variations in physical properties such as the plane orientation degree ΔP and in-plane retardation of the adhesion-promoting layer-coated polyester film, the stretching ratio in the transverse direction may be higher than or equal to twice and lower than or equal to seven times, may be higher than or equal to three times and lower than or equal to six times, or may be higher than or equal to four times and lower than or equal to five times. The stretching ratio in the transverse direction may be made higher than the stretching ratio in the machine direction.

While the Nz coefficient is set to higher than 2.0, one of the stretching ratio in the machine direction and the stretching ratio in the transverse direction may be made higher than the other. The stretching ratio in the machine direction and the stretching ratio in the transverse direction may be set to a similar level, and the Nz coefficient may be set to higher than 2.0. According to these examples, the molecular orientation of the polyester film becomes uniform. The polyester film with uniform molecular orientation excels in coating suitability. With the polyester film with uniform molecular orientation, a significant change, in the plane, of the viscoelasticity of the adhesion-promoting layer formed on the polyester film can be suppressed. From the viewpoint of adjusting the average value of δq/δa within the numeric range specified in the feature (B), the stretching ratio in the machine direction and the stretching ratio in the transverse direction may be adjusted such that the Nz coefficient is higher than 2.0.

The stretching temperature may be higher than or equal to the glass transition temperature of the resin and lower than or equal to the glass transition temperature+120 °C. The stretching temperature may increase from upstream to downstream of the polyester film. The difference between the upstream stretching temperature and the downstream stretching temperature may be larger than or equal to 20 °C, may be larger than or equal to 30 °C, may be larger than or equal to 35 °C, or may be larger than or equal to 40 °C. When a PET film is stretched, the first-stage stretching temperature may be higher than or equal to 80 °C and lower than or equal to 120 °C, may be higher than or equal to 90 °C and lower than or equal to 110 °C, or may be higher than or equal to 95 °C and lower than or equal to 105 °C.

To impart planarity and dimensional stability to the adhesion-promoting layer-coated polyester film, a heat treatment at a temperature higher than or equal to the stretching temperature and lower than the melting point may be applied within a tenter to the sequentially biaxially stretched polyester film. In the case of a PET film, heat setting may be performed at a temperature in the range of 150 °C or higher and 255 °C or lower, or in the range of 200 °C or higher and 250 °C or lower. To suppress excessive variations in physical properties such as plane orientation degree ΔP and in-plane retardation, additional stretching of 1% or higher and 10% or lower may be performed in the first half of the heat treatment.

After heat treatment and further slow cooling to room temperature, the polyester film may be taken up. If necessary, during heat treatment or slow cooling, relaxation treatment may be performed on the polyester film. To suppress excessive variations in physical properties such as plane orientation degree ΔP and in-plane retardation, the relaxation ratio during heat treatment may be higher than or equal to 0.5% and lower than or equal to 5%, may be higher than or equal to 0.5% and lower than or equal to 3%, may be higher than or equal to 0.8% and lower than or equal to 2.5%, or may be higher than or equal to 1% and lower than or equal to 2%. To suppress excessive variations in physical properties such as plane orientation degree ΔP and in-plane retardation, the relaxation ratio during slow cooling may be higher than or equal to 0.5% and lower than or equal to 3%, may be higher than or equal to 0.5% and lower than or equal to 2%, may be higher than or equal to 0.5% and lower than or equal to 1.5%, or may be higher than or equal to 0.5% and lower than or equal to 1.0%. To improve planarity, the temperature during slow cooling may be higher than or equal to 80 °C and lower than or equal to 150 °C, may be higher than or equal to 90 °C and lower than or equal to 130 °C, may be higher than or equal to 100 °C and lower than or equal to 130 °C, or may be higher than or equal to 100 °C and lower than or equal to 120 °C.

The transport speed for producing the stretched polyester film may be higher than or equal to 100 m/s and lower than or equal to 300 m/s.

### —Simultaneous Biaxial Stretching—

In simultaneous biaxial stretching, a casting film is introduced into a simultaneous biaxial tenter, and the polyester film is simultaneously and/or stepwise stretched in the machine direction and the transverse direction by transporting the polyester film while gripping both ends of the polyester film with clips. Examples of simultaneous biaxial stretching machines include a pantograph-type machine, a screw-type machine, a drive motor-type machine, and a linear motor-type machine. With the drive motor-type machine or the linear motor-type machine, the stretching ratio can be freely changed, and relaxation treatment can be performed at any location.

The stretching ratio in simultaneous biaxial stretching, as an area ratio, may be higher than or equal to six times or lower than or equal to 50 times. From the viewpoint of suppressing excessive variations in physical properties such as plane orientation degree ΔP and in-plane retardation, the area ratio may be higher than or equal to eight times and lower than or equal to 30 times, may be higher than or equal to nine times and lower than or equal to 25 times, may be higher than or equal to nine times and lower than or equal to 20 times, or may be higher than or equal to 10 times and lower than or equal to 15 times. In simultaneous biaxial stretching, the above-described area ratio may be achieved while the stretching ratio in the machine direction and the stretching ratio in the transverse direction are set to twice or higher and 15 times or less. In the case of simultaneous biaxial stretching, to suppress the orientation difference in the plane, the stretching ratios in the machine direction and transverse direction may be set to be substantially the same, and the stretching speeds in the machine direction and transverse direction may also be set to be substantially the same.

To suppress excessive variations in physical properties such as plane orientation degree ΔP and in-plane retardation, the stretching temperature for simultaneous biaxial stretching may be set so as to be higher than or equal to the glass transition temperature of the resin and lower than or equal to the glass transition temperature+120 °C. The stretching temperature for simultaneous biaxial stretching of a PET film may be higher than or equal to 80 °C and lower than or equal to 160 °C, may be higher than or equal to 90 °C and lower than or equal to 150 °C, or may be higher than or equal to 100 °C and lower than or equal to 140 °C.

To impart planarity and dimensional stability to the adhesion-promoting layer-coated polyester film, a heat treatment at a temperature higher than or equal to the stretching temperature and lower than the melting point may be continuously applied in a heat setting chamber within a tenter to the simultaneously biaxially stretched polyester film. The heat treatment conditions for simultaneously biaxially stretched polyester may be similar to the above-described heat treatment conditions for sequentially biaxially stretched polyester.

### <<Adhesion-Promoting Layer>>

The adhesion-promoting layer-coated polyester film according to the present embodiment includes an adhesion-promoting layer. In the adhesion-promoting layer-coated polyester film according to the present embodiment, the average value of δq/δa on the surface of the adhesion-promoting layer is higher than or equal to 1.125 and lower than or equal to 1.80, so the adhesion between the polyester film and the adhesion-promoting layer can be enhanced. When the average value of δq/δa on the surface of the adhesion-promoting layer is higher than or equal to 1.125 and lower than or equal to 1.80, it is possible to stabilize the mechanical strength by making it difficult to generate a starting point of defects of the adhesion-promoting layer-coated polyester film. By ensuring such stability and further satisfying the feature (A), the puncture resistance and bending resistance can be stably improved. The adhesion-promoting layer has physical properties and configurations that can impart the above-described physical properties and configurations to the adhesion-promoting layer-coated polyester film.

The resin constituting the adhesion-promoting layer is not limited. Examples of the resin constituting the adhesion-promoting layer include thermoplastic resins such as polyester resins, polyurethane resins, and acrylic resins, and thermosetting resins, and thermoplastic resins are illustrated as the resin constituting the adhesion-promoting layer. Examples of thermoplastic resins include polyester resins, polyurethane resins, and resins containing both a polyester component and a polyurethane component. With polyester resins, polyurethane resins, and resins containing both a polyester component and a polyurethane component, it is possible to reduce the refractive index difference between the polyester film and the adhesion-promoting layer, and the refractive index difference between the adhesion-promoting layer and the uneven layer.

The polyurethane component can contribute to improvement in adhesion. The polyurethane component is less likely to increase the strength of the coating film. From this viewpoint, the resin constituting the adhesion-promoting layer may contain both the polyester component and the polyurethane component. However, when the amount of polyurethane component is excessively larger than the amount of polyester component, the adhesion-promoting layer is prone to phase separation. For this reason, the average value of δq/δa and the coefficient of variation of δq/δa tend to be high. Because the polyurethane component is soft, when the amount of polyurethane component is excessively large, the average value of δq/δa and the coefficient of variation of δq/δa are likely to increase due to differences in crosslinking density in the plane. From this viewpoint, in a resin containing both a polyester component and a polyurethane component, the mass ratio between the polyester component and the polyurethane component may range from 95:5 to 60:40, or may range from 90:10 to 60:40.

The number average molecular weight of the resin constituting the adhesion-promoting layer may be greater than or equal to 10000, or may be greater than or equal to 15000. The number average molecular weight of the resin constituting the adhesion-promoting layer may be less than or equal to 100000, or may be less than or equal to 60000. By setting the number average molecular weight of the resin constituting the adhesion-promoting layer within the range, the cohesive failure of the adhesion-promoting layer can be suppressed.

The glass transition temperature of the resin constituting the adhesion-promoting layer may be higher than or equal to 30 °C, may be higher than or equal to 50 °C, or may be higher than or equal to 70 °C. The glass transition temperature of the resin constituting the adhesion-promoting layer may be lower than or equal to 120 °C, may be lower than or equal to 110 °C, or may be lower than or equal to 90 °C.

By setting the glass transition temperature of the resin constituting the adhesion-promoting layer to 30 °C or higher, generation of internal stress resulting from the flow of the adhesion-promoting layer due to heat during the process can be suppressed. As a result, it is easy to adjust the average value of δq/δa and the coefficient of variation of δq/δa within the above-described numeric range. Examples of heat during the process include heat from a step of drying a functional layer coating liquid and heat from warming for bonding an optical laminate to a polarizer.

By setting the glass transition temperature of the resin constituting the adhesion-promoting layer to 120 °C or lower, generation of stress due to the difference in thermal behavior between the adhesion-promoting layer and the polyester film caused by heat during the process can be suppressed. Occurrence of cracks and the like in the adhesion-promoting layer due to the stress can be suppressed. Accordingly, by setting the glass transition temperature of the resin constituting the adhesion-promoting layer to 120 °C or lower, it is easy to adjust the average value of δq/δa and the coefficient of variation of δq/δa within the above-described numeric range.

The adhesion-promoting layer may contain additives. Examples of the additives include additives such as refractive index modifiers, dyes, pigments, leveling agents, ultraviolet absorbers, antioxidants, and light stabilizers; and crosslinking agents for adjusting hardness or viscosity. Examples of the crosslinking agents include non-yellowing-type XDI-based, IPDI-based, and HDI-based isocyanates, and ionizing radiation-curable polyfunctional monomers.

The adhesion-promoting layer may be formed by an inline coating method in which coating is performed during formation of the polyester film. The adhesion-promoting layer may be formed by an offline coating method in which coating is performed after formation of the polyester film.

In the inline coating method and the offline coating method, an adhesion-promoting layer coating liquid containing components that constitute the adhesion-promoting layer may be used. For example, an adhesion-promoting layer may be formed by applying an adhesion-promoting layer coating liquid onto a polyester film using a general-purpose coating method and then drying the adhesion-promoting layer coating liquid. At this time, the drying time may be shorter than or equal to 120 seconds or may be shorter than or equal to 90 seconds. By setting the drying time to 120 seconds or shorter, it is possible to suppress phase separation of the components that constitute the adhesion-promoting layer. As a result, it is easy to adjust the average value of δq/δa and the coefficient of variation of δq/δa within the above-described numeric range. When the drying time is excessively shortened, the coating film surface may become rough, and the optical properties can deteriorate. From these viewpoints, the drying time may be longer than or equal to 15 seconds or may be longer than or equal to 20 seconds. The drying time can be adjusted by the drying temperature and the drying air velocity.

The direction of drying air may be opposite to the transport direction of the polyester film. By setting the direction of the drying air and the transport direction of the polyester film opposite to each other, the drying time of the adhesion-promoting layer coating liquid can be dramatically shortened without excessively increasing the drying temperature.

The drying temperature of the adhesion-promoting layer coating liquid may be higher than or equal to 50 °C and lower than or equal to 200 °C, or may be higher than or equal to 60 °C and lower than or equal to 150 °C. By setting the drying temperature to 50 °C or higher, the drying time of the adhesion-promoting layer coating liquid can be shortened, with the result that phase separation of the components constituting the adhesion-promoting layer can be suppressed. By setting the drying temperature to 200 °C or lower, thermal decomposition of the components constituting the adhesion-promoting layer can be suppressed.

The adhesion-promoting layer coating liquid may contain a solvent. With the solvent, the components constituting the adhesion-promoting layer can be dissolved in the adhesion-promoting layer coating liquid. With the solvent, the components constituting the adhesion-promoting layer can be dispersed in the adhesion-promoting layer coating liquid. With the solvent, the viscosity of the adhesion-promoting layer coating liquid can be adjusted.

Examples of the solvents include ketones such as acetone, methyl ethyl ketone, methyl isobutyl ketone, and cyclohexanone; ethers such as dioxane and tetrahydrofuran; aliphatic hydrocarbons such as hexane; cycloaliphatic hydrocarbons such as cyclohexane; aromatic hydrocarbons such as toluene and xylene; halogenated hydrocarbons such as dichloromethane and dichloroethane; esters such as methyl acetate, ethyl acetate, and butyl acetate; alcohols such as isopropanol, butanol, and cyclohexanol; cellosolves such as methyl cellosolve and ethyl cellosolve; glycol ethers such as propylene glycol monomethyl ether acetate; cellosolve acetates; sulfoxides such as dimethyl sulfoxide; and amides such as dimethylformamide and dimethylacetamide. The adhesion-promoting layer coating liquid may contain one of the solvents or may contain two or more of the illustrated solvents.

When the drying time of the solvent in the adhesion-promoting layer coating liquid is excessively long, the components constituting the adhesion-promoting layer are prone to phase separation. Therefore, the solvent in the adhesion-promoting layer coating liquid may include a solvent with a high evaporation rate.

On the other hand, when the drying time of the solvent in the adhesion-promoting layer coating liquid is excessively short, the surface of the coating film tends to become rough. For this reason, the adhesion-promoting layer coating liquid may contain a solvent with an extremely high evaporation rate and a solvent with a moderately high evaporation rate.

In this specification, a solvent with an extremely high evaporation rate means a solvent that has an evaporation rate of 280 or higher when the evaporation rate of butyl acetate is set to 100. In this specification, a solvent with a moderately high evaporation rate means a solvent that has an evaporation rate higher than or equal to 150 and lower than 280 when the evaporation rate of butyl acetate is set to 100.

The evaporation rate of the solvent with an extremely high evaporation rate may be higher than or equal to 320 and lower than or equal to 430, or may be higher than or equal to 340 and lower than or equal to 400. Examples of the solvent with an extremely high evaporation rate include methyl ethyl ketone with an evaporation rate of 370 and normal heptane with an evaporation rate of 362.

The evaporation rate of the solvent with a moderately high evaporation rate may be higher than or equal to 170 and lower than or equal to 250, or may be higher than or equal to 180 and lower than or equal to 220. Examples of the solvent with a moderately high evaporation rate include toluene with an evaporation rate of 200 and propyl acetate with an evaporation rate of 214.

In the solvent of the adhesion-promoting layer coating liquid, the mass ratio between the solvent with an extremely high evaporation rate and the solvent with a moderately high evaporation rate may range from 50:50 to 90:10, or may range from 70:30 to 85:15.

From the viewpoint of suppressing phase separation of the adhesion-promoting layer coating liquid, the solid content concentration of the adhesion-promoting layer coating liquid may be higher than or equal to 2 mass %, or may be higher than or equal to 4 mass %. The solid content concentration of the adhesion-promoting layer coating liquid may be lower than or equal to 30 mass %, or may be lower than or equal to 10 mass %. The solid content concentration of the adhesion-promoting layer coating liquid may be adjusted by the content of the solvent.

The composition of the adhesion-promoting layer coating liquid is not limited. The adhesion-promoting layer coating liquid may be solvent-based. Compared to a water-based adhesion-promoting layer coating liquid, with the solvent-based adhesion-promoting layer coating liquid, the adhesion between the adhesion-promoting layer and the polyester film can be improved after a damp heat resistance test.

A water-based adhesion-promoting layer coating liquid is believed to be able to reduce environmental load. However, for a water-based adhesion-promoting layer coating liquid, it is necessary to set the drying temperature to a high temperature and to maintain the high temperature for an extended period of time during drying. Therefore, it is not believed that a water-based adhesion-promoting layer coating liquid can contribute to reducing environmental load. A water-based adhesion-promoting layer coating liquid can reduce processing efficiency during mass production according to a solvent-based adhesion-promoting layer coating liquid.

In an adhesion-promoting layer-coated polyester film applied to a display device, a PVA resin can be added to the adhesion-promoting layer for the purpose of improving adhesion with a polarizer. A PVA resin can be used as the main material for the polarizer. Poval manufactured by Kuraray Co., Ltd. is known as a raw material for polarizers. An example of the Poval manufactured by Kuraray Co., Ltd. is “PVA28-98” (formerly known as “PVA-117”). The degree of polymerization of PVA28-98 (formerly known as PVA-117) is about 1700, and the molecular weight ranges from 30000 to 100000.

The PVA resin added to the adhesion-promoting layer makes the adhesion-promoting layer coating liquid water-based. As a result, by adding a PVA resin to the adhesion-promoting layer, the adhesion between the adhesion-promoting layer and the polyester film can be decreased.

The dry coating amount of the adhesion-promoting layer may be greater than or equal to 0.05 g/m² and less than or equal to 0.75 g/m². The thickness of the adhesion-promoting layer is not limited. The thickness of the adhesion-promoting layer may be greater than or equal to 10 nm and less than or equal to 600 nm, may be greater than or equal to 20 nm and less than or equal to 300 nm, or may be greater than or equal to 50 nm and less than or equal to 200 nm. From the viewpoint of suppressing interference fringes, the thickness of the adhesion-promoting layer may be reduced.

The thickness of each of the layers included in the adhesion-promoting layer-coated polyester film and the optical laminate, for example, the thickness of each of the adhesion-promoting layer, the functional layer, and the like, is measured similarly to the above-described measurement method for measuring the thickness of the adhesion-promoting layer-coated polyester film incorporated in the optical laminate. In other words, the cross section of the adhesion-promoting layer-coated polyester film and the optical laminate is observed using a scanning transmission electron microscope, and the thickness of the layer to be measured is measured from the observation image with the scanning transmission electron microscope. To enable cross-sectional observation, a measurement sample of which the cross section of the layer to be measured is exposed is prepared. A microtome is used to prepare the sample. A microtome manufactured by Leica Microsystems is an example of the microtome. The “product number: S4800” manufactured by Hitachi High-Tech Corporation is an example of the scanning electron microscope.

The thickness of the layer to be measured is measured at 20 measurement positions through cross-sectional observation using a scanning electron microscope. The largest measured value, the second largest measured value, the smallest measured value, and the second smallest measured value are excluded from the measured values at 20 measurement positions, and the average value of the remaining measured values at 16 measurement positions is set for the thickness of the layer to be measured. The 20 measurement positions are set at 20 positions along a straight line at a pitch of 10 μm.

### <<Size, Shape, and Other Properties of Adhesion-Promoting Layer-Coated Polyester Film>>

The adhesion-promoting layer-coated polyester film may be cut into sheets of a predetermined size. The size of the sheets is not limited; however, the maximum diameter is greater than or equal to about two inches and less than or equal to about 500 inches. The term “maximum diameter” refers to the maximum length between any two points of the adhesion-promoting layer-coated polyester film. For example, when the adhesion-promoting layer-coated polyester film has a rectangular shape, the diagonal of the rectangle is the maximum diameter. When the adhesion-promoting layer-coated polyester film has a circular shape, the diameter of the circle is the maximum diameter.

The shape of the adhesion-promoting layer-coated polyester film is not limited. Examples of the shape of the adhesion-promoting layer-coated polyester film include polygons such as triangles, quadrilaterals, and pentagons, a circle, and random irregular shapes. When the adhesion-promoting layer-coated polyester film has a rectangular shape, the aspect ratio is not limited as long as there is no problem in use as a display screen. The aspect ratio of the adhesion-promoting layer-coated polyester film may be width:height=1:1, 4:3, 16:10, 16:9, 2:1, 5:4, 11:8, or the like.

### <<<Film Article>>>

With the manufacturing method for an adhesion-promoting layer-coated polyester film using a wet process with an adhesion-promoting layer coating liquid, a long film article 15L that includes a large number of adhesion-promoting layer-coated polyester films 15 can be manufactured, as shown in FIG. 2. The width and length of the film article 15L are not limited. The width of the film article 15L may be greater than or equal to 500 mm and less than or equal to 8000 mm, and the length may be greater than or equal to 100 m and less than or equal to 10000 m.

By cutting the long film article 15L to a predetermined size, individual adhesion-promoting layer-coated polyester films 15 may be obtained. The film article 15L may be cut into sheets to match the size of an image display device or the like. According to this example, the film articles 15 with various dimensions can be obtained from the long film article 15L in accordance with needs. Therefore, the adhesion-promoting layer-coated polyester films 15 with various dimensions can be timely provided. During cutting, the ends of the film article 15L having unstable physical properties may be excluded. As shown in FIG. 2, the film article 15L may be handled in the form of a film roll 15R taken up with a take-up core 16 about a take-up axis RA. With the film roll 15R, the handleability of the film article 15L can be improved.

### <<<Optical Laminate>>>

The optical laminate according to the present embodiment has one or more functional layers on the adhesion-promoting layer of the above-described adhesion-promoting layer-coated polyester film according to the present embodiment.

FIG. 3 is a longitudinal sectional view showing an example of an optical laminate. As shown in FIG. 3, the optical laminate 10 has a first surface 10a and a second surface 10b. The first surface 10a and the second surface 10b may also be a pair of main surfaces of the optical laminate 10. The optical laminate 10 includes a functional layer 30 and the adhesion-promoting layer-coated polyester film 15 in order from the first surface 10a toward the second surface 10b. The optical laminate 10 includes the functional layer 30, the adhesion-promoting layer 25, and the polyester film 20 in order from the first surface 10a toward the second surface 10b.

In the example shown in FIG. 3, the first surface 10a is constituted by the functional layer 30. In the example shown in FIG. 3, the second surface 10b is constituted by the polyester film 20. In the example shown in FIG. 3, the second surface 10b of the optical laminate 10 is also the second surface 15b of the adhesion-promoting layer-coated polyester film 15.

The optical laminate 10 is not limited to the illustrated example. The optical laminate 10 may include two or more functional layers.

### <<Functional Layer>>

The functional layer may have a single-layer structure or may have a multilayer structure. Examples of layers constituting the functional layers include a hard coat layer, an anti-glare layer, an anti-reflective layer, a wavelength-selective absorption layer, an antifouling layer, and an antistatic layer. The functional layer may have a plurality of functions within a single layer.

Among the functional layers, examples of the anti-reflective layer include a single-layer structure and a multilayer structure. Examples of the single-layer anti-reflective layer include a single-layer low refractive index layer. The multilayer anti-reflective layer may include two layers of high refractive index layer and low refractive index layer, or may include three or more layers.

The following F1 to F7 are examples of the functional layers formed on the adhesion-promoting layer.
F1: A single-layer structure of a hard coat layer
F2: A single-layer structure of an anti-glare layer
F3: A multilayer structure having a hard coat layer and an anti-reflective layer in this order
F4: A multilayer structure having an anti-glare layer and an anti-reflective layer in this order
F5: A multilayer structure having a hard coat layer and an antifouling layer in this order
F6: A multilayer structure having an anti-glare layer and an antifouling layer in this order
F7: A multilayer structure having a hard coat layer, an anti-reflective layer, and an antifouling layer in that order

Among one or more functional layers, the functional layer that is in contact with the adhesion-promoting layer may contain a cured material of an ionizing radiation curable resin composition. The functional layer that is in contact with the adhesion-promoting layer may be a hard coat layer or may be an anti-glare layer. When the functional layer that is in contact with the adhesion-promoting layer contains a cured material of an ionizing radiation curable resin composition, the adhesion of the optical laminate can decrease. However, since the average value of δq/δa on the surface of the adhesion-promoting layer falls within the above-described numeric range, the optical laminate according to the present embodiment can improve the adhesion of the optical laminate even when the functional layer that is in contact with the adhesion-promoting layer contains a cured material of an ionizing radiation curable resin composition. When the functional layer that is in contact with the adhesion-promoting layer contain a cured material of an ionizing radiation curable resin composition, the mechanical strength of the optical laminate can be increased.

Among one or more functional layers, the functional layer that is in contact with the adhesion-promoting layer may contain a cured material of an ionizing radiation curable resin composition and have a thickness of 0.5 μm or greater. When the functional layer that is in contact with the adhesion-promoting layer has such a configuration, the mechanical strength of the optical laminate can be increased. The thickness of the functional layer that is in contact with the adhesion-promoting layer may be greater than or equal to 1.0 μm, or may be greater than or equal to 2.0 μm. The upper limit of the thickness of the functional layer that is in contact with the adhesion-promoting layer may be less than or equal to 20.0 μm, may be less than or equal to 10.0 μm, may be less than or equal to 7.0 μm, or may be less than or equal to 5.0 μm. The functional layer that is in contact with the adhesion-promoting layer may be a hard coat layer or an anti-glare layer.

The thickness of the functional layer that is in contact with the adhesion-promoting layer may be greater than or equal to 0.5 μm and less than or equal to 20.0 μm, may be greater than or equal to 0.5 μm and less than or equal to 10.0 μm, may be greater than or equal to 0.5 μm and less than or equal to 7.0 μm, or may be greater than or equal to 0.5 μm and less than or equal to 5.0 μm. The thickness of the functional layer that is in contact with the adhesion-promoting layer may be greater than or equal to 1.0 μm and less than or equal to 20.0 μm, may be greater than or equal to 1.0 μm and less than or equal to 10.0 μm, may be greater than or equal to 1.0 μm and less than or equal to 7.0 μm, or may be greater than or equal to 1.0 μm and less than or equal to 5.0 μm. The thickness of the functional layer that is in contact with the adhesion-promoting layer may be greater than or equal to 2.0 μm and less than or equal to 20.0 μm, may be greater than or equal to 2.0 μm and less than or equal to 10.0 μm, may be greater than or equal to 2.0 μm and less than or equal to 7.0 μm, or may be greater than or equal to 2.0 μm and less than or equal to 5.0 μm.

The contact angle at which the surface of the optical laminate, closer to the functional layer than to the adhesion-promoting layer-coated polyester film, that is, the first surface 10a in the example shown in FIG. 3 as an example, contacts pure water may be larger than or equal to 80 degrees, may be larger than or equal to 85 degrees, may be larger than or equal to 90 degrees, may be larger than or equal to 95 degrees, or may be larger than or equal to 100 degrees. By setting the contact angle to 80 degrees or larger, it is easy for another component to slip when the component contacts the surface of the optical laminate. As a result, it is possible to make it difficult for stress to occur in the optical laminate. Therefore, the adhesion of the optical laminate can be improved. In other words, by laminating a functional layer with an adjusted contact angle onto the adhesion-promoting layer of the adhesion-promoting layer-coated polyester film according to the present embodiment, in which the average value of δq/δa falls within a predetermined range, the adhesion of the optical laminate can be further improved.

When the functional layer located at the outermost surface contains a lot of antifouling agent, the contact angle of pure water can be increased. However, when the contact angle of pure water is excessively large, the physical properties such as the surface hardness of the optical laminate can decrease. From this viewpoint, the contact angle may be smaller than or equal to 130 degrees or may be smaller than or equal to 120 degrees. In this specification, the contact angle means a static contact angle measured using a θ/2 method. General-purpose pure water can be used as pure water. The specific resistivity of pure water is set so as to be higher than or equal to 0.1 MΩ·cm and lower than or equal to 15 MΩ·cm.

The contact angle on the surface of the optical laminate, constituted by the functional layer, may be larger than or equal to 80 degrees and smaller than or equal to 130 degrees, may be larger than or equal to 80 degrees and smaller than or equal to 120 degrees, may be larger than or equal to 85 degrees and smaller than or equal to 130 degrees, may be larger than or equal to 85 degrees and smaller than or equal to 120 degrees, may be larger than or equal to 90 degrees and smaller than or equal to 130 degrees, may be larger than or equal to 90 degrees and smaller than or equal to 120 degrees, may be larger than or equal to 95 degrees and smaller than or equal to 130 degrees, may be larger than or equal to 95 degrees and smaller than or equal to 120 degrees, may be larger than or equal to 100 degrees and smaller than or equal to 130 degrees, or may be larger than or equal to 100 degrees and smaller than or equal to 120 degrees.

The functional layer may contain, for example, a binder resin and may optionally contain additives. The thickness of the functional layer may be selected as needed according to the functions to be imparted.

The functional layer may contain a cured material of a curable resin composition as the binder resin. Examples of the cured material of the curable resin composition include a cured material of a thermosetting resin composition and a cured material of an ionizing radiation curable resin composition. The functional layer can effectively improve mechanical strength by containing a cured material of an ionizing radiation curable resin composition.

The proportion of the cured material of the curable resin composition to the total binder resin of the functional layer may be higher than or equal to 60 mass %, may be higher than or equal to 80 mass %, may be higher than or equal to 90 mass %, or may be 100 mass %.

The thermosetting resin composition contains at least a thermosetting resin. It is a thermosetting resin composition that cures when heated. Examples of the thermosetting resin include acrylic resins, urethane resins, phenolic resins, urea melamine resins, epoxy resins, unsaturated polyester resins, and silicone resins. A curing agent may be optionally added to the thermosetting resin composition.

The ionizing radiation curable resin composition contains a compound having an ionizing radiation curable functional group. In this specification, a “compound having an ionizing radiation curable functional group” is also referred to as an “ionizing radiation curable compound”. Among electromagnetic waves or charged particle beams, ionizing radiation has energy quanta that can polymerize or crosslink molecules. The ionizing radiation may be ultraviolet radiation or may be an electron beam. The ionizing radiation may be electromagnetic waves such as X-rays and gamma rays, or charged particle beams such as alpha rays and ion beams.

Examples of the ionizing radiation curable functional group include an ethylenically unsaturated group, such as a (meth)acryloyl group, a vinyl group, and an allyl group, an epoxy group, and an oxetanyl group. The ionizing radiation curable compound may also be a compound that has an ethylenically unsaturated group, a compound that has two or more ethylenically unsaturated groups, or a polyfunctional (meth)acrylate compound that has two or more ethylenically unsaturated groups.

Both a monomer and an oligomer may be used for a polyfunctional (meth)acrylate compound. The functional layer may contain a cured material of a polyfunctional (meth)acrylate oligomer as the binder resin. In particular, the functional layer that is in contact with the adhesion-promoting layer may contain a cured material of a polyfunctional (meth)acrylate oligomer as the binder resin. The cured material of the polyfunctional (meth)acrylate oligomer can improve the surface hardness of the optical laminate while suppressing excessive curing shrinkage of the functional layer. For this reason, it is possible to increase the mechanical strength of the optical laminate while improving the adhesion of the optical laminate.

To further improve the balance between the mechanical strength and adhesion of the optical laminate, the functional layer may contain an oligomer and a monomer as polyfunctional (meth)acrylate compounds. The functional layer may contain a cured material of a polyfunctional (meth)acrylate oligomer and a cured material of a polyfunctional (meth)acrylate monomer as the binder resins. In particular, the functional layer that is in contact with the adhesion-promoting layer may contain a cured material of a polyfunctional (meth)acrylate oligomer and a cured material of a polyfunctional (meth)acrylate monomer as the binder resins.

When an oligomer and a monomer are used as polyfunctional (meth)acrylate compounds, the mass ratio between the oligomer and the monomer may range from 5:95 to 95:5, may range from 50:50 to 85:15, or may range from 60:40 to 80:20.

Examples of a polyfunctional (meth)acrylate oligomer include (meth)acrylate polymers, such as urethane (meth)acrylate, epoxy (meth)acrylate, polyester (meth)acrylate, and polyether (meth)acrylate. The urethane (meth)acrylate can be obtained, for example, by reacting a polyhydric alcohol and an organic diisocyanate with a hydroxy(meth)acrylate.

The weight average molecular weight of the polyfunctional (meth)acrylate oligomer may be higher than or equal to 500, or may be higher than or equal to 1000. The weight average molecular weight of the polyfunctional (meth)acrylate oligomer may be lower than or equal to 5000, or may be lower than or equal to 3000. By setting the weight average molecular weight of the oligomer to 500 or higher, excessive curing shrinkage of the functional layer can be suppressed. By setting the weight average molecular weight of the oligomer to 5000 or lower, a decrease in mechanical strength can be suppressed. The weight average molecular weight of the polyfunctional (meth)acrylate oligomer may be higher than or equal to 500 and lower than or equal to 5000, may be higher than or equal to 500 and lower than or equal to 3000, may be higher than or equal to 1000 and lower than or equal to 5000, or may be higher than or equal to 1000 and lower than or equal to 3000.

In this specification, the weight average molecular weight and the number average molecular weight mean polystyrene-equivalent values measured by gel permeation chromatography.

Examples of bifunctional (meth)acrylate monomers among polyfunctional (meth)acrylate compounds include ethylene glycol di(meth)acrylate, bisphenol A tetraethoxy diacrylate, bisphenol A tetrapropoxy diacrylate, and 1,6-hexanediol diacrylate. Examples of (meth)acrylate monomers with three or more functional groups include trimethylolpropane tri(meth)acrylate, pentaerythritol tri(meth)acrylate, pentaerythritol tetra(meth)acrylate, dipentaerythritol hexa(meth)acrylate, dipentaerythritol tetra(meth)acrylate, and modified isocyanuric acid tri(meth)acrylate. The (meth)acrylate monomer may have a molecular backbone that is partially modified. For example, a (meth)acrylate monomer modified by ethylene oxide, propylene oxide, caprolactone, isocyanuric acid, alkyl, cyclic alkyl, aromatic, bisphenol, or the like may be used.

For the purpose of adjusting the viscosity of the functional layer coating liquid, a monofunctional (meth)acrylate may be added as an ionizing radiation curable compound. Examples of a monofunctional (meth)acrylate include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, lauryl (meth)acrylate, stearyl (meth)acrylate, and isobornyl (meth)acrylate. One of the above ionizing radiation curable compounds may be used alone. Two or more of the above ionizing radiation curable compounds may be used in combination. A polymer for adjusting the viscosity may be added to the functional layer coating liquid in addition to the ionizing radiation curable compound. The weight average molecular weight of the polymer may be higher than 5000 and lower than or equal to 200000.

When the ionizing radiation curable compound is an ultraviolet curable compound, the ionizing radiation curable resin composition may contain additives such as a photopolymerization initiator and a photopolymerization accelerator. Examples of the photopolymerization initiator include one or more selected from among acetophenone, benzophenone, α-hydroxyalkylphenone, Michler's ketone, benzoin, benzyl dimethyl ketal, benzoyl benzoate, α-acyl oxime ester, anthraquinone, halogenated ketone, and thioxanthone compounds. As a photopolymerization initiator, yellowing-resistant α-hydroxyalkylphenone may be used.

The photopolymerization accelerator can reduce polymerization inhibition caused by air during curing and increase the rate of curing. Examples of the photopolymerization accelerator include one or more selected from among p-dimethylaminobenzoic acid isoamyl ester and p-dimethylaminobenzoic acid ethyl ester.

The functional layer may optionally contain additives. Additives may be selected as needed from general-purpose materials according to the functions to be imparted to the functional layer. For example, the functional layer imparted with anti-glare properties may contain organic particles and/or inorganic particles as additives. The functional layer imparted with anti-reflective properties may contain refractive index modifiers such as a high refractive index material and a low refractive index material as additives. The functional layer imparted with antifouling properties may contain an antifouling agent as an additive. Furthermore, examples of additives also include antistatic agents, leveling agents, ultraviolet absorbers, dyes, pigments, conductive particles, coagulants, defoamers, antioxidants, and light stabilizers.

### <<Physical Properties of Optical Laminate>>

The total light transmittance of the optical laminate may be higher than or equal to 50%, may be higher than or equal to 80%, or may be higher than or equal to 90%. The incident surface for measuring the total light transmittance of the optical laminate is the main surface closer to the adhesion-promoting layer-coated polyester film than to the functional layer. In the example shown in FIG. 3 as an example, the incident surface for measuring total light transmittance is set to the second surface 10b. The measurement method for total light transmittance is as described above.

The transmission haze of the optical laminate may be higher than or equal to 0.3%, may be higher than or equal to 0.4%, or may be higher than or equal to 0.5%. The transmission haze of the optical laminate may be lower than or equal to 10%, may be lower than or equal to 7%, or may be lower than or equal to 5%. The incident surface for measuring the transmission haze of the optical laminate is the main surface closer to the adhesion-promoting layer-coated polyester film than to the functional layer, and is the second surface 10b in the example shown in FIG. 3 as an example. The measurement method for transmission haze is as described above.

### <<Size, Shape, and Other Properties of Optical Laminate>>

The optical laminates may also be sheets cut into a predetermined size. The size of the sheet is not limited. The maximum diameter of the optical laminate as a sheet may be greater than or equal to about two inches and less than or equal to about 500 inches. The “maximum diameter” refers to the maximum length between any two points of the optical laminate. For example, when the optical laminate has a rectangular shape, the diagonal of the rectangle is the maximum diameter. When the optical laminate has a circular shape, the diameter of the circle is the maximum diameter.

The shape of the optical laminate is not limited. Examples of the shape of the optical laminate include polygons such as triangles, quadrilaterals, and pentagons, a circle, and random irregular shapes. When the shape of the optical laminate has a rectangular shape, the aspect ratio of the optical laminate is not limited as long as there is no problem in use as a display screen. The width:height of the optical laminate may be 1:1, 4:3, 16:10, 16:9, 2:1, 5:4, 11:8, or the like.

### <<<Laminated Article>>>

With the manufacturing method for an optical laminate using a wet process with a functional layer coating liquid, a long laminated article 10L that includes a large number of the optical laminates 10 can be manufactured, as shown in FIG. 4. The width and length of the laminated article 10L are not limited. The width of the laminated article 10L may be greater than or equal to 500 mm and less than or equal to 8000 mm, and the length may be greater than or equal to 100 m and less than or equal to 10000 m.

By cutting the long laminated article 10L to a predetermined size, individual optical laminates 10 may be obtained. The laminated article 10L may be cut into sheets to match the size of an image display device or the like. According to this example, the optical laminates 10 with various dimensions can be obtained from the long laminated article 10L in accordance with needs. Therefore, the optical laminates 10 with various dimensions can be timely provided. During cutting, the laminated article 10L that has unstable physical properties may be excluded.

As shown in FIG. 4, the laminated article 10L may be handled in the form of a laminate roll 10R taken up with a take-up core 11 about a take-up axis RA. With the laminate roll 10R, the handleability of the laminated article 10L can be improved.

### <<<Polarizing Plate>>>

The polarizing plate according to the present embodiment includes the above-described optical elements.

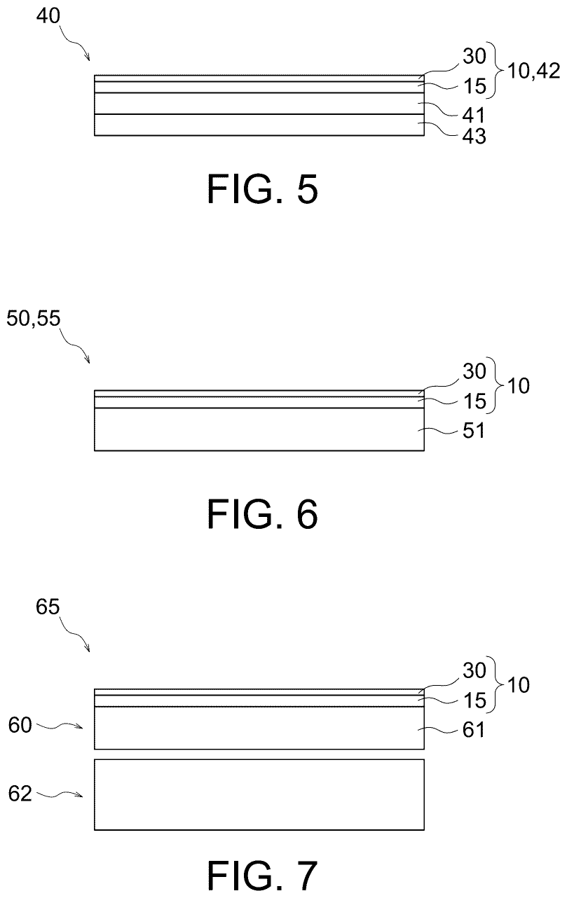

FIG. 5 shows an example of the polarizing plate. The polarizing plate 40 shown in FIG. 5 includes a polarizer 41, a first transparent protective plate 42 disposed on one side of the polarizer 41, and a second transparent protective plate 43 disposed on the other side of the polarizer 41. At least one of the first transparent protective plate 42 and the second transparent protective plate 43 may be the above-described optical laminate 10 according to the present embodiment. The adhesion-promoting layer-coated polyester film 15 is located between the functional layer 30 and the polarizer 41.

In the illustrated example, only the first transparent protective plate 42 is the adhesion-promoting layer-coated polyester film 15. Both the first transparent protective plate 42 and the second transparent protective plate 43 may be constituted by the adhesion-promoting layer-coated polyester film 15.

### <Polarizer>

The polarizer may also be a sheet polarizer. The sheet polarizer may also be a stretched resin film dyed with iodine or the like. Examples of the resin film include a polyvinyl alcohol film, a polyvinyl formal film, a polyvinyl acetal film, and an ethylene-vinyl acetate copolymer saponified film. Examples of the polarizer include a wire-grid polarizer made up of a large number of metal wires arranged in parallel, a coated polarizer coated with a lyotropic liquid crystal or a dichroic guest-host material, and a multilayer thin-film polarizer. The polarizer may also be a reflective polarizer. The reflective polarizer can reflect polarization components that are not transmitted.

### <Transparent Protective Plate>

A first transparent protective plate may be disposed on one side of the polarizer. A second transparent protective plate may be disposed on the other side of the polarizer. At least one of the first transparent protective plate and the second transparent protective plate is the above-described optical laminate according to the present embodiment.

Examples of each of the first transparent protective plate and the second transparent protective plate include a plastic film and glass. Examples of the plastic film include a polyester film, a polycarbonate film, a cycloolefin polymer film, an acrylic film, and one or more of these films stretched. With the stretched films, the mechanical strength can be improved. Examples of the glass include alkali glass, nitride glass, soda-lime glass, borosilicate glass, and lead glass. The glass serving as a transparent protective plate for protecting the polarizer may also serve as another member of the image display device. For example, a glass substrate of a liquid crystal display element can also serve as a transparent protective plate for protecting the polarizer.

The polarizer and the transparent protective plate may be bonded together with an adhesive. The adhesive may be a general-purpose adhesive. The adhesive may be a PVA-based adhesive.

In the polarizing plate according to the present embodiment, both the first transparent protective plate and the second transparent protective plate may be the above-described optical laminate according to the present embodiment. In the polarizing plate according to the present embodiment, one of the first transparent protective plate and the second transparent protective plate may be the above-described optical laminate according to the present embodiment. When the polarizing plate according to the present embodiment is used as a polarizing plate disposed on the light exit surface side of the display element, the transparent protective plate on the light exit surface side of the polarizer may be the above-described optical laminate according to the present embodiment. On the other hand, when the polarizing plate according to the present embodiment is used as a polarizing plate disposed on the opposite side from the light exit surface of the display element, the transparent protective plate on the opposite side from the light exit surface of the polarizer may be the above-described optical laminate according to the present embodiment.

### <<<Panel, Surface Plate>>>

The panel according to the present embodiment includes a support plate and an adhesion-promoting layer-coated polyester film optical laminate. The surface plate according to the present embodiment includes the support plate and the optical laminate on the support plate.

FIG. 6 shows an example of a panel 50 and a surface plate 55. As shown in FIG. 6, the panel 50 includes a support plate 51 and the adhesion-promoting layer-coated polyester film according to the present embodiment. The adhesion-promoting layer-coated polyester film 15 may be joined to the support plate 51. A joining layer, such as a bonding layer and an adhesion layer, may be disposed between the adhesion-promoting layer-coated polyester film 15 and the support plate 51. In the panel, the polyester film may be joined to the support plate. In the panel, the adhesion-promoting layer may be joined to the support plate.

The panel 50 may include the functional layer 30. In this example, the panel 50 may include the optical laminate 15 including the adhesion-promoting layer-coated polyester film 20, and the support plate 51. The panel 50 may be exposed as a member constituting the surface. The panel 50 does not need to be a member that is used in an exposed state.

As shown in FIG. 6, the surface plate 55 includes the support plate 51 and the optical laminate 10 according to the present embodiment. The surface plate 55 is used in an exposed state as a member that constitutes the surface. The optical laminate 10 may be bonded to the support plate 51. The adhesion-promoting layer-coated polyester film 15 is located between the functional layer 30 and the support plate 51.

The panel and the surface plate according to the present embodiment may be used, for example, as a surface plate for an image display device. The panel and the surface plate according to the present embodiment may be used as a member for protecting an article such as a clock and a painting. The panel or surface plate according to the present embodiment may be used as a member for a show window and a showcase. The support plate may also be a resin plate. The support plate may also be a glass plate.

The surface plate for an image display device may be disposed such that the side closer to the optical laminate than to the support plate is located on the side closest to the observer. In other words, the surface on the surface plate, closer to the optical laminate than to the support plate, may face the opposite side from a display element. The surface plate for protecting an article may be disposed such that the surface closer to the optical laminate than to the support plate faces the opposite side from the article.

A lower limit may be set on the thickness of the support. By setting a lower limit on the thickness of the support plate, mechanical strength can be imparted to the panel and the surface plate. From this viewpoint, the thickness of the support plate may be greater than or equal to 10 μm. An upper limit may be set on the thickness of the support plate. By setting an upper limit on the thickness of the support plate, an increase in size and weight of the panel and surface plate can be suppressed. The thickness of the panel and the surface plate may be less than or equal to 5000 μm. In response to recent demands for thinner image display devices, the thickness of the panel and the surface plate may be less than or equal to 1000 μm, may be less than or equal to 500 μm, or may be less than or equal to 100 μm. The thickness of the support plate may be greater than or equal to 10 μm and less than or equal to 5000 μm, may be greater than or equal to 10 μm and less than or equal to 1000 μm, may be greater than or equal to 10 μm and less than or equal to 500 μm, or may be greater than or equal to 10 μm and less than or equal to 100 μm.

### <<<Image Display Panel>>>

The image display panel according to the present embodiment includes a display element and an optical laminate. FIG. 7 shows an example of the image display panel. In the image display panel 60 shown in FIG. 7, the optical laminate 10 according to the present embodiment is disposed on the display element 61. The adhesion-promoting layer-coated polyester film 15 may be located between the display element 61 and the functional layer 30.

In the image display panel, the surface of the optical laminate, close to the functional layer than to the adhesion-promoting layer-coated polyester film, may be disposed so as to face the opposite side from the display element. The optical laminate may constitute the outermost surface of the image display panel. The functional layer of the optical laminate may constitute the outermost surface of the image display panel.

Examples of the display element include a liquid crystal display element, an EL display element such as an organic EL display element and an inorganic EL display element, and a plasma display element. Examples of the display element include an LED display element such as a mini-LED display element and a micro-LED display element. Examples of the display element include a laser holographic display element. These display elements may have a touch panel function in the display element.

Examples of the liquid crystal display mode of the liquid crystal display element include an IPS mode, a VA mode, a multi-domain mode, an OCB mode, an STN mode, a TSTN mode, and a ferroelectric liquid crystal mode. The display element, which is a liquid crystal display element, may be illuminated by a backlight from behind. The liquid crystal display element may be located between the optical laminate and the backlight. Examples of the backlight include a backlight using a quantum dot and a backlight using a white light-emitting diode.

The image display panel may be a foldable image display panel or may be a rollable image display panel. The image display panel may be an image display panel with a touch panel.

The size of the image display panel is not limited. The maximum diameter of the image display panel may be greater than or equal to about two inches and less than or equal to about 500 inches. The maximum diameter means the maximum length between any two points within the plane of the image display panel.

### <<<Image Display Device>>>

The image display device according to the present embodiment includes the above-described image display panel according to the present embodiment.

FIG. 7 shows an example of the image display device. In an image display device 65 shown in FIG. 7, the optical laminate 10 is formed at the outermost surface. As shown in FIG. 7, when the display element 61 is a liquid crystal display element, the image display device 65 may include a backlight 62 that illuminates the image display panel 60 from behind. As shown in FIG. 7, the display element 61 may be located between the backlight 62 and the optical laminate 10.

The image display device of the present disclosure preferably further includes a drive control unit electrically connected to the image display panel and a housing that accommodates the image display panel and the drive control unit.

The image display device may include an effective display region. The effective display region is a region where images can be displayed. For example, when the image display device includes a housing that surrounds the display element, the region inside the housing may be configured as an effective display region. The size of the image display device is not limited; however, the maximum diameter of the effective display region is greater than or equal to about two inches and less than or equal to about 500 inches. The maximum diameter of the effective display region refers to the maximum length between any two points within the effective display region. For example, when the effective display region has a rectangular shape, the diagonal of the rectangle is the maximum diameter. When the effective display region has a circular shape, the diameter of the circle is the maximum diameter.

### EXAMPLES

Hereinafter, the present disclosure will be specifically described by using examples, comparative examples, and reference examples. The present disclosure is not limited to the examples.

### <<<Evaluation, Measurement>>>

The following measurements and evaluations were conducted on the adhesion-promoting layer-coated polyester films and the optical laminates, obtained in the examples, comparative examples, and reference examples. The results are shown in Table 1 and Table 2. Unless otherwise specified, the atmosphere for each measurement and evaluation was a temperature of 23 °C±2 °C and a relative humidity of 50%+5%. The samples for measurements and evaluations were used without defects, and were clean and flat. Unless otherwise specified, before each measurement and evaluation, a target sample was placed in the atmosphere for 16 hours.

### <<1-1. Plane Orientation Degree ΔP>

Samples measuring 7 mm×7 mm were cut out from the adhesion-promoting layer-coated polyester films according to the examples, comparative examples, and reference examples. Using the above-described method with a retardation measuring device “RETS-100” manufactured by Otsuka Electronics Co., Ltd., the plane orientation degree ΔP of each of the adhesion-promoting layer-coated polyester films was measured. The measurement results of the plane orientation degree ΔP are shown in the “ΔP” columns of Tables 1 and 2. Using the above-described measurement method with the retardation measuring device “RETS-100”, the in-plane retardation Re was measured. The measurement results of the in-plane retardation Re are shown in the “Re” columns of Tables 1 and 2.

The Nz coefficient was calculated from the values of the thickness direction retardation Rth and the in-plane retardation Re obtained by the above-described measurement method using the retardation measuring device “RETS-100”. It was confirmed whether the Nz coefficient calculated for each example was higher than 2.0 or lower than or equal to 2.0. The confirmation results are shown in the “2.0<Nz” columns of Tables 1 and 2. When the Nz coefficient was higher than 2.0, “Y” was entered in the “2.0<Nz” columns. When the Nz coefficient was lower than or equal to 2.0, “N” was entered in the “2.0<Nz” columns.

Using the above-described measurement method with the retardation measuring device “RETS-100”, “nx−ny” was measured. For the adhesion-promoting layer-coated polyester films of all the examples, “nx−ny” was smaller than or equal to 0.0300.

<<1-2. Average Value of δq/δa and Coefficient of Variation of δq/δa>>

Samples measuring 5 mm×5 mm were cut out from the adhesion-promoting layer-coated polyester films according to the examples, comparative examples, and reference examples. Using the above-described method, measurements regarding δq/δa were conducted to measure the average value of δq/δa and the coefficient of variation of the coefficient of variation δq/δa. The measurement results of the average value of δq/δa are shown in the “Average Value” columns under “δq/δa” in Tables 1 and 2. The measurement results of the coefficient of variation of δq/δa are shown in the “Coefficient of Variation” columns under “δq/δa” in Tables 1 and 2.

For the cut-out samples each having a size of 5 mm×5 mm, a 10 μm×10 μm region on the surface of the adhesion-promoting layer was measured using an atomic force microscope in a phase mode. The details of the measuring device and measurement conditions were as follows. Seven measurement evaluation regions each having a size of 2 μm×2 μm were selected from within a measurement region of 10 μm×10 μm. The above seven positions were selected from regions measured with an atomic force microscope, in which the maximum height of the amplitude was less than or equal to 90 nm and the arithmetic mean height of the amplitude was less than or equal to 10 nm. Sa and δq of the seven measurement evaluation regions and δq/δa were calculated. Based on the δa and δq of the five measurement evaluation regions obtained by excluding the maximum value and the minimum value from the seven δq/δa values, the average value of δq/δa and the coefficient of variation of δq/δa were calculated.

In the measuring device below, when a measurement evaluation region of 2 μm×2 μm is selected on the screen, the δa and δq of the selected measurement evaluation region are automatically displayed. However, due to the settings of the measuring device below, the item corresponding to da is displayed as “Ra”, and the item corresponding to δq is displayed as “Rq”, on the display screen of the measuring device.

### <Measuring Device>

“SPM-9600” manufactured by Shimadzu Corporation

### <Analysis Software>

SPM Manager

### <AFM Analysis Conditions>

Tilt Correction: Line fitting

### <Cantilever Used>

Product number “NCHR” manufactured by Nanoworld AG

(resonant frequency: 320 kHz; spring constant: 42 N/m)

### <Measurement Mode>

Phase (in the “phase mode” of the above measuring device, not only phase but also amplitude is measured)

### <Measurement Conditions>

### —Amplitude and Phase—

Sensitivity: ×2

Phase offset: 95.00 deg

### —XY Control—

Scan range: 10.0000 μm

Scan rate: 1.00 Hz

Number of pixels: 512×512

Offset X: 0.0000 μm

Offset Y: 0.0000 μm

Scan angle: 0.0000 deg

### —Z Control—

Operating point: 0.228 V

P gain: 0.001

I gain: 15000.000

Offset Z: 0.0630 μm

### <<1-3. Adhesion>>

An adhesion test was performed in accordance with the following procedure to evaluate the adhesion of each of the optical laminates of the examples, comparative examples, and Reference Example 1.

Using a cutter blade, eleven linear cuts extending in the longitudinal direction and eleven linear cuts extending in the transverse direction were formed on a surface (the first surface 10a in FIG. 3) constituted by the hard coat layer of each of the optical laminates of the examples, comparative examples, and Reference Example 1. Each of the optical laminates was divided into 100 grid-shaped regions by the 11 longitudinal cuts and the 11 transverse cuts. The spacing of the 11 longitudinal cuts in the transverse direction was set to 1 mm. The spacing of the 11 transverse cuts in the longitudinal direction was set to 1 mm. The cutter blade was a product number “BA-52P” manufactured by NT Incorporated.

Subsequently, a peeling test was performed by affixing an adhesive tape (“Cellotape (registered trademark) manufactured by Nichiban Co., Ltd.) to the surface constituted by the hard coat layer of the optical laminate divided into grid-shaped regions and then peeling off the adhesive tape. This peeling test was performed in accordance with the cross-cut method specified in JIS K 5600-5-6:1999. The adhesion of each of the optical laminates of the examples, comparative example, and Reference Example 1 was evaluated based on the evaluation criteria. The evaluation results of adhesion are shown in the “Adhesion” column of Table 1.

### <Evaluation Criteria>

AA: There were no delaminated regions, and there were also no regions with partial chipping.
A: There were no delaminated regions, and the quality was determined to be acceptable; however, there were some regions with partial chipping along the cut lines.
B: There were some delaminated regions.

### <<1-4. Puncture Resistance>>

A puncture test was performed in accordance with the following procedure to evaluate the puncture resistance of each of the optical laminates of the examples, comparative examples, and Reference Example 1.

Using the adhesion-promoting layer-coated polyester films of the examples, comparative examples, and Reference Example 1, samples for a puncture test were prepared as follows. Each of the puncture test samples included a PET film, optical clear adhesive (OCA) film, chemically strengthened glass, a heat seal layer, an adhesion-promoting layer-coated polyester film, and a hard coat layer, in this order. During preparation of the samples, care was taken to avoid abnormalities such as occurrence of wrinkles and contamination of foreign matter.

Initially, A4-size samples were cut out from the adhesion-promoting layer-coated polyester films according to the examples, comparative examples, and Reference Example 1. A hard coat layer coating liquid having the formulation described below was applied onto the adhesion-promoting layer-coated polyester film to form a coating film. The coating film was dried at 80 °C for 60 seconds and then cured by irradiation with ultraviolet radiation at 200 mJ/cm². As a result, the hard coat layer was formed on the adhesion-promoting layer. The thickness of the hard coat layer was 10 μm. After that, by cutting the sample into a size of 10 mm×30 mm, a first laminate including the adhesion-promoting layer-coated polyester film and the hard coat layer was obtained.

### <Hard Coat Layer Coating Liquid>

30 parts by mass of polyfunctional acrylate monomer “PET-30” (manufactured by Nippon Kayaku Co., Ltd.)

2 parts by mass of a photopolymerization initiator “Omnirad 184” (manufactured by IGM Resins B.V.)

30 parts by mass of toluene

33 parts by mass of methyl ethyl ketone

Subsequently, a coating film was formed by applying the following heat-sealable resin composition onto the surface constituted by the polyester film of the first laminate. The coating film was dried under the conditions of 70 °C for one minute to form a heat seal layer. As a result, a second laminate, including the heat seal layer, the adhesion-promoting layer-coated polyester film, and the hard coat layer, was obtained.

### <Composition of Heat-Sealable Resin Composition>

100 parts by mass of an amorphous polyester resin (Vylon 560, manufactured by Toyobo Co., Ltd.)

5 parts by mass of hexamethylene diisocyanate (Coronate 2203, manufactured by Japan Polyurethane Industry Co., Ltd.)

5 parts by mass of silane coupling agent (KBM-403, manufactured by Shin-Etsu Chemical Co., Ltd.)

0.2 parts by mass (in terms of solid content) of a fluorine-based leveling agent (F568, manufactured by DIC Corporation)

310 parts by mass of solvent (MEK)

310 parts by mass of solvent (toluene)

Subsequently, the heat seal layer of the second laminate was used to join the second laminate and the chemically strengthened glass by heat sealing. For heat sealing, a “Desktop Roll Laminator B35A3” manufactured by ACCO brands Japan K.K. was used. During heat sealing, the roll temperature was set so as to range from 140 °C to 149 °C. During heat sealing, the feed speed was set to 0.3 m/min. As a result, a third laminate, including the chemically strengthened glass, the heat seal layer, the adhesion-promoting layer-coated polyester film, and the hard coat layer, was obtained.

The chemically strengthened glass was glass of which the mechanical properties were enhanced by a chemical method and had a compressive stress layer on its surface. The thickness of the chemically strengthened glass was set to 70 μm. The adhesion-promoting layer-coated polyester film and the optical laminate are joined to the chemically strengthened glass with a thickness of about 70 μm when applied to a display device. For example, chemically strengthened glass with a thickness of about 70 μm is used in foldable display elements.

A PET film was bonded via an optical clear adhesive film to the surface, constituted by the chemically strengthened glass, of the third laminate. The thickness of the optical clear adhesive film was set to 50 μm. The optical clear adhesive film was “8146-2” manufactured by 3M Company. The thickness of the PET film was set to 100 μm. The PET film was “A4160” manufactured by Toyobo Co., Ltd. The PET film “A4160” includes a PET layer and an adhesion-promoting layer provided only on one side of the PET layer. The surface, constituted by the adhesion-promoting layer, of the PET film “A4160” was brought into contact with the optical clear adhesive film. As a result, a puncture test sample was obtained.

As a puncture test, a pen was dropped onto the puncture test sample from above in the vertical direction, the presence or absence of cracking in the chemically strengthened glass was checked.

During the puncture test, the puncture test sample was placed on a metal plate such that the surface constituted by the PET layer of the PET film “A4160” was brought into contact with the metal plate. The metal plate was installed on a horizontal table. It was confirmed that the puncture test sample was spread in the horizontal direction as much as possible. The metal plate was a SUS304 plate. A pen was dropped from each test height onto the central portion of the hard coat layer of the puncture test sample. The pen was dropped vertically onto the puncture test sample with the tip facing downward. The pen was a Blen 0.5 BAS88-BK (weight: 12 g; pen tip diameter: 0.5 mmd) manufactured by Zebra Co., Ltd.

The maximum test height (cm) at which no cracking occurred in the chemically strengthened glass of the puncture test sample was measured as the puncture strength. The test height is the length measured in the vertical direction from the outermost surface formed by the hard coat layer of the puncture test sample to the pen tip. As the maximum test height (cm) defined as the puncture strength increases, the puncture strength increases. In the puncture test, the drop height (test height) was increased in increments of 1 cm. A ruler was fixed to the metal plate. The ruler extended in the vertical direction. Using this ruler, the test height in each test was visually confirmed.

Cracks of the chemically strengthened glass were confirmed by visually observing the chemically strengthened glass from various angles in a bright room at 1000 lux. The pen was continuously used as long as no change in the pen tip was visually observed. When a change in the pen tip was confirmed through visual observation or when ink leakage occurred, the pen was replaced with a new pen.

Ten puncture test samples were prepared for the adhesion-promoting layer-coated polyester film of each example. Ten puncture test samples were tested for the adhesion-promoting layer-coated polyester film of each example. The puncture resistance of each of the adhesion-promoting layer-coated polyester films of the examples, comparative examples, and Reference Example 1 was evaluated based on the evaluation criteria below. The evaluation results for puncture resistance are shown in the “Puncture Resistance” column of Table 1.

### <Evaluation Criteria>

AAA: For the 10 puncture test samples, the maximum test height at which no cracking occurred was greater than or equal to 25 cm.
AA: For eight or more puncture test samples, the maximum test height at which no cracking occurred was greater than or equal to 25 cm. However, the evaluation did not fall under AAA.
A: For eight or more puncture test samples, the maximum test height at which no cracking occurred was greater than or equal to 20 cm. However, the evaluation did not fall under AAA or AA.
B: The evaluation did not fall under AAA, AA, or A.

### <<1-5. Bending Resistance>>

A bending test was performed in accordance with the following procedure to evaluate the bending resistance of each of the optical laminates of the examples, comparative examples, and Reference Example 1.

Samples having a rectangular shape were cut out from the optical laminates of the examples, comparative examples, and Reference Example 1. The short side of the sample was set to 30 mm. The long side of the sample was set to 100 mm. The short side of the sample was made parallel to the slow axis. The long side of the sample was made parallel to the fast axis. As described above, with the retardation measuring device “RETS-100” manufactured by Otsuka Electronics Co., Ltd. used to measure the plane orientation degree ΔP, the slow axis and the fast axis can be identified. By identifying the slow axis and the fast axis of the optical laminate of each example using the retardation measuring device “RETS-100”, the short side and long side of the sample were aligned with the slow axis and the fast axis, respectively.

Using a durability tester “DLDMLH-FS” manufactured by Yuasa System Equipment Co., Ltd., a continuous bending test with a bending angle of 180 degrees was performed 100000 times. The bending speed was set to 120 times per minute. More detailed procedures for the bending test were as described below.

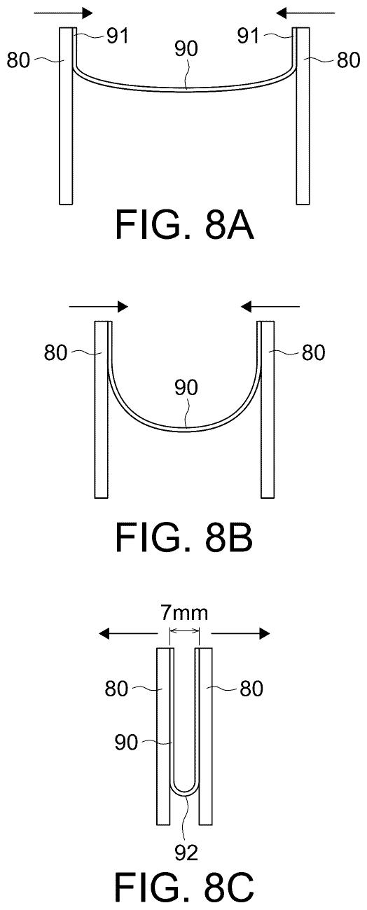

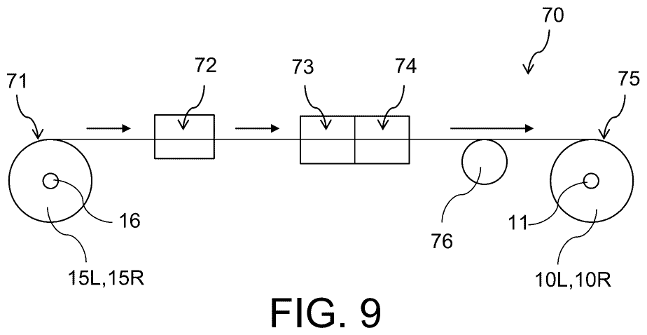

Initially, as shown in FIGS. 8A to 8C, both ends 91 of the sample 90 in the longitudinal direction were respectively fixed to a pair of fixing portions 80 of the durability tester. In the sample 90, a region extending 10 mm from the short side along the longitudinal direction was defined as an end 91 and was fixed to the fixing portion 80 of the durability tester.

As shown in FIGS. 8A to 8C, the pair of fixing portions 80 is relatively movable in the horizontal direction. The pair of fixing portions 80 can move toward each other and can move away from each other.

In the bending test, an operation of moving the pair of fixing portions 80 toward each other and an operation of moving the pair of fixing portions 80 away from each other were repeatedly performed. As shown in FIG. 8B, the fixing portions 80 were moved toward each other. As a result, the optical laminate sample 90 deforms to fold. As shown in FIG. 8C, the fixing portions 80 were moved toward each other until the spacing between both ends 91 of the sample 90 reached 7 mm. In the bent state shown in FIG. 8C, the sample was bent along an arc with a diameter of 7 mm. In the bent state, the bent tip 92 of the sample 90 was designed not to protrude between the pair of fixing portions 80. After that, the pair of fixing portions 80 was moved away from each other, and the sample 90 was spread as shown in FIG. 8A. The sample was bent and unfolded 100000 times. The sample 90 was bent 120 times per minute.

For the optical laminate of each example, 10 bending test samples were prepared. For the optical laminate of each example, 10 bending test samples were tested. The sample after the bending test was visually evaluated based on the criteria below. The evaluation results of bending resistance are shown in the “Bendability” column of Table 1.

### <Evaluation Criteria>

AAA: For the 10 bending test samples, no sample was broken, and no defects such as interlayer delamination of the sample occurred. For the 10 bending test samples, no abnormalities such as whitening were found upon careful observation.
AA: For the 10 bending test samples, no sample was broken, and no defects such as interlayer delamination of the sample occurred. For one or two bending test samples, the quality was determined to be acceptable; however, slight whitening was observed upon careful observation. However, the evaluation did not fall under AAA.
A: For the 10 bending test samples, no sample was broken, and no defects such as interlayer delamination of the sample occurred. For three or more bending test samples, the quality was determined to be acceptable; however, slight whitening was observed upon careful observation. However, the evaluation did not fall under AAA or AA.
B: For the 10 bending test samples, no sample was broken; however, defects such as interlayer delamination occurred in some of the bending test samples. However, the evaluation did not fall under AAA, AA, or A.
BB: For one or more bending test samples, breakage occurred before the number of bending test cycles reached 100000. However, the evaluation did not fall under AAA, AA, A, or B.

### <<1-6. Pencil Hardness>>

The pencil hardness of the polyester film was measured for each of the adhesion-promoting layer-coated polyester films of the examples, comparative examples, and Reference Example 1. The pencil hardness was measured on the surface (the second surface 15b in FIG. 1) constituted by the polyester film of the adhesion-promoting layer-coated polyester film.

An evaluation sample was cut out from the adhesion-promoting layer-coated polyester film of each example. The evaluation sample had a rectangular shape. The short side of the rectangular shape was set to 50 mm, and the long side was set to 100 mm. The rectangular sample was spread on the pencil hardness tester so that no wrinkles or warping occurred. The two short sides of the spread sample were fixed to the pencil hardness tester using mending tape along the entire length of each short side. The mending tape was “810-3-2018” manufactured by 3M Company. A pencil scratch hardness tester “SH-V1” manufactured by Toyo Seiki Seisaku-sho, Ltd., was used as the pencil hardness tester. The pencil scratch hardness tester SH-V1 was electrically driven.

The following conditions were adopted for measuring pencil hardness. Other conditions were in accordance the conditions specified in JIS K 5600-5-4:1999.

Moving speed of pencil: 1 mm/s

Moving distance of pencil: 7 mm

Temperature: 23 °C±2 °C.

Relative humidity: 50±5%

Angle of pencil: 45 degrees.

Pencil moving direction (pencil scratching direction): The direction in which the pencil was moved was made parallel to the slow axis direction of the adhesion-promoting layer-coated polyester film. The slow axis of each sample was identified using a method similar to that of the bending test.

For each example, the pencil hardness test was performed five times using a pencil of each hardness. When no scratches were formed on the film in three or more out of five tests with a pencil of a predetermined hardness, the predetermined hardness was regarded as passing. For the sample of each example, the pencil hardness test was performed until the test failed, and the highest hardness determined to be passing was defined as the pencil hardness for the example. The measurement results of pencil hardness are shown in the “Pencil” column of Table 1.

### <<1-7. Transmission Haze>>

Samples measuring 5 cm×10 cm were cut out from the optical sheets according to the examples, comparative examples, and Reference Example 1. The transmission haze of the adhesion-promoting layer-coated polyester film of each example was measured using the above-described method. A haze meter “HM-150” (Murakami Color Research Laboratory) was used for measurement of transmission haze. For the adhesion-promoting layer-coated polyester films of all the examples, the transmission haze was lower than or equal to 1.0%.

### <<1-8. Total Light Transmittance>>

Samples measuring 5 cm×10 cm were cut out from the optical sheets according to the examples, comparative examples, and Reference Example 1. The total light transmittance of the adhesion-promoting layer-coated polyester film of each example was measured using the above-described method. A haze meter “HM-150” manufactured by Murakami Color Research Laboratory was used for measurement of total light transmittance. For the adhesion-promoting layer-coated polyester films of all the examples, the total light transmittance was higher than or equal to 90%.

### <<1-9. Transportability>>

For each of Reference Examples A to E, a film article 15L (see FIG. 2) of the adhesion-promoting layer-coated polyester film having a width of 680 mm and a length of 500 m was produced. By taking up the film article 15L onto the take-up core 16, the film roll 15R was obtained. For each of Reference Examples A to E, 10 film rolls 15R were prepared.

Using a manufacturing apparatus 70 for the optical laminate 10, shown in FIG. 9, the laminated article 10L was produced from the film article 15L. The manufacturing apparatus 70 included a supply device 71, a coating device 72, a drying device 73, a curing device 74, and a collecting device 75. The manufacturing apparatus 70 produced the laminated article 10L from the film article 15L in a roll-to-roll manner. For each of Reference Examples A to E, 10 laminate rolls 10R were produced using 10 film rolls 15R.

The supply device 71 was holding the film roll 15R such that the film roll 15R was rotatable. The supply device 71 rotated the take-up core 16 to feed out the film article 15L from the film roll 15R. The coating device 72 applied the following hard coat layer coating liquid to the film article 15L. The drying device 73 dried the coating film of the hard coat layer coating liquid on the film article 15L. The curing device 74 cured the coating film of the hard coat layer coating liquid by irradiating the coating film with ultraviolet radiation. The collecting device 75 collected the laminated article 10L by taking up the laminated article 10L onto the take-up core 16.

### <Hard Coat Layer Coating Liquid>

30 parts by mass of polyfunctional acrylate monomer “PET-30” (manufactured by Nippon Kayaku Co., Ltd.)

2 parts by mass of a photopolymerization initiator “Omnirad 184” (manufactured by IGM Resins B.V.)

30 parts by mass of toluene

33 parts by mass of methyl ethyl ketone

The manufacturing apparatus 70 further included one suction roll. The suction roll holds the film article 15L by suction. Therefore, it is possible to transport the film article 15L without a nip roll. As shown in FIG. 9, the suction roll 76 was located between the curing device 74 and the collecting device 75.

The suction roll 76 has the following specifications.

Wrap angle: 180°

Suction width: 500 mm

Mesh size: 500 μm

Suction angle: 90°

Outside diameter: φ600 mm

The tension of the film article 15L supplied from the supply device 71 was set to 200 N. The tension of the laminated article 10L collected by the collecting device 75 was set to 250 N. The peripheral speed of a transport roller was measured using a rotary encoder attached to the suction roll. The transport speed was set to 20 m/min. Other manufacturing conditions, such as drying conditions in the drying device 73 and curing conditions in the curing device 74, were the same as the conditions adopted in the manufacturing method for the optical laminate according to Example 1.

When 10 laminate rolls 10R are produced for each example, changes in peripheral speed measured by the rotary encoder were checked. The transportability of each example was evaluated in accordance with the following evaluation criteria. The evaluation results of transportability are shown in the “Transportability” column of Table 2.

### <Evaluation Criteria>

AA: While 10 laminate rolls 10R were being manufactured, the peripheral speed was able to be maintained at 20±0.3 m/min over the length of 100% of the total length (500 m×10).
A: While 10 laminate rolls 10R were being manufactured, the peripheral speed was able to be maintained at 20±0.3 m/min over the length of 80% or higher and lower than 100% of the total length (500 m×10).
B: While 10 laminate rolls 10R were being manufactured, the peripheral speed was able to be maintained at 20±0.3 m/min over the length of 70% or higher and lower than 80% of the total length (500 m×10).
BB: While 10 laminate rolls 10R were being manufactured, the peripheral speed was maintained at 20±0.3 m/min over the length of lower than 70% of the total length (500 m×10).

In all Reference Examples A to E, changes in peripheral speed were not problematic for mass production.

For Reference Example A in which the in-plane retardation Re was 1512 nm, and Reference Example E in which the in-plane retardation Re was 2934 nm, the peripheral speed measured by the rotary encoder repeatedly decelerated and accelerated between 19.6 m/min and 20.5 m/min every five seconds. For Reference Example A and Reference Example E, abnormal sounds occurred during transport of the adhesion-promoting layer-coated polyester film. For Reference Example A and Reference Example E, when the transport became unstable, appearance defects such as scratches occurred on the film article 15L or the laminated article 10L.

For Reference Examples B to D, no abnormal sounds occurred, and the peripheral speed was stable. No appearance defects such as scratches occurred on the film article 15L and the laminated article 10L.

<<<2. Optical Laminates according to Examples and Comparative Examples to Be Evaluated>>>

As described below, optical laminates according to Examples 1 to 8, Comparative Examples 1 to 7, Reference Example 1, and Reference Examples A to E were produced. Each of the optical laminates included an adhesion-promoting layer-coated polyester film and a functional layer formed on the adhesion-promoting layer-coated polyester film. The adhesion-promoting layer-coated polyester film included a polyester film and an adhesion-promoting layer formed on the polyester film using an adhesion-promoting layer coating liquid. In each example, the polyester film was one selected from a plurality of PET films. In each example, the adhesion-promoting layer coating liquid was one selected from a plurality of adhesion-promoting layer coating liquids.

### <<2-1. Preparation of Adhesion-Promoting Layer Coating Liquid>>

Adhesion-promoting layer coating liquids A to D were prepared as described below.

### <2-1-1. Adhesion-Promoting Layer Coating Liquid A>

The following materials were mixed to cause transesterification at 200 °C for two hours to obtain Compound 1.
110 parts by mass of dimethyl terephthalate
30 parts by mass of ethylene glycol
30 parts by mass of 1,4-butanediol
0.1 parts by mass of zinc acetate.
0.1 parts by mass of antimony trioxide

Subsequently, 4.0 parts by mass of fumaric acid were added to Compound 1 to cause an esterification reaction at 230 °C for two hours. Subsequently, a polycondensation reaction was performed under reduced pressure (3 mmHg to 6 mmHg) at 250 °C for an hour to obtain Compound 2. 230 parts by pass of methyl ethyl ketone and 120 parts by mass of isopropyl alcohol were added as a solvent to Compound 2. Compound 2 and the solvent were stirred while being heated to 70 °C to dissolve Compound 2 into the solvent, with the result that a resin solution 3 was obtained.

30 parts by mass of m-xylene diisocyanate were added to the resin solution 3 and stirred for three hours. Subsequently, the temperature of a reaction container was increased to 100 °C to remove methyl ethyl ketone and isopropyl alcohol, with the result that an adhesion-promoting resin 4 was obtained.

The adhesion-promoting resin 4 was dissolved into a mixed solvent of methyl ethyl ketone and toluene at a mass ratio of 8:2. As a result, an adhesion-promoting layer coating liquid A with a solid content of 5 mass % was obtained. The mass ratio between the polyester component and the polyurethane component of the resin included in the adhesion-promoting layer coating liquid A was set to 8:2.

### <2-1-2. Adhesion-Promoting Layer Coating Liquid B>

Except that the amounts of dimethyl terephthalate, ethylene glycol, and 1,4-butanediol in Compound 1 and the amount of m-xylene diisocyanate added to the resin solution 3 were changed as shown below, an adhesion-promoting layer coating liquid B was obtained similarly to the adhesion-promoting layer coating liquid A. The mass ratio between the polyester component and the polyurethane component of the resin included in the adhesion-promoting layer coating liquid B was set to 7:3.

100 parts by mass of dimethyl terephthalate

28 parts by mass of ethylene glycol

28 parts by mass of 1,4-butanediol

46 parts by mass of m-xylene diisocyanate

### <2-1-3. Adhesion-Promoting Layer Coating Liquid C>

Except that the amounts of dimethyl terephthalate, ethylene glycol, and 1,4-butanediol in Compound 1 and the amount of m-xylene diisocyanate added to the resin solution 3 were changed as shown below, an adhesion-promoting layer coating liquid C was obtained similarly to the adhesion-promoting layer coating liquid A. The mass ratio between the polyester component and the polyurethane component of the resin included in the adhesion-promoting layer coating liquid C was set to 6:4.

70 parts by mass of dimethyl terephthalate

25 parts by mass of ethylene glycol

25 parts by mass of 1,4-butanediol

60 parts by mass of m-xylene diisocyanate

### <2-1-4. Adhesion-Promoting Layer Coating Liquid D>

Except that the amounts of dimethyl terephthalate, ethylene glycol, and 1,4-butanediol in Compound 1 and the amount of m-xylene diisocyanate added to the resin solution 3 were changed as shown below, an adhesion-promoting layer coating liquid C was obtained similarly to the adhesion-promoting layer coating liquid A. The mass ratio between the polyester component and the polyurethane component of the resin included in the adhesion-promoting layer coating liquid C was set to 4:6.

30 parts by mass of dimethyl terephthalate

23 parts by mass of ethylene glycol

23 parts by mass of 1,4-butanediol

89 parts by mass of m-xylene diisocyanate

### <2-1-5. Adhesion-Promoting Layer Coating Liquid E>

A PVA-A solution with a solid content concentration of 15 mass % was prepared by gradually adding 15 g of polyvinyl alcohol to 85 g of ion-exchange water while stirring, then heating the mixture to 70 °C to 90 °C, and stirring the mixture. Polyvinyl alcohol used was “PVA28-98” manufactured by Kuraray Co., Ltd. (formerly known as “PVA117”).

A mixture obtained by mixing the PVA-A solution and a water-based polyurethane resin at a solid content ratio of 60:40 was diluted with a solvent to obtain an adhesion-promoting layer coating liquid E. The solid content concentration of the adhesion-promoting layer coating liquid E was set to 14.6 mass %. “Vylonal MD2000” manufactured by Toyobo MC Corporation was used as the water-based polyurethane resin. The solvent was a mixture obtained by mixing water and isopropanol at a mass ratio of 7:3.

### <2-1-6. Adhesion-Promoting Layer Coating Liquid F>

A mixture of 33 parts by mass of polyester resin and 1 part by mass of crosslinking agent was diluted with a solvent to obtain an adhesion-promoting layer coating liquid F. The solid content concentration of the adhesion-promoting layer coating liquid F was set to 10 mass %. “Vylon UR-1400” manufactured by Toyobo Co., Ltd. was used as the polyester resin. “Takenate D110N” manufactured by Mitsui Chemicals, Inc. was used as the crosslinking agent. The solvent is a mixture obtained by mixing methyl ethyl ketone and toluene at a mass ratio of 8:2.

### <2-1-7. Adhesion-Promoting Layer Coating Liquid G>

A polyester-based water-dispersible urethane adhesive was diluted with a solvent to obtain an adhesion-promoting layer coating liquid G. The solid content concentration of the adhesion-promoting layer coating liquid G was set to 14.6 mass %. “Superflex SF210” manufactured by Dai-ichi Kogyo Seiyaku Co., Ltd. (solid content concentration of 35%) was used as the polyester-based water-dispersible urethane adhesive. The solvent was a mixture obtained by mixing water and isopropanol at a mass ratio of 7:3.

### <<2-2. Production and Preparation of PET Films>>

The following PET films 1 to 6 were prepared as the polyester films of the examples, comparative examples, and reference examples.

### <2-2-1. PET Film 1>

One kilogram of PET (absorption center wavelength: 320 nm) and 0.1 kg of ultraviolet absorber were melt-mixed at 280 °C in a kneader to produce pellets containing the ultraviolet absorber. The ultraviolet absorber was 2,2′-(1,4-phenylene)bis(4H-3,1-benzoxazin-4-one). The pellets and PET having a melting point of 258 °C were put into a single-screw extruder, melt-kneaded at 290 °C, and extruded through a T-die. The extruded PET was cast onto a cast drum with a controlled surface temperature to obtain a casting film. The amount of ultraviolet absorber in the casting film was 3 parts by mass for 100 parts by mass of PET.

The surface temperature of the cast drum was controlled as follows. The portion, to which the resin extruded from the T-die adhered, was set to 50 °C. The release point of the resin was set to 25 °C. The temperature was gradually reduced from the portion where the resin adhered to the release point of the resin.

After the obtained casting film was heated with a group of rolls set to 120 °C, the film was stretched 5.1 times in the machine direction in a stretching zone, and then was temporarily cooled. The length of the stretching zone in the machine direction was 480 mm. A stretching roll A was positioned at a starting point of the stretching zone, and a stretching roll B was positioned at an end point thereof. The stretching roll A and the stretching roll B each have two nip rolls. The casting film was stretched while being heated by radiation heaters from both sides of the film such that the film temperature reached 135 °C at a point 180 mm from the starting point of the 480 mm stretching zone. The time for the casting film to pass through a machine-direction stretching zone was set to 0.50 seconds.

Subsequently, the uniaxially stretched film was guided to a tenter. After the uniaxially stretched film was preheated with a roll group set at 120 °C, the film was subjected to heat treatment with hot air at 105 °C in the first stage and 136 °C in the second stage, while being stretched 4.9 times in the film transverse direction. Here, when a transverse-direction stretching zone was divided into two sections, stretching was performed in two stages such that the stretching amount of the film at an intermediate point of the transverse-direction stretching zone was 80% of the stretching amount at the end of the transverse-direction stretching zone. The stretch amount is calculated by subtracting the film width before stretching from the film width at the measurement point. The film stretched in the transverse direction was subsequently subjected to heat treatment in the tenter with hot air having a temperature that was gradually increased from 180 °C to a heat treatment temperature 245 °C. Subsequently, the film stretched in the transverse direction was subjected to a relaxation treatment of 1% in the transverse direction under the same temperature conditions, and, after being rapidly cooled to 100 °C, was further subjected to a relaxation treatment of 1% in the transverse direction. The relaxed PET film was taken up to obtain a biaxially stretched PET film 1 with a thickness of 40 μm.

### <2-2-2. PET Film 2>

Except that the time for which the casting film passed through the machine-direction stretching zone was changed to 0.45 seconds, a biaxially stretched PET film 2 was obtained similarly to the PET film 1.

### <2-2-3. PET Film 3>

Except that the time for which the casting film passed through the machine-direction stretching zone was changed to 0.40 seconds, a biaxially stretched PET film 2 was obtained similarly to the PET film 1.

### <2-2-4. PET Film 4>

Except that the time for which the casting film passed through the machine-direction stretching zone was changed to 0.35 seconds, a biaxially stretched PET film 4 was obtained similarly to the PET film 1.

### <2-2-5. PET Film 5>

Except that the time for which the casting film passed through the machine-direction stretching zone was changed to 0.30 seconds, a biaxially stretched PET film 4 was obtained similarly to the PET film 1.

### <2-2-6. PET Film 6>

Except that the time for which the casting film passed through the machine-direction stretching zone was changed to 0.25 seconds, a biaxially stretched PET film 6 was obtained similarly to the PET film 1.

### <2-2-7. PET Film 7>

An adhesion-promoting layer-coated PET film “COSMOSHINE A4160” available from Toyobo Co., Ltd. was prepared as a PET film 7. This adhesion-promoting layer-coated polyester film included a biaxially stretched PET film and an adhesion-promoting layer provided on one side of the biaxially stretched PET film. The thickness of the adhesion-promoting layer-coated polyester film serving as the PET film 7 was 38 μm.

### <2-2-8. PET Film 8>

Except that the stretching ratio in the machine direction was changed to 3.8 times and the stretching ratio in the transverse direction was changed to 4.4 times, a PET film 8 was obtained similarly to the PET film 1.

### <2-2-9. PET Film 9>

Except that the stretching ratio in the machine direction was changed to 3.5 times and the stretching ratio in the transverse direction was changed to 4.4 times, a biaxially stretched PET film 8 was obtained similarly to the PET film 1.

### <2-2-10. PET Film 10>

Except that the stretching ratio in the machine direction was changed to 3.5 times and the stretching ratio in the transverse direction was changed to 4.7 times, a biaxially stretched PET film 8 was obtained similarly to the PET film 1.

### <2-2-11. PET Film 11>

Except that the stretching ratio in the machine direction was changed to 3.3 times and the stretching ratio in the transverse direction was changed to 4.7 times, a biaxially stretched PET film 8 was obtained similarly to the PET film 1.

### <2-2-12. PET Film 12>

Except that the stretching ratio in the machine direction was changed to 3.3 times and the stretching ratio in the transverse direction was changed to 5.0 times, a biaxially stretched PET film 8 was obtained similarly to the PET film 1.

### <2-2-13. PET Film 13>

Except that the stretching ratio in the machine direction was changed to 3.3 times and the stretching ratio in the transverse direction was changed to 5.1 times, a biaxially stretched PET film 8 was obtained similarly to the PET film 1.

### <<2-3. Production of Adhesion-Promoting Layer-Coated Polyester Film and Optical Laminate>>

Using the above-described adhesion-promoting layer coating liquids and PET films, adhesion-promoting layer-coated polyester films and optical laminates according to Examples 1 to 8, Comparative Examples 1 to 4, Reference Example 1, and Reference Examples A to E were produced.

### Example 1

The above-described adhesion-promoting layer coating liquid A was applied onto the PET film 2 to form a coating film. The coating film was dried at 90 °C for 60 seconds. As a result, an adhesion-promoting layer with a thickness of 100 nm was formed, and an adhesion-promoting layer-coated polyester film of Example 1 was obtained.

A hard coat layer coating liquid having the formulation described below was applied onto the adhesion-promoting layer-coated polyester film to form a coating film. The coating film was dried at 80 °C for 60 seconds and cured by irradiation with ultraviolet radiation at 200 mJ/cm². As a result, a hard coat layer with a dry thickness of 10 μm was formed on the adhesion-promoting layer to obtain an optical laminate of Example 1.

### <Hard Coat Layer Coating Liquid>

30 parts by mass of polyfunctional acrylate monomer “PET-30” (manufactured by Nippon Kayaku Co., Ltd.)

2 parts by mass of a photopolymerization initiator “Omnirad 184” (manufactured by IGM Resins B.V.)

30 parts by mass of toluene

33 parts by mass of methyl ethyl ketone

### Example 2

Except that the PET film 2 was changed to the PET film 3, an adhesion-promoting layer-coated polyester film and optical laminate of Example 2 were obtained similarly to Example 1.

### Example 3

Except that the PET film 2 was changed to the PET film 4, an adhesion-promoting layer-coated polyester film and optical laminate of Example 3 were obtained similarly to Example 1.

### Example 4

Except that the PET film 2 was changed to the PET film 5, an adhesion-promoting layer-coated polyester film and optical laminate of Example 4 were obtained similarly to Example 1.

### Example 5

Except that the PET film 2 was changed to the PET film 3 and the adhesion-promoting layer coating liquid A was changed to the adhesion-promoting layer coating liquid B, an adhesion-promoting layer-coated polyester film and optical laminate of Example 5 were obtained similarly to Example 1.

### Example 6

Except that the PET film 2 was changed to the PET film 3 and the adhesion-promoting layer coating liquid A was changed to the adhesion-promoting layer coating liquid C, an adhesion-promoting layer-coated polyester film and optical laminate of Example 6 were obtained similarly to Example 1.

### Example 7

Except that the PET film 2 was changed to the PET film 5, the adhesion-promoting layer coating liquid A was changed to the adhesion-promoting layer coating liquid B, and the drying conditions for drying the coating film of the adhesion-promoting layer coating liquid was changed from 90 °C for 60 seconds to 100 °C for 60 seconds, an adhesion-promoting layer-coated polyester film and optical laminate of Example 7 were obtained similarly to Example 1.

### Example 8

Except that the PET film 2 was changed to the PET film 3, the adhesion-promoting layer coating liquid A was changed to the adhesion-promoting layer coating liquid B, and the drying conditions for drying the coating film of the adhesion-promoting layer coating liquid was changed from 90 °C for 60 seconds to 110 °C for 60 seconds, an adhesion-promoting layer-coated polyester film and optical laminate of Comparative Example 8 were obtained similarly to Example 1.

### Comparative Example 1

Except that the PET film 2 was changed to the PET film 1, an adhesion-promoting layer-coated polyester film and optical laminate of Comparative Example 1 were obtained similarly to Example 1.

### Comparative Example 2

Except that the PET film 2 was changed to the PET film 6, an adhesion-promoting layer-coated polyester film and optical laminate of Comparative Example 2 were obtained similarly to Example 1.

### Comparative Example 3

Except that the PET film 2 was changed to the PET film 3 and the adhesion-promoting layer coating liquid A was changed to the adhesion-promoting layer coating liquid D, an adhesion-promoting layer-coated polyester film and optical laminate of Comparative Example 3 were obtained similarly to Example 1.

### Comparative Example 4

Except that the PET film 2 and the adhesion-promoting layer were changed to the commercially available PET film 7 (adhesion-promoting layer-coated polyester film), an adhesion-promoting layer-coated polyester film and optical laminate of Comparative Example 4 were obtained similarly to Example 1.

### Comparative Example 5

Except that the PET film 2 was changed to the PET film 3, the adhesion-promoting layer coating liquid A was changed to adhesion-promoting layer coating liquid E, the application timing of the adhesion-promoting layer coating liquid E was changed, the application amount of the adhesion-promoting layer coating liquid E was changed, and the drying conditions for the coating film of the adhesion-promoting layer coating liquid E was changed, an adhesion-promoting layer-coated polyester film and optical laminate of Comparative Example 5 were obtained similarly to Example 1. In Comparative Example 5, the adhesion-promoting layer coating liquid E was applied to a uniaxially stretched film before transverse-direction stretching. The uniaxially stretched film was stretched in the transverse direction together with the coating film of the adhesion-promoting layer coating liquid E. The application amount of the adhesion-promoting layer coating liquid E was set to 0.2 g/m² based on the mass of adhesion promotion after drying. The drying conditions for the coating film were set to 80 °C for 20 seconds.

### Comparative Example 6

Except that the PET film 2 was changed to the PET film 3, the adhesion-promoting layer coating liquid A was changed to the adhesion-promoting layer coating liquid F, the drying conditions for the coating film of the adhesion-promoting layer coating liquid F were changed, and the application amount of the adhesion-promoting layer coating liquid F was changed, an adhesion-promoting layer-coated polyester film and optical laminate of Comparative Example 6 were obtained similarly to Example 1. The drying conditions for the coating film were set to 70 °C for 30 seconds. The application amount of the adhesion-layer coating liquid F was set to 5 g/m² based on the wet mass and 0.5 g/m² based on the mass of the adhesion-promoting layer after drying.

### Comparative Example 7

Except that the PET film 2 was changed to the PET film 3, the adhesion-promoting layer coating liquid A was changed to adhesion-promoting layer coating liquid G, the application method for the coating film of the adhesion-promoting layer coating liquid G was changed, the drying conditions for the coating film of the adhesion-promoting layer coating liquid G were changed, and the application amount of the adhesion-promoting layer coating liquid G was changed, an adhesion-promoting layer-coated polyester film and optical laminate of Comparative Example 7 were obtained similarly to Example 1. The application of the adhesion-promoting layer coating liquid G was performed using a coating tester with a gravure roll having a mesh size of #200. The drying conditions for the coating film were set to 150 °C for one minute. The application amount of the adhesion-layer coating liquid F was set to an amount by which an adhesion-promoting layer with a thickness of 0.3 μm was obtained.

### Reference Example 1

Except that the PET film 2 was changed to the PET film 8, an adhesion-promoting layer-coated polyester film and optical laminate of Reference Example 1 were obtained similarly to Example 1.

### Reference Example A

Except that the PET film 2 was changed to the PET film 9, an adhesion-promoting layer-coated polyester film and optical laminate of Reference Example A were obtained similarly to Example 1.

### Reference Example B

Except that the PET film 2 was changed to the PET film 10, an adhesion-promoting layer-coated polyester film and optical laminate of Reference Example B were obtained similarly to Example 1.

### Reference Example C

Except that the PET film 2 was changed to the PET film 11, an adhesion-promoting layer-coated polyester film and optical laminate of Reference Example C were obtained similarly to Example 1.

### Reference Example D

Except that the PET film 2 was changed to the PET film 12, an adhesion-promoting layer-coated polyester film and optical laminate of Reference Example D were obtained similarly to Example 1.

### Reference Example E

Except that the PET film 2 was changed to the PET film 13, an adhesion-promoting layer-coated polyester film and optical laminate of Reference Example E were obtained similarly to Example 1.

TABLE 1
Samples and Evaluation Results

| | | Adhesion- | | | | | | | | | |
|---|---|---|---|---|---|---|---|---|---|---|---|
| | | Promoting | | | | δ q / δ a | | | | | |
| | | Layer | | Re | | | Coefficient of | | Puncture | Bending | Pencil |
| | PET Film | Costing Liquid | ΔP | (nm) | 2.0 < Nz | Average Value | Variation | Adhesion | Resistance | Resistance | Hardness |
| Example 1 | 2 | A | 0.191 | 486 | Y | 1.305 | 0.081 | AA | AAA | AAA | F |
| Example 2 | 3 | A | 0.176 | 546 | Y | 1.382 | 0.049 | AA | AAA | AAA | F |
| Example 3 | 4 | A | 0.161 | 633 | Y | 1.326 | 0.057 | AA | AAA | AAA | HB |
| Example 4 | 5 | A | 0.151 | 998 | Y | 1.125 | 0.072 | AA | A | A | B |
| Example 5 | 3 | B | 0.176 | 546 | Y | 1.592 | 0.093 | AA | AAA | AAA | F |
| Example 6 | 3 | C | 0.176 | 846 | Y | 1.789 | 0.053 | A | AAA | AAA | F |
| Example 7 | 5 | B | 0.151 | 998 | Y | 1.558 | 0.143 | AA | A | A | B |
| Example 8 | 3 | B | 0.176 | 846 | Y | 1.611 | 0.178 | A | A | AAA | F |
| Comparative | 1 | A | 0.198 | 435 | Y | 1.348 | 0.062 | A | B | B | F |
| Example 1 | | | | | | | | | | | |
| Comparative | 6 | A | 0.127 | 1498 | Y | 1.366 | 0.065 | A | B | B | 2B |
| Example 2 | | | | | | | | | | | |
| Comparative | 3 | C | 0.176 | 846 | Y | 2.287 | 0.079 | B | A | AA | F |
| Example 3 | | | | | | | | | | | |
| Comparative | 7 | commercially | 0.139 | 1465 | Y | 2.025 | 0.19 | A | B | B | 2B |
| Example 4 | | available product | | | | | | | | | |
| Comparative | 3 | E | 0.176 | 546 | Y | 1.028 | 0.048 | B | A | AA | F |
| Example 5 | | | | | | | | | | | |
| Comparative | 3 | F | 0.176 | 546 | Y | 1.044 | 0.017 | B | A | AA | F |
| Example 6 | | | | | | | | | | | |
| Comparative | 3 | G | 0.176 | 546 | Y | 1.036 | 0.044 | B | A | AA | F |
| Example 7 | | | | | | | | | | | |
| Reference | 8 | A | 0.157 | 890 | N | 1.493 | 0.198 | A | A | A | F |
| Example 1 | | | | | | | | | | | |

TABLE 2
Samples and Evaluation Results

| | | Adhesion- | | | | | | |
|---|---|---|---|---|---|---|---|---|
| | | Promoting | | | | δ q / δ a | | |
| | | Layer | | Re | | | Coefficient of | |
| | PET Film | Coating Liquid | ΔP | (nm) | 2.0 < Nz | Average Value | Variation | Transportability |
| Reference Example A | 9 | A | 0.155 | 1512 | Y | 1.327 | 0.088 | A |
| Reference Example B | 10 | A | 0.159 | 1911 | Y | 1.367 | 0.109 | AA |
| Reference Example C | 11 | A | 0.156 | 2307 | Y | 1.344 | 0.093 | AA |
| Reference Example D | 12 | A | 0.152 | 2770 | Y | 1.380 | 0.102 | AA |
| Reference Example E | 13 | A | 0.152 | 2934 | Y | 1.391 | 0.095 | A |

By setting the average value of δq/δa to 1.125 or higher and 1.80 or lower according to the feature (B), high adhesion was able to be imparted to the adhesion-promoting layer-coated polyester film and the optical laminate. By setting the plane orientation degree ΔP to 0.150 or higher and 0.195 or lower according to the feature (A), the mechanical strength was able to be improved.

The plane orientation degree ΔP and puncture resistance correlated with each other. However, the correlation between the plane orientation degree ΔP and puncture resistance was not very strong, and was weaker than the correlation between the plane orientation degree ΔP and bending resistance. This point is understood from the fact that the puncture resistance of Comparative Example 3, which has a plane orientation degree ΔP of 0.176, was lower than that of other examples having a comparable plane orientation degree ΔP. On the other hand, among the samples where the average value of δq/δa is higher than or equal to 1.125 and lower than or equal to 1.80, the plane orientation degree ΔP and puncture resistance exhibited a very strong correlation. From this point, it can be understood that unexpected advantageous effects can be obtained by the combination of the above-described feature (A) relating to the plane orientation degree ΔP and the above-described feature (B) relating to the average value of δq/δa.

More specifically, Comparative Example 3 has the same plane orientation degree ΔP as Example 2, Example 5, and Example 6, and has an average value of δq/δa that is higher than those of Example 2, Example 5, and Example 6. The evaluation of puncture resistance and the evaluation of bending resistance for Comparative Example 3 were not good, unlike those of Example 2, Example 5, and Example 6. In other words, by setting an upper limit on the average value of δq/δa according to the feature (B) in addition to the feature (A), puncture resistance and bending resistance were able to be more stably improved.

It is presumed that one reason for this phenomenon is that, by setting an upper limit on the average value of δq/δa, the mechanical properties of the adhesion-promoting layer-coated polyester film become uniform, which can lead to stable improvement in bending resistance that is an evaluation index for a more local mechanical strength and puncture resistance that is regarded as an evaluation indicator for a more local mechanical strength compared to bending resistance. However, the present disclosure is not bound by this presumption.

Similarly, Comparative Examples 5 to 7 have the same plane orientation degree ΔP as Example 2, and have a lower average value of δq/δa than Example 2. The evaluation of bending resistance and puncture resistance for Comparative Examples 5 to 7 was sufficient; however, the evaluation was lower than that of Example 2. In other words, by setting a lower limit on the average value of δq/δa according to the feature (B) in addition to the feature (A), bending resistance and puncture resistance were able to be more stably improved.

It is presumed that one reason why bending resistance can be stably improved is that, by setting a lower limit on the average value of δq/δa, repeated application of load in a certain region due to excessively uniform mechanical properties of the adhesion-promoting layer-coated polyester film can be suppressed. It is presumed that one reason why puncture resistance can be stably improved is that, by setting a lower limit on the average value of δq/δa, concentration of impact load at an extremely small area due to excessively uniform mechanical properties of the adhesion-promoting layer-coated polyester film can be suppressed. However, the present disclosure is not bound by this presumption.

The ratio of the polyester component in the adhesion-promoting layer decreases in order of Example 2, Example 5, Example 6, and Comparative Example 3. The average value of δq/δa decreases in order of Example 2, Example 5, Example 6, and Comparative Example 3, and the adhesion was insufficient in Comparative Example 3. The ratio of the polyester component in the adhesion-promoting layer of Comparative Example 6 is higher than the ratio of the polyester component in the adhesion-promoting layer of Example 2. The average value of δq/δa of Comparative Example 6 is lower than the average value of δq/δa of Example 2. However, the evaluation of adhesion of Comparative Example 6 was “B”. This phenomenon is considered to be attributable to the fact that, in Comparative Example 6, the viscoelasticity of the surface of the adhesion-promoting layer is excessively uniform, with the result that the adhesion between the adhesion-promoting layer and the functional layer is decreased. In other words, in Comparative Example 6, although the adhesion between the adhesion-promoting layer and the polyester film is improved, it is considered that the adhesion between the adhesion-promoting layer and the functional layer is reduced. Comparative example 5 and Comparative Example 7, similarly to Comparative Example 6, had an average value of δq/δa of lower than 1.125, and the evaluation of adhesion was insufficient.

With the above-described feature (B1) relating to the coefficient of variation of δq/δa in addition to the feature (A) and the feature (B), the adhesion between the adhesion-promoting layer-coated polyester film and the optical laminate was able to be more stably improved. This point can be understood from the evaluation results of adhesion of Example 5 and Example 8.

In Reference Example 1 of which the Nz coefficient was 2.0 or lower, results determined to be acceptable were obtained in all of adhesion, puncture resistance, bending resistance, and pencil hardness. However, when the adhesion-promoting layer-coated polyester film of Reference Example 1 was manufactured, the wettability of the adhesion-promoting layer coating liquid on the PET film decreased compared to other examples. Compared to other examples, the coefficient of variation of δq/δa increased. It was inferior in all of adhesion, puncture resistance, and bending resistance as compared with Example 3 having a comparable plane orientation degree ΔP.

### REFERENCE SIGNS LIST

10 optical laminate
10a first surface
10b second surface
10L laminated article
10R laminate roll
11 take-up core
15 adhesion-promoting layer-coated polyester film
15a first surface
15b second surface
15L film article
15R film roll
16 take-up core
20 polyester film
25 adhesion-promoting layer
30 functional layer
40 polarizing plate
41 polarizer
42 first transparent protective plate
43 second transparent protective plate
50 panel
51 support
55 surface plate
60 image display panel
61 display element
65 image display device

1. An adhesion-promoting layer-coated polyester film comprising:
a polyester film; and an adhesion-promoting layer, wherein
a plane orientation degree is higher than or equal to 0.150 and lower than or equal to 0.195, and
an average value of δq/δa on a surface of the adhesion-promoting layer is higher than or equal to 1.125 and lower than or equal to 1.80.
<Calculation of the average value of δq/δa>
A 10 μm×10 μm region on the surface of the adhesion-promoting layer is measured using an atomic force microscope in a phase mode. A distribution of a phase signal on the surface of the adhesion-promoting layer is obtained through the measurement. A unit of the phase signal is [deg].
δa denotes an arithmetic mean value of the phase signal shown in the following Equation (1). δq denotes a root mean square of the phase signal shown in the following Equation (2). In the following Equation (1) and Equation (2), orthogonal coordinate axes X and Y are placed on a reference surface that represents an average value of the phase signal, an axis orthogonal to the reference surface is defined as a Z axis, and a curved surface of the phase signal is defined as f(x,y). In the following Equation (1) and Equation (2), dimensions of a region for calculating da and δq are Lx and Ly. In the following Equation (1) and Equation (2), Ar=Lx×Ly.
Seven measurement evaluation regions each having a size of 2 μm×2 μm are selected from within the measurement region of 10 μm×10 μm. δa and δq of the seven measurement evaluation regions and δq/δa are calculated. Based on the five δq/δa values, excluding a maximum value and a minimum value from the seven δq/δa values, an average value of δq/δa is calculated.
$$[ Formula 1 ]$$
$$δ a = \frac{1}{Ar} {\int }_{0}^{Lx} {\int }_{0}^{Ly} \vert f ( x , y ) \vert dxdy \qquad Equation ( 1 )$$
$$[ Formula 2 ]$$
$$\begin{matrix}δ q = \sqrt{\frac{1}{Ar} {\int }_{0}^{Lx} {\int }_{0}^{Ly} \vert {f}^{2} ( x , y ) \vert dxdy} & Equation ( 2 )\end{matrix}$$

2. The adhesion-promoting layer-coated polyester film according to claim 1, wherein a coefficient of variation of δq/δa, calculated based on the five δq/δa values, is lower than or equal to 0.150.

3. The adhesion-promoting layer-coated polyester film according to claim 1, wherein, when a refractive index in a slow axis direction within a plane is defined as nx, and a refractive index in a direction orthogonal to the slow axis within the same plane is defined as ny, nx and ny satisfy the following relationship.
nx−ny≤0.0300

4. The adhesion-promoting layer-coated polyester film according to claim 1, wherein a thickness is greater than or equal to 10 μm and less than or equal to 75 μm.

5. The adhesion-promoting layer-coated polyester film according to claim 1, wherein an in-plane retardation is less than or equal to 2000 nm.

6. A film article comprising a plurality of the adhesion-promoting layer-coated polyester films according to claim 1.

7. The film article according to claim 6, wherein the film article is taken up around a take-up axis.

8. An optical laminate comprising: the polyester film according to claim 1; and one or more functional layers on the adhesion-promoting layer of the polyester film.

9. The optical laminate according to claim 8, wherein, among the one or more functional layers, the functional layer that is in contact with the adhesion-promoting layer contains a cured material of an ionizing radiation curable resin composition.

10. The optical laminate according to claim 8, wherein a contact angle, at which a surface of the optical laminate on a side having the functional layer contacts pure water, is larger than or equal to 80 degrees.

11. A laminated article comprising a plurality of the optical laminates according to claim 8.

12. The laminated article according to claim 11, wherein the laminated article is taken up around a take-up axis.

13. A polarizing plate comprising:
a first transparent protective plate; a polarizer; and a second transparent protective plate in this order, wherein
at least one of the first transparent protective plate and the second transparent protective plate is the optical laminate according to claim 8, and the adhesion-promoting layer-coated polyester film is located between the functional layer and the polarizer.

14. A panel comprising a support plate; and the adhesion-promoting layer-coated polyester film according to claim 1.

15. A surface plate comprising:
a support plate; and the optical laminate according to claim 8, wherein
the adhesion-promoting layer-coated polyester film is located between the functional layer and the support plate.

16. An image display panel comprising: a display element; and the optical laminate according to claim 8.

17. An image display device comprising the image display panel according to claim 16.
